(19) United States
(12) Patent Application Publication
(10) Pub. No.: US 2009/0144134 A1
(43) Pub. Date: Jun. 4, 2009

(54) Method and system for active process improvement in the production of products

(76) Inventors: Gary L. Henby, Metamora, IL (US); S. Mike Joyner, Germantown Hills, IL (US); Steven R. Case, East Peoria, IL (US); Tyronne A. Bolden, Bolingbrook, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/292,549

(22) Filed: Nov. 20, 2008

Related U.S. Application Data
(60) Provisional application No. 60/996,514, filed on Nov. 21, 2007.
(60) Provisional application No. 61/136,920, filed on Oct. 14, 2008.

(51) Int. Cl. G06Q 10/00

(52) U.S. Cl. 705/11

(57) ABSTRACT

A method of problem analysis within an organization having one or more production levels is provided. The method includes defining a plurality of organizational principles that apply to the organization. The method also includes defining a plurality of practices to enable the plurality of organizational principles. Each of the practices is associated with at least one metric for performance measurement. The method also includes displaying each metric at a display at one of the production levels. The method also includes enabling a meeting between two or more organization personnel concerning at least one metric. The meeting is to identify a problem associated with the at least one metric.

### PRIORITY

This application claims priority to U.S. Provisional Patent Application No. 60/996,514, filed Nov. 21, 2007, and to U.S. Provisional Patent Application No. 61/136,920, filed Oct. 14, 2008, both of which are incorporated herein by reference in their entirety.

### RELATED APPLICATIONS

The subject matter of the present application is related to that in the following copending U.S. patent applications:

A Method and System for Production of Products, filed Nov. 20, 2008, by Henby et al.;

A Method and System for Assessing Process Conformance in the Production of Products, filed Nov. 20, 2008, by Schroeder;

A Method and System for Monitoring Process Performance in the Production of Products, filed Nov. 20, 2008, by Pemberton;

A Method and System for Improving Manufacturing Processes in the Production of Products, filed Nov. 20, 2008, by Pemberton;

A Method and System for Enabling Process Improvement in the Production of Products, filed Nov. 20, 2008, by Henby;

A Method and System for Process Improvement in the Production of Products, filed Nov. 20, 2008, by Henby; and

A Method and System for Continuous Improvement in the Production of Products, filed Nov. 20, 2008, by Joyner, all of which are incorporated herein by reference.

### TECHNICAL FIELD

The present disclosure is directed to a production system and, more particularly, to a system and method of process improvement for the production of products within an organization.

### BACKGROUND

Business organizations generally strive for improvement throughout every aspect of their business. Improvements in product quality, production efficiency, worker safety, or customer satisfaction illustrate a few of the more common improvement goals. Generally, a business, such as a manufacturing business, will employ an improvement plan to produce the highest quality products as efficiently and safely as possible. Many businesses worldwide have utilized various methodologies in an effort to achieve this improvement, with a focus on certain aspects of their production processes. For example, many organizations have utilized an internal system in order to more efficiently move a product from the order stage to customer delivery. Many of these models for improvement focus on individual operational areas within the business, as that approach to improvement seemingly yields the most direct results.

While many of these models provide incremental improvements for various aspects of the business organization, one shortfall is a concentration weighted too heavily toward discrete systems or solely to the fundamental production operations of the business. Such a concentration offers benefits early on, but falls short producing the long term improvement gains desired by the organization. In particular, current models do not utilize a wholly inclusive process for continuous improvement that includes core beliefs and values that define how the business organization will approach every aspect of its work, in a manner observable at and within every level of the organization. Such models are not implemented across every level of an organization as well as uniformly from the top executive decision making body down to each assembly line operator, i.e., one common system to drive process improvements across all operations worldwide and to provide a heightened sense of ownership among the organization employees. Additionally, these models are not used across a business organization's entire line of products, regardless of the number of business units within the organization or the specific goals of individual business units, and they do not include the evaluation and improvement of every order-to-delivery practice of the organization, from placement of an order to managing suppliers, producing the good, and delivering it to a distributor or to the customer.

Consequently, long term benefits can be obtained by utilizing a unified and comprehensive approach to continuous process improvement that not only considers operational conditions for the product being produced, but fully integrates cultural and management aspects of the business organization.

The disclosed embodiments are directed to overcoming one or more of the problems set forth above.

### SUMMARY

A method of problem analysis within an organization having one or more production levels is provided. The method may include defining a plurality of organizational principles that apply to the organization. The method may also include defining a plurality of practices to enable the plurality of organizational principles. Each of the practices may be associated with at least one metric for performance measurement. The method may also include displaying each metric at a display at one of the production levels. The method may also include enabling a meeting between two or more organization personnel concerning at least one metric. The meeting may be to identify a problem associated with the at least one metric.

A system of problem analysis within an organization having one or more production levels is provided. The system may include a plurality of organizational principles that apply to the organization. The system may also include a plurality of practices that enable the plurality of organizational principles. Each of the practices may be associated with at least one metric for performance measurement. The system may also include a display for displaying each metric at one of the production levels. The system may also include a meeting between two or more organization personnel concerning at least one metric, the meeting to identify a problem associated with the at least one metric. The meeting may be to identify a problem associated with the at least one metric.

A tangible computer-readable storage medium embodying computer-readable code for instructing a system of problem analysis within an organization having one or more production levels is provided. The computer-readable code may include a plurality of organizational principles that apply to the organization. The computer-readable code may also include a plurality of practices that enable the plurality of organizational principles. Each of the practices may be associated with at least one metric for performance measurement. The computer-readable code may also include a display for displaying each metric at one of the production levels. The computer-readable code may also include a meeting between two or more organization personnel concerning at least one metric. The meeting may be to identify a problem associated with the at least one metric.

### BRIEF DESCRIPTION OF THE DRAWINGS

FIG. 1 is a diagram illustrating an exemplary business organization consistent with certain disclosed embodiments;

FIG. 1a is a diagram illustrating an exemplary facility of the business organization of FIG. 1, consistent with certain disclosed embodiments;

FIG. 1b is a diagram illustrating selected elements of the production system of the organization consistent with certain disclosed embodiments;

FIG. 2a is a diagram illustrating critical success factors of the organization consistent with certain disclosed embodiments;

FIG. 2b is a diagram illustrating wastes of the organization consistent with certain disclosed embodiments;

FIG. 3 is a diagram illustrating the subsystems of the organization and their associated principles consistent with certain disclosed embodiments;

FIG. 4 is a chart illustrating the association of assessment questions with subsystems and principles of the organization consistent with certain disclosed embodiments;

FIG. 5 is a chart illustrating the assessment cycle consistent with certain disclosed embodiments;

FIG. 5a is a diagram of an exemplary general-purpose computer connected to a network within the organization consistent with certain disclosed embodiments;

FIG. 5b is a diagram illustrating components of an exemplary general-purpose computer connected to a network within the organization consistent with certain disclosed embodiments;

FIG. 6 is a chart illustrating processes that may be defined by the organization consistent with certain disclosed embodiments;

FIG. 7 is a diagram of an exemplary metric spreadsheet consistent with certain disclosed embodiments;

FIG. 7a is a diagram of an exemplary metric spreadsheet showing ‘Days of Injury-Free Work’ consistent with certain disclosed embodiments;

FIG. 7b is a diagram of an exemplary metric spreadsheet showing ‘Dealer Repair Frequency’ consistent with certain disclosed embodiments;

FIG. 7c is a diagram of an exemplary metric spreadsheet showing ‘Parts per Million’ consistent with certain disclosed embodiments;

FIG. 7d is a diagram of an exemplary metric spreadsheet showing ‘Committed Ship Date Performance’ consistent with certain disclosed embodiments;

FIG. 7e is a diagram of an exemplary metric spreadsheet showing ‘Expenses per Hours Worked’ consistent with certain disclosed embodiments;

FIG. 7f is a diagram of an exemplary metric spreadsheet showing ‘Ideas per Employee’ consistent with certain disclosed embodiments;

FIG. 7g is a diagram of an exemplary metric spreadsheet showing ‘% Ideas Closed Within 30 Days’ consistent with certain disclosed embodiments;

FIG. 8 is a diagram of exemplary displays consistent with certain disclosed embodiments;

FIG. 8a is a diagram of a first part of an exemplary facility display consistent with certain disclosed embodiments;

FIG. 8b is a diagram of a second part of an exemplary facility display consistent with certain disclosed embodiments;

FIG. 8c is a diagram of a representative objective plan of an exemplary facility display consistent with certain disclosed embodiments;

FIG. 8d is a diagram of a root cause corrective action chart of an exemplary facility display consistent with certain disclosed embodiments;

FIG. 8e is a diagram of an alternative second part of an exemplary facility display consistent with certain disclosed embodiments;

FIG. 9a is a diagram of first part of an exemplary group display consistent with certain disclosed embodiments;

FIG. 9b is a diagram of second part of an exemplary group display consistent with certain disclosed embodiments;

FIG. 9c is a diagram of a representative objective plan of an exemplary group display consistent with certain disclosed embodiments;

FIG. 9d is a diagram of a root cause corrective action chart of an exemplary group display consistent with certain disclosed embodiments;

FIG. 9e is a diagram of an alternative second part of an exemplary group display consistent with certain disclosed embodiments;

FIG. 10a is a diagram of the faces of an exemplary group tower display consistent with certain disclosed embodiments;

FIG. 10b is a perspective view of an exemplary group tower display consistent with certain disclosed embodiments;

FIG. 11 is a diagram of an exemplary area display consistent with certain disclosed embodiments;

FIG. 11a is a diagram of a representative objective plan of an exemplary area display consistent with certain disclosed embodiments;

FIG. 11b is a diagram of a root cause corrective action chart of an exemplary area display consistent with certain disclosed embodiments;

FIG. 12 is a diagram of an exemplary cell display consistent with certain disclosed embodiments;

FIG. 12a is a diagram of an alternative time period portion of an exemplary cell display consistent with certain disclosed embodiments;

FIG. 12b is a diagram of another alternative time period portion of an exemplary cell display consistent with certain disclosed embodiments;

FIG. 13a is a diagram of an exemplary operational executive scorecard consistent with certain disclosed embodiments;

FIG. 13b is a diagram of an exemplary “how” executive scorecard consistent with certain disclosed embodiments;

FIG. 14 is a chart illustrating a metrics cascade consistent with certain disclosed embodiments;

FIG. 15 is a diagram illustrating a Process Improvement Dialogue consistent with certain disclosed embodiments;

FIG. 16a is a diagram illustrating the elements of a value stream transformation consistent with certain disclosed embodiments;

FIG. 16b is a diagram illustrating a value stream map consistent with certain disclosed embodiments;

FIG. 16c is a diagram illustrating the elements of a Value Stream Transformation Project consistent with certain disclosed embodiments;

FIG. 17 is a diagram illustrating the elements of a Rapid Improvement Workshop consistent with certain disclosed embodiments;

FIG. 17a is a diagram illustrating the stages of the Workshop phase of a Rapid Improvement Workshop consistent with certain disclosed embodiments;

FIG. 17b is a diagram illustrating an organizational structure of a Rapid Improvement Workshop consistent with certain disclosed embodiments;

FIG. 18 is a chart depicting the alignment of wastes and metric categories that capture savings due to waste reduction activities during a Rapid Improvement Workshop consistent with certain disclosed embodiments;

FIG. 19 is a chart for reporting benefits associated with a Rapid Improvement Workshop consistent with certain disclosed embodiments;

FIG. 20 is a diagram illustrating the steps of a Continuous Improvement process consistent with certain disclosed embodiments;

FIG. 21 is a diagram illustrating Continuous Improvement cards consistent with certain disclosed embodiments; and

FIG. 22 is a diagram illustrating a Continuous Improvement display consistent with certain disclosed embodiments.

### DETAILED DESCRIPTION

The present disclosure is directed to a production system and, more particularly, to a system and method of process improvement for the production of products within an organization.

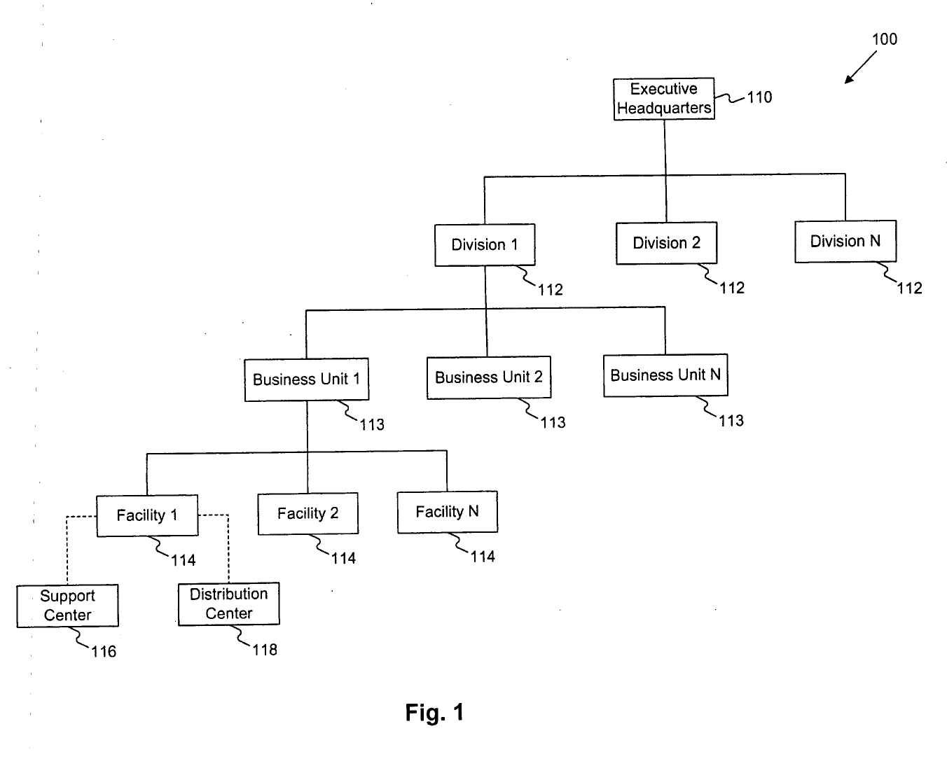

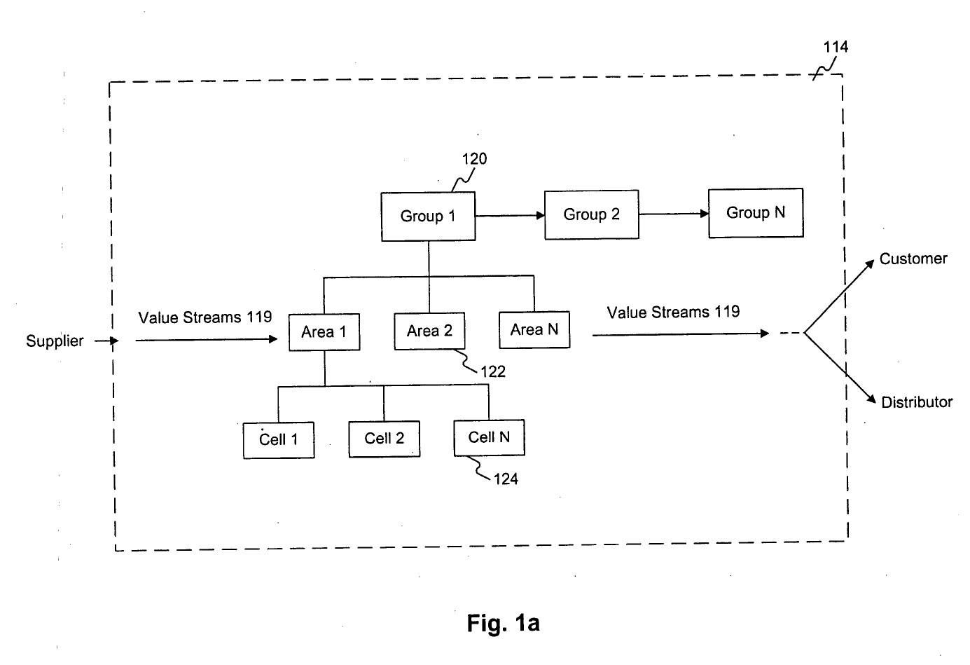

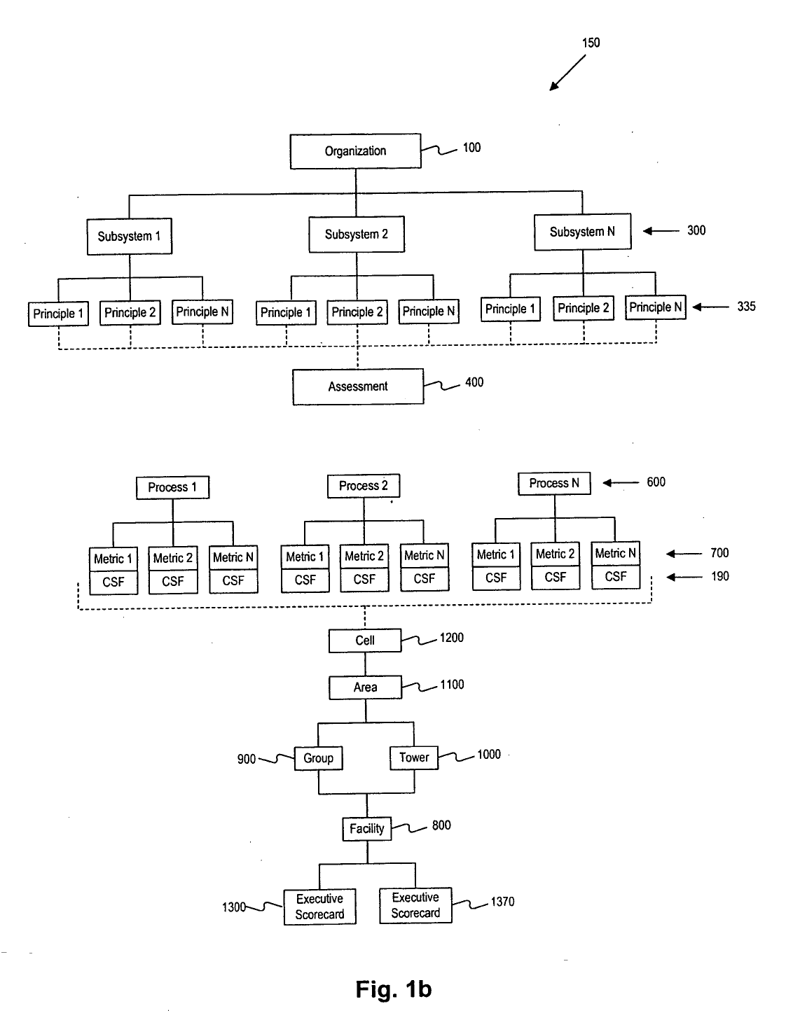

FIG. 1 depicts an exemplary business organization 100 consistent with certain disclosed embodiments. Organization 100 may be a company or other entity, though it will be recognized that organization 100 may be structured in any form desired, such as a corporation, partnership, or limited liability company. For example, in one embodiment consistent with FIG. 1, organization 100 may be a corporation.

Organization 100 may be structured with one or more components, or levels, in a hierarchical relationship to facilitate both the decision-making process and the allocation of resources within organization 100 for the most effective production of goods or services. As shown in FIG. 1, organization 100 may include an executive headquarters 110 with one or more divisions 112, one or more business units 113, and one or more facilities 114, as may be the case with large companies, such as companies that produce a variety of products or provide a variety of services, or companies with a wide regional or even global reach. More specifically, executive headquarters 110 may exist as a separate central office in which executives at the highest decision-making level of organization 100 are centrally located to more efficiently make decisions concerning business operations across organization 100, with one or more divisions 112, business units 113, and facilities 114 geographically situated, locally or worldwide, to take advantage of factors specific to business operations, such as the locations of raw materials, labor, and/or customers. A division 112 may serve as an intermediate managerial entity within organization 100 while facility 114 may refer to a physical location with associated equipment in which production of goods or provision of services takes place. A business unit 113 may serve as a second intermediate managerial level. Alternatively, if organization 100 is relatively small or produces a narrow range of products or services, the entire hierarchical arrangement of the organization, including all management and operations, may exist on a much smaller scale, for example, all within one physical structure.

Executive decisions made within organization 100 may involve all aspects of the business, including, for example, financial, operational, or personnel issues. In one embodiment, executive headquarters 110 may oversee the operations of the entire organization 100 through direct management of facilities 114, with no intermediary divisions 112 or business units 113 required. Alternatively, depending on the size of organization 100, executive headquarters 110 may indirectly manage facilities 114 through the one or more divisions 112 and/or business units 113, in which case, for example, a division 112 may directly oversee the operations of one or more facilities 114 within a particular geographic region or product or service category in furtherance of the goals of organization 100. In such a case, facilities 114 may report directly to a division 112, and one or more divisions 112 may report directly to executive headquarters 110. Such a top-down structure of authority is well understood in business and other contexts as an efficient method of decision making and execution of operations.

Referring again to FIG. 1, facilities 114 may contain the structure, equipment, and personnel required to produce a good or provide a service and will be described in detail below. At the hierarchical level of facilities 114 may be other supporting entities such as support centers 116 and distribution centers 118. A support center 116 may provide support to facility 114 in various forms. For example, for a facility 114 producing consumer goods, support center 116 may provide maintenance of production tools within facility 114 or, as another example, may provide packaging and material handling support. Support center 116 may be physically separated from or within facility 114, depending on the needs of organization 100. A distribution center 118 may provide the means for goods produced by production facility 114 to reach customers and provide a faster response to customer needs for service. Various methods of commercially distributing goods to customers are well known, for example, distribution center 118 may be a wholly or partially owned unit of organization 100, or, alternatively, may be part of an independent network of dealers. Organization 100 may also choose to sell and/or deliver goods directly to its customers. It should be recognized that any particular organization 100 may include a number of additional entities, not shown, utilized for the creation of goods and/or services. For example, entities associated with human resources, marketing, research and development, or training exemplify a few of the elements supporting the business of organization 100. Such elements may exist within any of the previously identified levels of organization 100 or they may be separately located units. These elements and their operations are commonly known and understood in the business organization context.

In one embodiment consistent with FIG. 1, organization 100 may be a corporation that produces machines and machine parts for customers all over the world. Further description of organization 100 will be directed to this type of organizational embodiment, although the following description may apply and be adapted equally to any type of organization 100 formed to produce goods or provide services.

Referring to FIG. 1a, in an organization 100 that manufactures goods for customers, production of goods takes place at the level of one or more facilities 114. The physical location of a facility 114 may be within a single building or it may be among one or more buildings. In an exemplary facility 114 of a present embodiment, one or more discrete functions will take place in order to produce a finished good. The entirety of actions within facility 114 for this purpose may be referred to as a value stream. In particular, the term “value stream” includes all of the actions required to bring a product from an initial order from the customer to delivery. These actions may include value-adding actions or non-value-adding actions and may encompass, among other things, actions to process information to and from the customer and actions to transform a product that is destined for a customer. “Value” refers to the inherent worth of a product as judged from the perspective of the customer. A value stream 119 may consequently be referred to as a group of linked value-added processes, wherein a “process” refers to a series of two or more steps that may transform one or more inputs into an output to meet the need of an external or internal customer. An external customer is a customer in the traditional sense, such as an end user of a product, while an internal customer may be, for example, a downstream step in the assembly process of a final product within facility 114.

Each facility 114 may include one or more groups 120. A group 120 may be the next hierarchical level below facility 114 and operate as a “product level” within facility 114, serving to order one or more areas 122 for reporting or other organizational purposes. The general function of an area 122 is to carry out the discrete processes of value stream 119, described above, and facilitate reporting of that value stream. Area 122 may itself include one or more levels for additional demarcation of production or assembly tasks of value stream 119. For example, any area 122 (implementing the processes of value stream 119) may be further divided into one or more cells 124 such that production is dispersed functionally in a way that increases accountability while allowing for task specialization.

As an example, in a facility 114 of an organization 100 that produces heavy-duty trucks, a value stream 119 may include one or more processes carried out on the production floor, i.e., through areas 122, as described above. A value stream 119 may be categorized broadly, and, as a specific example, include all the steps required to assemble a diesel engine. In that situation, cells 124 may include engine block casting, piston assembly, or crankshaft construction. Or, a value stream 119 may be defined more narrowly, such as to include all steps to produce an engine block, in which case a first cell 124 may include foundry work, a second cell 124 may clean the cast block, and a third cell 124 may perform machining. In this manner, all steps required to produce a product are organizationally accounted for within the hierarchy of facility 114.

A production system and more particularly a system and method of process improvement for the production of products within an organization is hereby described. The production system defines, based on organization 100 priorities, how to implement, improve, and sustain the processes required to decrease wastes in order to enhance product quality and customer satisfaction. The production system is universal in its application across and within each and every level of organization 100.

### Organizational Production System

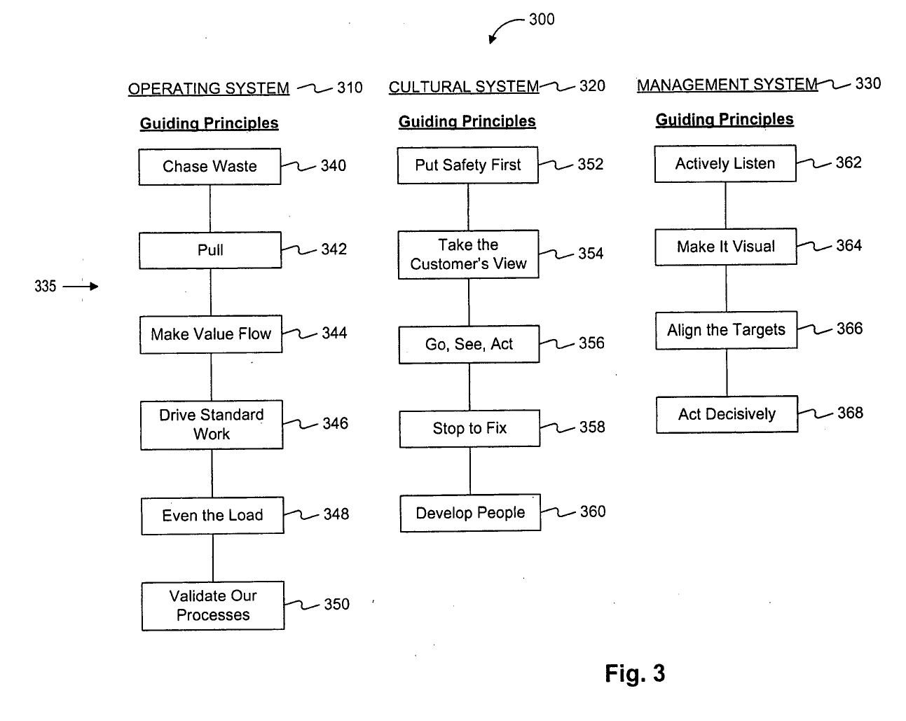

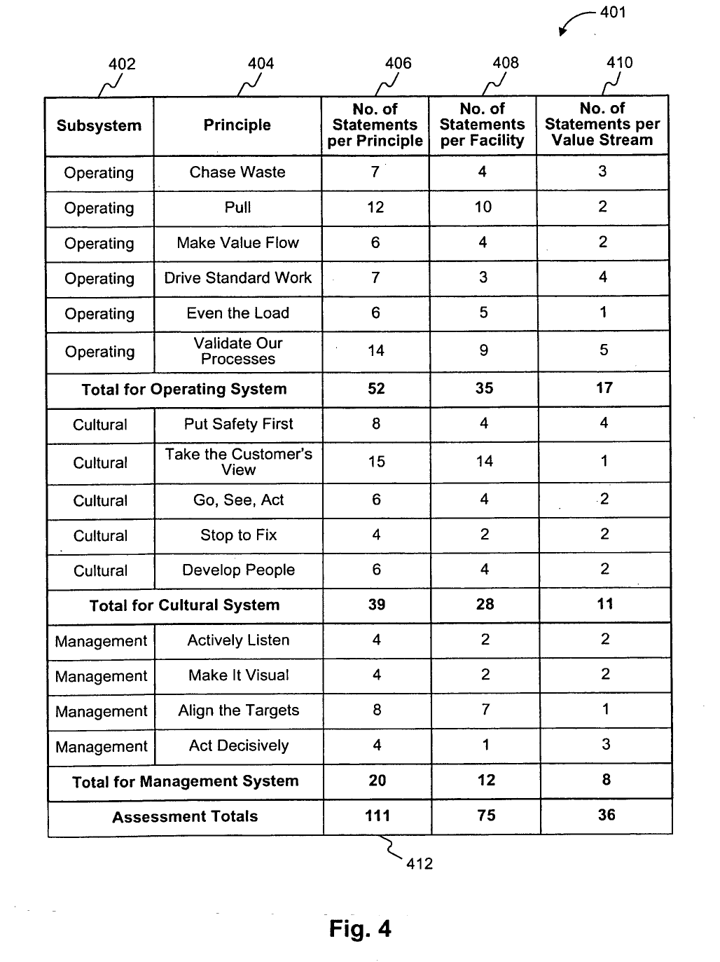

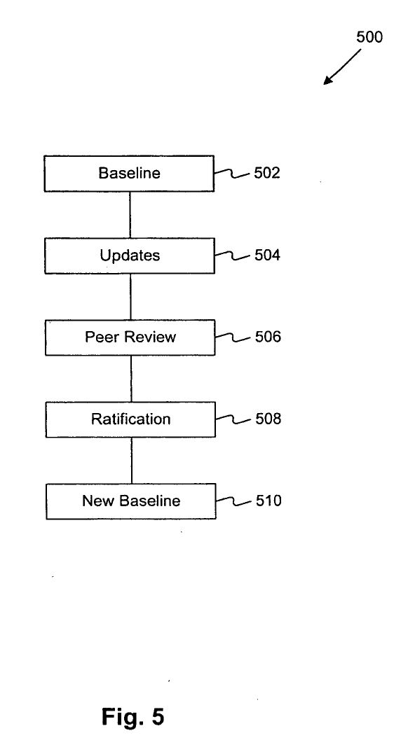

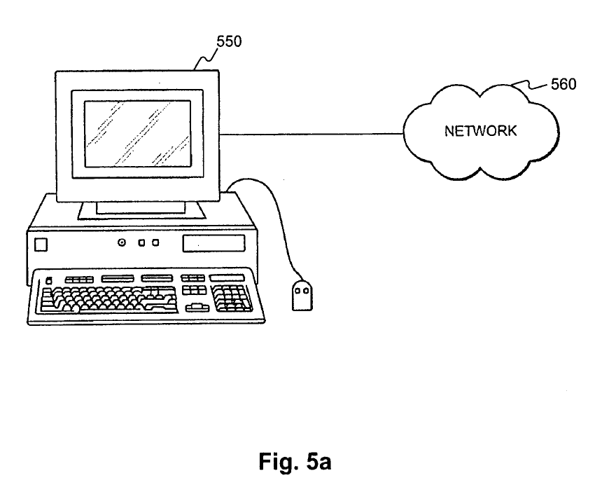

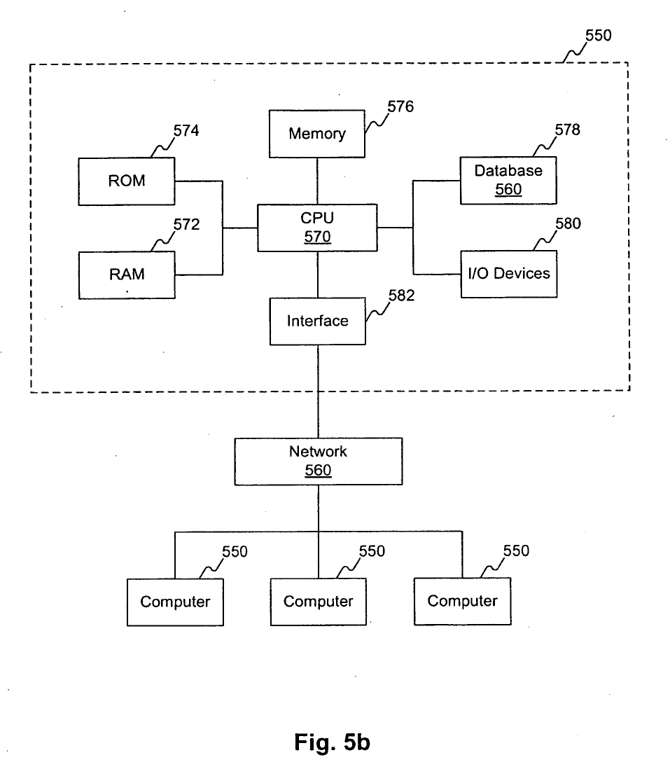

To establish a framework for an organizational production system 150, as shown in FIG. 1b, an organization 100 may include one or more subsystems 300 to more easily delineate areas of organization 100 for continuous improvement. The subsystems 300 may each include one or more guiding principles 335 that define the approach to work within organization 100. Subsystems 300 and guiding principles 335 are further detailed below and in FIG. 3. To evaluate adherence to guiding principles 335, organization 100 may conduct an assessment 400 and, depending on the results, adjust organizational resources accordingly. Assessment 400 may also establish a baseline for further improvement and is further described below (see FIGS. 4, 5).

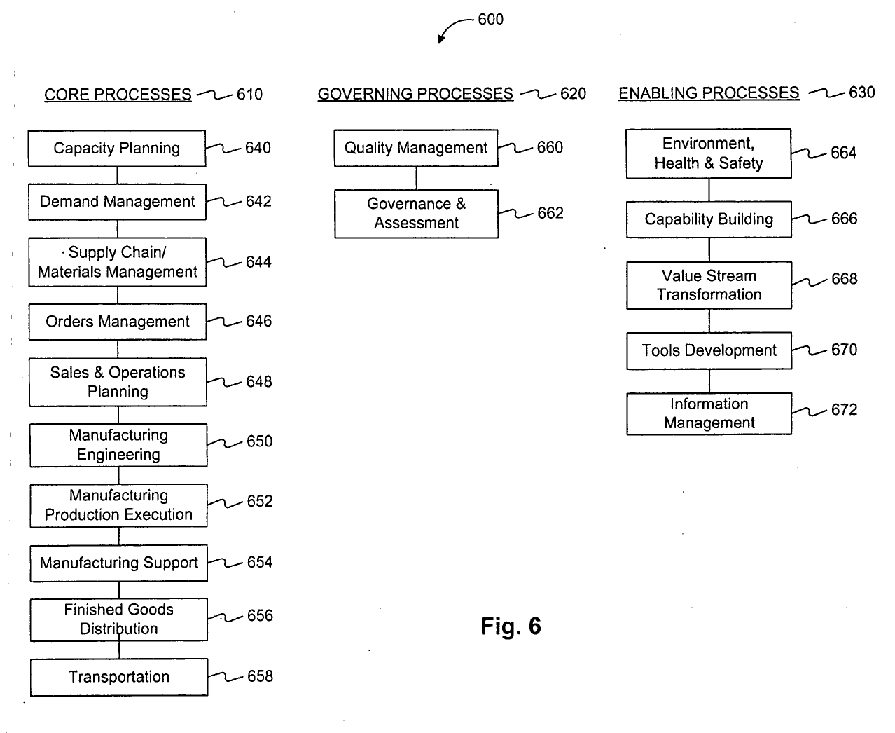

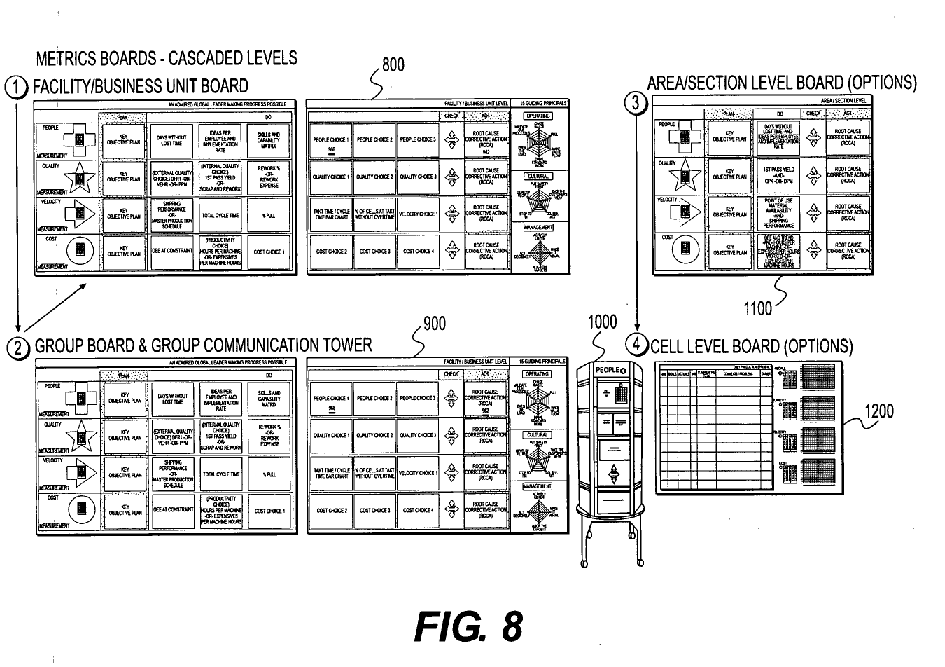

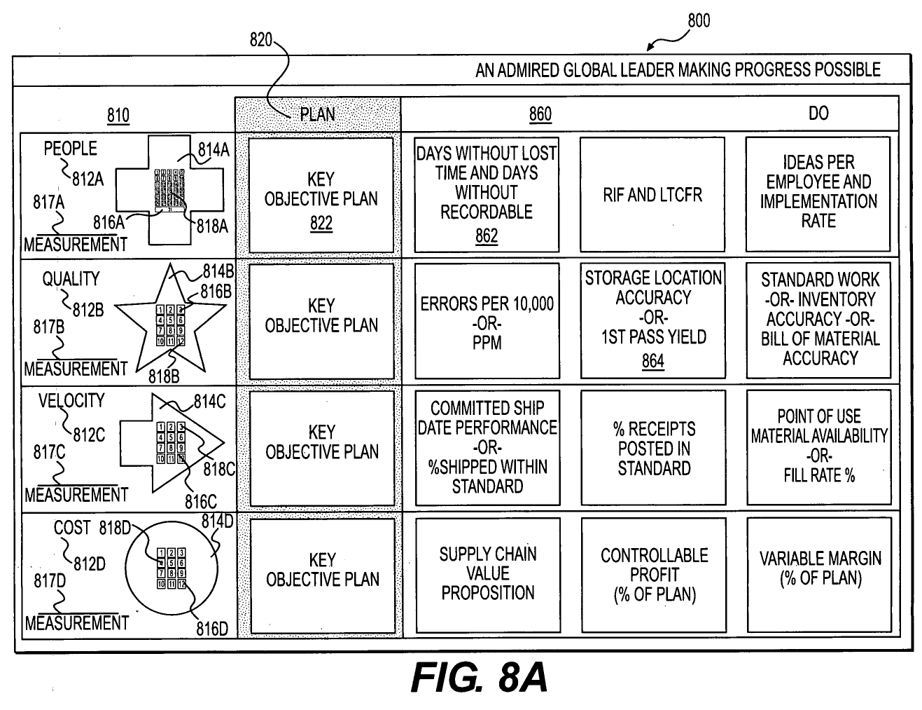

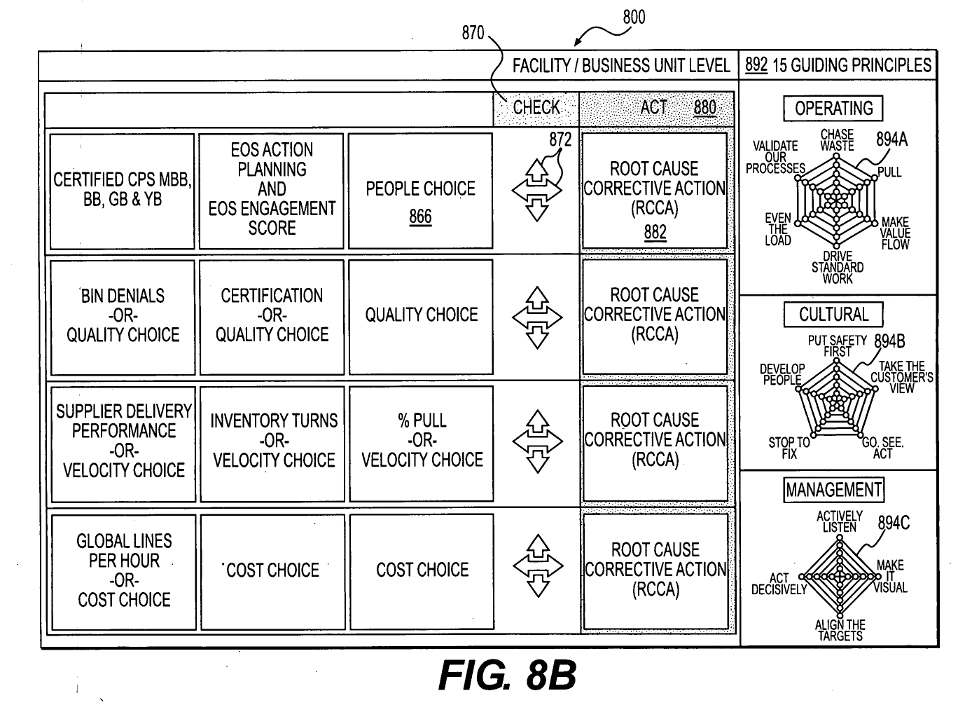

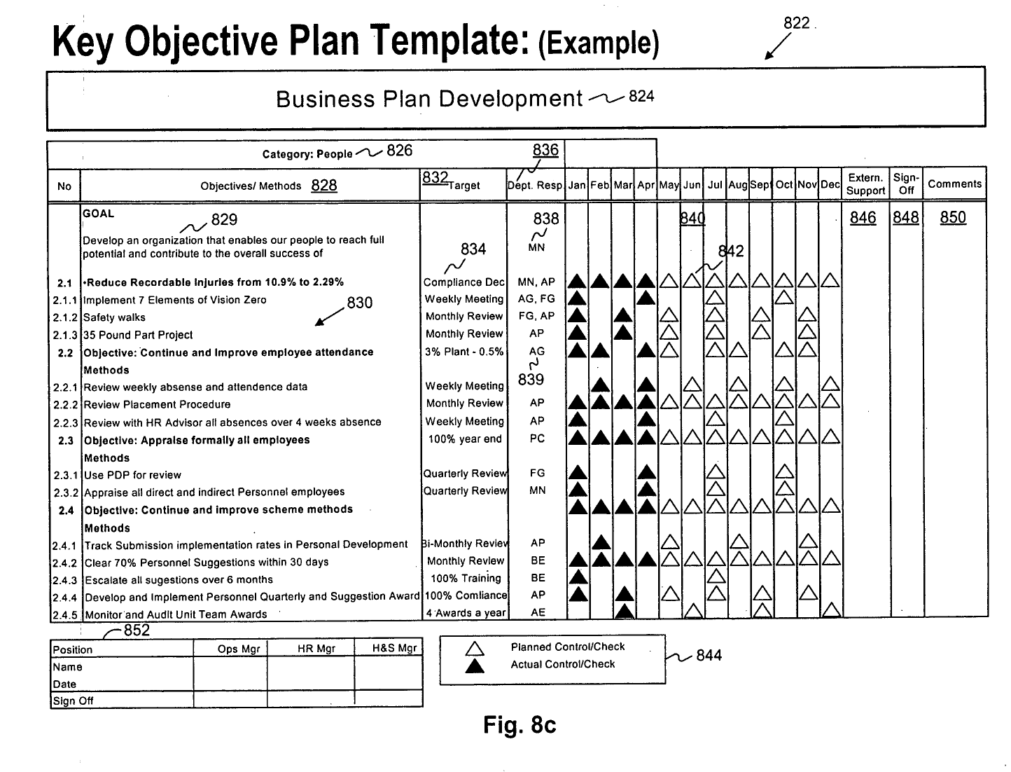

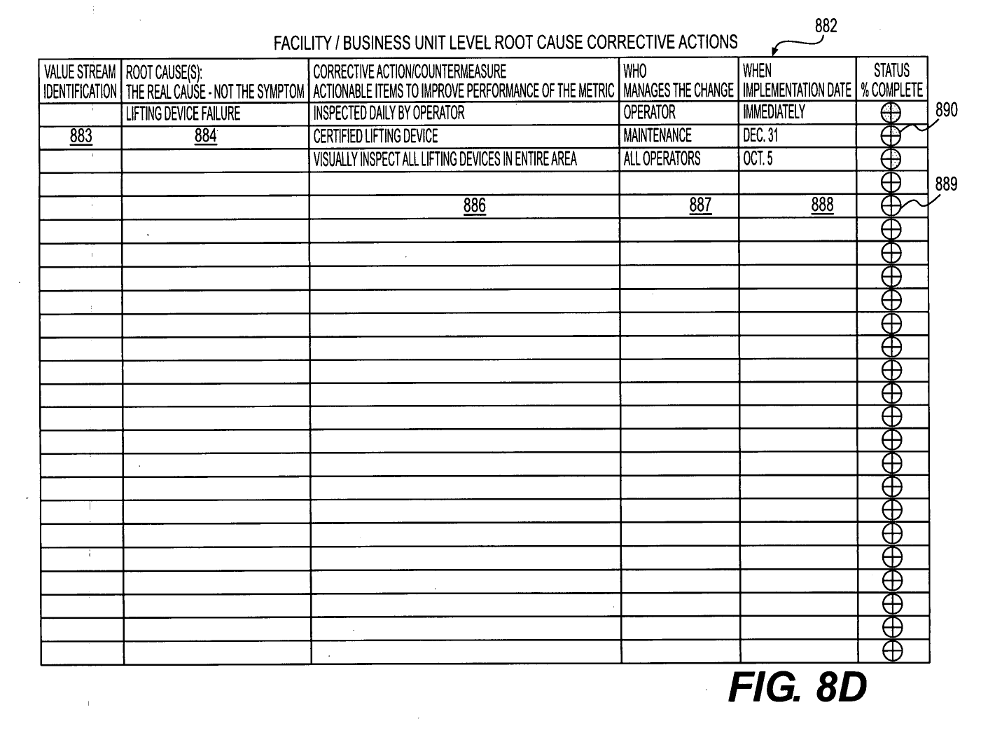

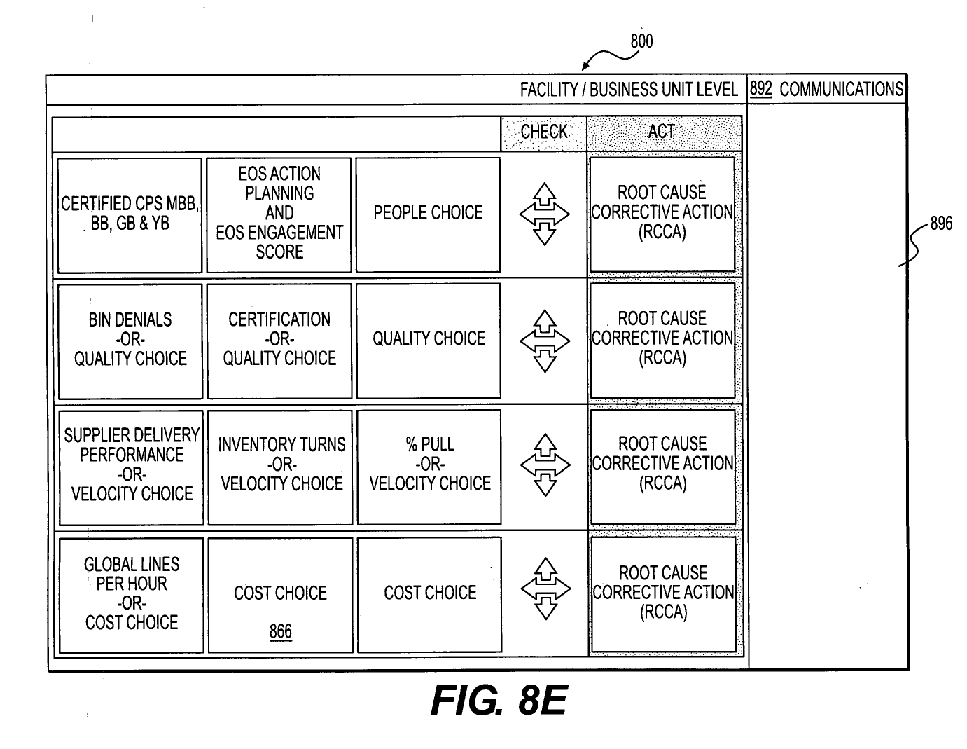

To implement organizational production system 150, organization 100 may establish one or more practices, or processes 600 (see FIG. 6), with each process having distinct performance metrics 700 and with each metric associated with one of the critical success factors 190 (abbreviated as CSF in FIG. 1b) of organization 100, further described below. Metrics 700 may ensure process conformance through common measurement and may be displayed on one or more displays and/or executive scorecards 800-1370, as shown in FIGS. 8-13b. Cascading of select metrics 700, along with Process Improvement Dialogues and the Continuous Improvement process (further described below) may lead to implemented changes in organization 100 operations for consistent improvements in the order-to-delivery practices of organization 100.

I. Critical Success Factors

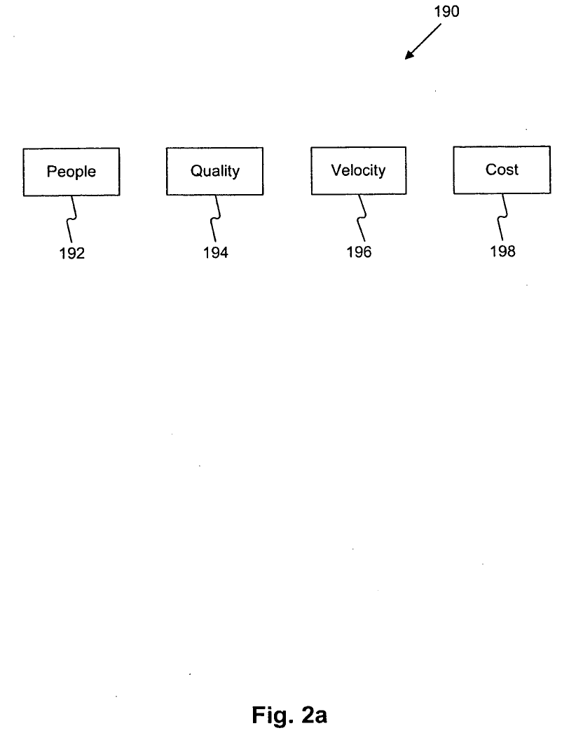

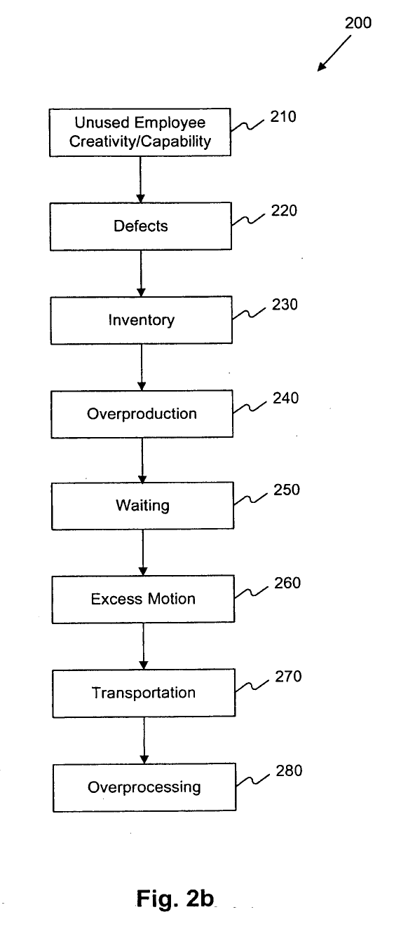

To initiate a focus of priorities, organization 100 may define one or more critical success factors 190 as top priorities upon which to base success and focus improvement. As shown in FIG. 2a, organization 100 may include a critical success factor 192, People, wherein the well-being of employees and personnel is of paramount importance to the success of organization 100. As another example, another critical success factor 194, Quality, may focus on ensuring the best possible quality of every part or machine made or assembled resulting in limited service issues for customers. As yet another example, organization 100 may choose to include a critical success factor 196, Velocity, which entails meeting customer demands through sustained production output, not only in terms of a timely final end product but through the efficient movement of parts and sub-assemblies within and throughout facilities 114. And, as still another example, a fourth critical success factor 198, Cost, may focus on the reduction of unwanted production costs, for example, unnecessary overtime or scrap/rework within the production process. Critical success factors 190 may therefore serve as an underpinning for organizational production system 150 of the present embodiment and may be used in evaluating the performance of organization 100, as will be later shown. Organization 100 may, of course, choose to focus on other factors it deems critical to success.

II. Wastes

One of the primary goals of organizational production system 150 is the elimination of waste throughout the company. “Waste” refers to any activity that consumes resources but creates no value for the customer. Organizational production system 150 will encourage the detection of waste in all forms. In so doing, organization 100 may designate one or more specific waste categories 200 to further define one or more areas on which to concentrate efforts, as shown in FIG. 2b.

For example, waste may be characterized as waste 210, Unused Employee Creativity/Capability, in which opportunities may be lost when employees are not fully engaged for input in any given process or not available due to an injury sustained during production. As a result, a primary goal of organization 100 may be to encourage all employees at all levels to participate in the effort for continuous process improvement, rather than to rely on managerial directives. For example, employees at a cell 124 may be able to offer ideas for improvement based on day-to-day observations from a perspective unavailable to others within facility 114.

Other types of waste may be recognized within organization 100. A waste 220, Defects, may be characterized with respect to product defects, in which, for example, specific machine parts may have been produced outside of specifications and cannot be further used, or a part requires reworking to conform it to accepted tolerances. A waste 230, Inventory, may relate directly to inventory levels and include excess raw material, work that is in production, or work that is finished but has not yet been delivered to a distributor or customer. Inventory within facility 114 not being used or delivered is representative of cost instead of revenue. In a similar manner, a waste 240, Overproduction, may be characterized as production of products beyond the requirements of a distributor or, within facility 114, beyond the requirements of a subsequent step in the production process. A waste 250, Waiting, may be characterized with respect to time, in that shortages or bottlenecks may develop within facility 114 due to equipment downtime or process inefficiencies. Deficiencies at one step in the production process may then rapidly lead to delays, waiting, and other inefficiencies at other steps. A waste 260, Excess Motion, may exist within, for example, any cell 124, contributing to a production step that is not wholly efficient, e.g., if due to unnecessary employee movement within a cell 124. Similarly, a waste 270, Transportation, may be related to excessive movement of goods between cells 124. A waste 280, Overprocessing, may be characterized as work done at any level, for example, non-production documentation work, providing no value to the customer or to organization 100. To the extent such administrative tasks can be minimized, or the time to complete them reduced, organization 100 may then devote its resources to its core production competencies.

III. Subsystems

As a primary goal of organizational production system 150 is to eliminate waste, organization 100 may define one or more subsystems 300, as shown in FIG. 3, to facilitate continuous process improvement through the recognition and purging of current and potential areas of waste (see FIG. 2b). Exemplary subsystems 300 may include an operating subsystem 310, a cultural subsystem 320, and a management subsystem 330.

Operating subsystem 310 may define the physical layout of facilities 114, the movement of materials within and between facilities 114, and other production components of value stream 119 and/or groups 120, areas 122, or cells 124 within value stream 119. Operating subsystem 310 may eliminate waste using common methodologies, for example, Six Sigma tools and methods. Whereas operating subsystem 310 may represent operational aspects of the business of organization 100, cultural subsystem 320 may encompass aspects of the human elements within organization 100, specifically of value streams 119. Cultural subsystem 320 includes the creation of an environment within organization 100, specifically concerning environmental conditions on the production floor, in which employees may be encouraged to contribute ideas directed toward enhancing the production process in accordance with the goals of organization 100. Cultural subsystem 320 may consequently be considered as allowing and promoting change within organization 100. Management subsystem 330 may facilitate cultural subsystem 320 by creating the measurements and management structure that support continuous improvement, encouraging and rewarding continuous improvement throughout organization 100 and communicating organization 100 goals and expectations. These three subsystems mutually support one another within organizational production system 150 of organization 100 to achieve continuous process improvement.

A. Principles

Referring to FIG. 1b, within each subsystem 300, organization 100 may identify one or more guiding principles 335 to further define a desired approach to the production of goods and/or provision of services. Guiding principles 335, as organizational principles, may be considered as disciplines to be mastered for long-term sustainability of organizational production system 150 and are defined in such a way as to exemplify the operational, behavioral, and leadership qualities desired throughout organization 100 for business excellence. Referring to FIG. 3, these guiding principles are further grouped by specific subsystem 310, 320, or 330.

Operating subsystem 310 may include a principle 340, Chase Waste, focusing on a continuous identification and elimination of waste in all production processes to significantly improve performance and customer service. For example, any of the wastes described in reference to FIG. 2b may be specifically identified and eliminated in accordance with this principle. Organization 100 may prioritize one or more wastes within principle 340, for example, wastes related to employee safety or product quality, e.g., waste 210, Unused Employee Creativity/Capability, and waste 220, Defects, respectively.

Operating subsystem 310 may also include a principle 342, Pull, focusing on the use of pull replenishment to only build products that are needed at the time they are needed and in an amount needed. “Pull” refers to a method of production control in which downstream activities signal a need for product to upstream activities. For example, in the production of heavy trucks, a cell 124 that installs an engine on a chassis may signal upstream to a chassis cell 124 to construct one or more chassis, depending on capacity. In that manner, using a pull method of production strives to eliminate overproduction (i.e., waste 240) within value stream 119 and aligns processes with customer requirements.

Operating subsystem 310 may also include a principle 344, Make Value Flow, focusing on the simplification of production processes to more rapidly identify issues or potential issues within the process, thereby increasing process efficiency. This may also promote the smooth flow of products from one workstation to the next. For example, a process may include one or more steps that are unnecessarily repetitive or could be combined in some manner. Eliminating extra steps may reduce future issues, increase the efficiency of that process, and ultimately lessen wastes 260, Excess Motion, and 270, Transportation.

Operating subsystem 310 may also include a principle 346, Drive Standard Work, in which standardization of production processes may be desired as a method for process efficiency and continuous process improvement. Standard work is the organization of tasks into the best known sequence of procedures to make the most efficient use of people, equipment, and resources. For example, processes common to one or more cells 124 may be standardized across those cells, allowing for a more efficient monitoring of and training on those standardized processes. Documented, repeatable standard work ensures performance consistency and high-quality products while contributing to continuous improvement, i.e., reduction of waste 280, Overprocessing.

Operating subsystem 310 may also include a principle 348, Even the Load, focusing on a desire to balance the workload and reduce process variability. For example, overload of work in one area 122 may be alleviated by transferring personnel or equipment from another area 122 currently being underutilized. Or, work itself may be moved from one area 122 to another area 122. Such balanced workflow may reduce the impact on organization 100 employees and equipment and may lessen the amount of overtime required. Such an evening of the load requires constant and open communications across value stream 119 but may result in the lessening of waste, such as waste 250, Waiting, and balanced production for customer satisfaction.

Operating subsystem 310 may also include a principle 350, Validate Our Processes, which focuses on proving a particular process and/or technology is viable before introducing it as or within an existing production process. For example, a new technology for welding may be thoroughly tested not only for its technical superiority but for its practical effectiveness in a production process. Implementing a new technology only after thorough consideration followed by validation may provide a smoother technological transition through fewer potential defects, i.e., waste 220, decreasing the risk to both organization 100 and its customers.

Cultural subsystem 320 may include a principle 352, Put Safety First, focusing on building a culture within organization 100 that prioritizes the well-being of personnel and the elimination of safety-related waste, i.e., waste 210, from production-related injuries that diminish an employee's ability to contribute to the production effort.

Cultural subsystem 320 may also include a principle 354, Take the Customer's View, in which a focus of organization 100 is viewed from the perspective of the customer, both external and internal, and decisions may be made with that perspective in mind, all in the context of the long-term business strategy of organization 100. For example, a customer's long-term requirements for a certain product to be delivered at a certain time may necessitate altering the short term sales and delivery goals of organization 100. Knowing the customer's expectations may also play a role in reconsidering short-term production goals to meet those expectations. This may decrease, for example, wastes 230, Inventory, and 240, Overproduction.

Cultural subsystem 320 may also include a principle 356, Go, See, Act, which focuses on first-hand observation of processes for thorough understanding. Through this understanding, process challenges may be most efficiently determined and issues rectified. For example, a concern arising in a cell 124 may be observed directly before a correction plan is implemented to more efficiently and quickly develop a lasting and successful solution. Principle 356 also encompasses the expectation that organization 100 leaders will frequently visit the production floor, engage organization members in understanding the production processes and current issues, work with those members to develop solutions, and provide support by removing obstacles to efficient production. Efforts such as this may reduce waste 210, Unused Employee Creativity/Capability.

Cultural subsystem 320 may also include a principle 358, Stop to Fix, focusing on immediate cessation of a production process when an issue occurs to allow correction of that issue in process, in furtherance of decreasing waste 220, Defects. For example, an issue with a spray painter in a cell 124 would require that cell 124 to immediately stop in order to evaluate and plan a repair option. In this manner, difficulties do not continue to a further step in the process, requiring costly downtime, rework, or other inefficient and wasteful procedures. Additionally, the development of solutions may be done with an eye to the root cause of the problem such that meaningful corrective solutions may be implemented in lieu of temporary, undependable quick fixes.

Cultural subsystem 320 may also include a principle 360, Develop People, which focuses on the identification and acquisition of people and the development of individuals and teams in accordance with the long-term goals of organization 100. Investment in organization 100 personnel may be premised on the fact that it greatly diminishes unused employee potential (waste 210) and leads to long-term satisfaction of customer needs and, consequently, of the organization itself.

Management subsystem 330 may include a principle 362, Actively Listen, focusing on encouraging organization 100 personnel to offer ideas and proposals for continuous improvement. For example, focused discussions, such as Process Improvement Dialogues, may be conducted at all hierarchical levels to further the goal of encouraging and subsequently implementing ideas presented by all personnel, in furtherance of the goal of reducing waste 210, Unused Employee Creativity/Capability. A Process Improvement Dialogue refers to structured talks that take place at specific locations at regular intervals. These talks are focused on metrics 700 (see FIG. 1b and further described below) and established business goals with a particular emphasis on how a specific hierarchical level has progressed in that effort and on further possibilities for improvement. Process Improvement Dialogues will be more fully discussed below.

Management subsystem 330 may also include principle 364, Make It Visual, focusing on building a visual workplace, such that no defects are hidden. A visual workplace may allow for the rapid identification and resolution of inefficient conditions. One primary method of facilitating this, discussed below, may be through the use of particular visual displays at certain hierarchical levels. These displays may facilitate daily discussions and permit organization 100 employees to further realize opportunities for process improvement, again, reducing waste 210.

Management subsystem 330 may also include principle 366, Align the Targets, focusing on deploying “cascaded metrics” (described below) with process targets throughout the hierarchical levels of organization 100. The cascaded metrics may allow immediate and continuous monitoring of progress and aid in the setting of priorities. They may be aligned to an overarching strategy of organization 100 and further understanding among organization 100 personnel of their daily contribution to executing that strategy. As such, cascaded metrics may promote collaboration to achieve the goals of organization 100, while decreasing the incidence of waste 210. Cascaded metrics will be more fully explained below.

Management subsystem 330 may also include principle 368, Act Decisively, focusing on making decisions by consensus, fully considering all options and implementing decisions swiftly and deliberately. Adherence to this principle advances the discussion of current issues, the identification of root causes, and the implementation of the best possible solutions with the full support of all involved, while also reducing, for example, waste 250, Waiting.

1. Assessment

Guiding principles 335 identified above within each subsystem 300 serve a fundamental purpose within organization 100, as they provide a framework under which organization 100 may operate both across and within all business levels, including within any facility 114, from top to bottom. Conformance to guiding principles 335 promotes the achievement of organizational production system 150 goals required for continuous process improvement. Referring to FIG. 1b, the vehicle for evaluating conformance to guiding principles 335 is assessment 400. A derivative intent of assessment 400 is to establish a baseline for improvement. Assessment 400 provides a standard template for facilities 114 to understand previously evaluated performance baselines against the guiding principles, compare the organization's actual performance to its potential expected performance, and to develop plans for improvement. Assessment 400 may further allow organization 100 to identify and prioritize the placement of resources for maximum effect.

To evaluate the adherence of organization 100 to guiding principles 335, assessment 400 includes a plurality of assessment question statements that are specifically aligned with guiding principles 335, with each question statement being specifically associated with a single principle. Specifically, many of the question statements may be uniquely tailored to a specific principle and therefore customized for that purpose. Moreover, because processes 600 of organization 100 (further described below) each enable one or more guiding principles 335, one or more question statements tailored to that principle may also be specifically aligned to a particular process. In effect, such a tailoring may permit organization 100 to drive the behaviors of the organization in accordance with subsystems 300.

FIG. 4 shows in chart form one possibility of the relationship of guiding principles 335 to subsystems 300 and an exemplary distribution of question statements. Chart 401 includes a column 402, Subsystem, listing the particular subsystem for which each principle listed in column 404, Principle, may be associated. Each principle of column 404 may in turn be linked with one or more question statements. Column 406, Number of Statements per Principle, indicates the number of question statements allocated to each principle. Additionally, each question statement may address a principle either at the level of facility 114 or at the level of value stream 119. This allows each value stream 119, of which there may be more than one within any facility 114, to be evaluated independently of that facility 114. As shown in FIG. 4, columns 408, Number of Statements per Facility, and 410, Number of Statements per Value Stream, indicate, respectively, how many of the question statements of adjacent column 406 are further applicable at the facility 114 level or the value stream 119 level. In this embodiment, this question statement structure is consistent for all three subsystems 300 and their respective principles, but other combinations are possible. In this structure, all question statements for organization 100 may be categorized to maximize each statement's value to organization 100.

When all value streams 119 in facility 114 have been assessed, facility 114 may be evaluated based on combined value stream performances along with specific facility level statements. This evaluation will be further explained below. In one embodiment, each facility 114 within organization 100 may be assigned the same question statements to permit direct comparisons of facilities 114, though all facilities 114 may also be evaluated independently.

Question statements may vary greatly in context and scope. The following illustrations of question statements for guiding principles 335 within subsystems 300 (see FIG. 3) reflect within the statement the fundamental premise of the associated guiding principle.

Referring to FIG. 4, a question statement for the first operating principle, Chase Waste, may be: “We have been trained to identify and eliminate the 8 wastes.” A question statement for the second operating principle, Pull may be: “Greater than 80 percent of direct inbound material is on Pull.” A question statement for the third operating principle, Make Value Flow, may be: “All demand streams including service parts are consolidated and considered in the supply planning process.” A question statement for the fourth operating principle, Drive Standard Work, may be: “New jobs have Standard Work developed and validated prior to production release.” A question statement for the fifth operating principle, Even the Load, may be: “For commercial orders, priority is given to customer orders. Inventory and rental orders are used to level the production plan.” A question statement for the sixth operating principle, Validate Our Processes, may be: “Quality plans are clearly communicated to all workforce members in station.”

Again, referring to FIG. 4, a question statement for the first cultural principle, Put Safety First, may be: “A quantitative safety and ergonomic assessment has been completed on all jobs. Work elements have been evaluated and risks have been reduced to a medium or lower level for all jobs/work elements within the value stream.” A question statement for the second cultural principle, Take the Customer's View, may be: “Standard customer orders are acknowledged within 48 hours. The number of customer orders waiting processing is measured and managed using standard enterprise guidelines.” A question statement for the third cultural principle, Go, See, Act, may be: “Executive Officers attend five (5) Rapid Improvement Workshop report out meetings annually.” A question statement for the fourth cultural principle, Stop to Fix, may be: “We delay workstation and/or product assembly station activities until all parts are physically present according to the plan.” A question statement for the fifth cultural principle, Develop People, may be: “Workforce members and teams are recognized and rewarded for achieving goals and certifications. A formal recognition plan is established and documented.”

Still referring to FIG. 4, a question statement for the first management principle, Actively Listen, may be: “The Continuous Improvement process is in place to support management's commitment to review innovative ideas from all sources. Feedback is provided in compliance with the defined production system process.” A question statement for the second management principle, Make It Visual, may be: “Engineering change material, obsolete material and non-conformance/scrap areas exist with proper visuals. Control procedures are in place and followed to prevent their use in production.” A question statement for the third management principle, Align the Targets, may be: “Metrics are posted on the standard metric boards directly linked to the annual business plan and long-term strategy. These metrics are updated in compliance with the production system standard.” A question statement for the fourth management principle, Act Decisively, may be: “Support staff is in place for assessment of Continuous Improvement issues and ideas. 80% of all issues and ideas are assessed and closed within 30 days. There are no past due issues and ideas in the Continuous Improvement process.”

While these examples from FIG. 4 are representative of one or more question statements, it is readily apparent that a variety of question statements for guiding principles 335 may be utilized by organization 100, depending on the goals of assessment 400. In the embodiment of FIG. 4, the total number of question statements, 111, is spread throughout fifteen principles, as shown in box 412, although organization 100 may vary the number of question statements per principle as well as the distribution of question statements to facility 114 and value stream 119, e.g., where the total number of question statements for facility 114 is 75 and the total number of question statements for value stream 119 is 36, as one example in this embodiment.

As shown in FIG. 5, assessment 400 may be completed formally at least once a year within organization 100, however, an assessment cycle 500 may include one or more scheduled events leading up to the execution of this formal assessment. To facilitate assessment cycle 500, each facility 114 may form a facility team of individuals specifically responsible for the assessment for that facility 114. The facility teams may, among other things, re-assess and update one or more question statements as facility 114 improvements are realized to more accurately capture the evolving focus of organization 100 for process improvement.

Referring to FIG. 5, assessment cycle 500 may begin with stage 502, Baseline, in which baseline (comparative standard) scores are determined using a self-assessment completed at some other time or using ratified assessment scores from a previous time period. A self-assessment for facility 114 may be performed at any time by facility 114. Such a self-assessment may be needed as a baseline during an initial assessment process (for example, if no prior year assessment exists from which to obtain numerical data) or if one or more assessment parameters is altered by organization 100, such that a new baseline is desired prior to formally executing the year-end assessment. Organization 100 may, of course, have additional reasons for conducting a self-assessment at any facility 114. From baseline scores, facility 114 may additionally conduct an analysis comparing the previous baseline scores with the desired targeted scores for facility 114. This type of analysis is commonly referred to as a gap analysis, and represents the comparison of the expectation of performance within facility 114 with the level of performance actually achieved, as reflected in the baseline scores. Facility 114 may then generate one or more improvement plans for each principle.

While the formal execution of the assessment may be accomplished once a year, reviews throughout the year, for example, on a quarterly basis, may be performed to gather information on current facility 114 progress toward organization 100 targeted goals and as a means to recognize potential areas of marginal performance. As shown in stage 504, Updates, these reviews may take the form of one or more visits to facility 114, or a less formal communication, such as a teleconference.

A formal on-site assessment may be completed once per year during stage 506, Peer Review, for each facility 114. During stage 506, assessment scores may be audited for validity and for reporting to the hierarchical levels of organization 100. Specifically, stage 506 may include validation of scores at both the facility 114 level and the value stream 119 level, review of the factual support behind the scoring of the corresponding question statements, and review of proposed improvement plans. The peer review of stage 506 also may provide a forum for the facility team to highlight areas of accomplished improvement within facility 114 as well as recognize opportunities for additional improvement. While stage 506 may at least focus on assessment score validation and proposed improvement plans, it may also include, for example, the identification of barriers within facility 114 to further progress toward the targeted goals. A peer review council may be formed for this purpose, consisting of organization 100 employees who are familiar with the assessment process and methods and employees who may provide leadership, expertise, and guidance in the development of improvement plans. The peer review council may facilitate the peer review process and, as one or more peer review council members may contribute to the peer review of multiple facilities 114, may provide a level of consistency in the formal assessment of stage 506.

A peer review of stage 506 may include a report, which may itself include updated assessment scores, one or more recommendations to facilitate further progress, required actions, and/or a twelve month action plan focusing on one or more guiding principles 335 (see FIG. 3). Organizational resources may be allocated accordingly. While the peer review of stage 506 generally occurs once per year, toward the end of the year, a peer review early in the assessment period may allow facility 114 to continue to realize improvements during the remainder of that assessment period, up to the point of stage 508, Ratification.

Stage 508, Ratification, may be scheduled toward the end of a calendar year, but other times are possible. The purpose of stage 508 is to confirm the year-end assessment score of facility 114. Any improvements made during the intervening period from the peer review of stage 506 may also be validated during stage 508. The score validated and agreed upon during stage 508 may become a new baseline of stage 510. This new baseline score may also be provided at any of the hierarchical levels of organization 100 for tracking progress against the following year's targeted goals. The baseline score of stage 510 initiates the continuous assessment process.

Responding to question statements may be accomplished as required to complete a formal assessment or a self-assessment. Responding to the question statements may be done manually or with the aid of a computer. Specifically, a web-based or other computer application may be used to provide the question statements to be answered, accept question statement responses, and perform scoring calculations. The web-based computer application may be an application designed and maintained by organization 100 and may include security or other parameters, such that the website is secured and accessible only to certain personnel, at certain locations, at certain times. Such security methods are commonly known. In one embodiment, only specified personnel responsible for a particular facility 114 may maintain and authorize access to the application. Such a web-based application may allow facility 114 personnel the ability to securely update performance as necessary or desired. A web-based application of this embodiment may also provide for automated real-time score calculation and viewing at both the levels of value stream 119 and facility 114. Organization 100 may assign certain organization members within facility 114 to complete all value stream 119 and facility 114 question statement responses using the aforementioned web-based application. These members may have additional duties with respect to assessment 400 (see FIG. 1b), as explained below.

Scoring assessment 400 is required if it is to be of practical use to organization 100. Many scoring methodologies may be employed to evaluate responses to question statements. In one embodiment, each statement may be evaluated using a scale that incorporates pre-determined criteria, such that a particular value corresponds to one of the pre-determined criteria, with the same scoring criteria applicable for question statements pertaining to both the level of facility 114 and the level of value stream 119. For example, a scale may range from a value of zero (0) to a value of five (5), with five being the highest score attainable. In that regard, a quantitative score may correspond to a qualitative measure of performance, pre-determined by organization 100. For example, a score of zero (0) on a response to an question statement may equate to “no plan in place to meet the question statement.” A score of one (1) may equate to “plan in place with performance measures established to meet question statement.” A score of two (2) may equate to “process implemented with performance metrics improving and a plan in place to sustain.” Metrics will be described in detail below. A score of three (3) may equate to “minimal acceptable performance as defined by criteria included with each statement.” A score of four (4) may equate to “better-than-acceptable performance with glide path established for ‘Best in Class.’” A glide path may be defined as a scoring evaluation in which a particular range of scores may be rated a certain way. To illustrate, scoring ranges may be ‘stepped,’ such that each jump to a successive range includes an easily recognized rating, for example, for a 100-point scale, 0-25 may be rated ‘bronze,’ 26-50 may be rated ‘silver,’ 51-75 may be rated ‘gold,’ and 76-100 may be rated ‘platinum.’ In this way, scoring targets may be easily associated with range identifiers, and organization 100 may then communicate specified scoring targets with such a system. The top score, five (5), may equate to “highest expected performance as defined by criteria included with each statement.” In this manner, each question statement response is matched with the appropriate qualitative criteria to determine a numerical value for each statement.

In one embodiment, the criteria required to achieve a certain numerical score may vary with respect to one or more of the numerical values. For example, while the criteria for numerical values zero (0), one (1), two (2), and four (4) generally may not vary from question statement to question statement, organization 100 may quantitatively customize the definition of “minimal acceptable performance” within value three (3) and the definition of “highest expected performance” within value five (5). By so doing, organization 100 may establish quantitative benchmarks of performance, which may then be directly reflected in the scoring system. For example, as applied to one particular example, a statement, discussed above, for the second cultural principle of FIG. 4, Take the Customer's View, may be “Standard customer orders are acknowledged within 48 hours. The number of customer orders waiting processing is measured and managed using standard enterprise guidelines.” In this particular example, a numerical score of three (3) may be given to the answer to this statement if, for example, 80% of standard customer orders are acknowledged within 48 hours during the last three (3) months. A numerical score of five (5) may be given if, for example, 98% of standard customer orders are acknowledged within 24 hours during the last six (6) months. Such a customization, by reflecting specific quantitative performance goals, may provide measureable performance targets and thereby achieve maximum flexibility in the overall assessment. Obviously, variations exist in quantitatively or qualitatively distinguishing specific scoring criteria within any one question statement and among all question statements organization 100 may utilize.

As described above, each question statement may address a specific guiding principle either at the level of facility 114 or at the level of value stream 119. In one embodiment, assessment scores are calculated independently for each principle at the level of each value stream 119, i.e., each value stream 119 within facility 114 responds to its own particularized question statements, principle by principle, generating a value stream 119 independent principle score and a indicating an initial value stream 119 level of compliance with a particular principle. Facility 114 also independently answers question statements particularized at the facility 114 level, principle by principle, generating a facility 114 independent principle score. Because facility 114 independent principle score does not itself include the responses of value streams 119 within that facility 114, facility 114 independent principle score, by itself, may offer limited value to facility 114. It is instead automatically distributed to each value stream 119, such that each value stream 119 may integrate facility 114 independent principle score with its own independent principle score first calculated, as will be further explained below. The result of this integration, totaled across all value streams 119 within facility 114, is an integrated principle score for facility 114, which may indicate a facility 114 level of compliance with a particular principle, and may be distributed to facility 114 or elsewhere for organization 100 use.

Integrated principle score for facility 114 may be obtained in multiple ways, as the examples below will show. In one embodiment, this score may be obtained by first scoring each value stream 119 within facility 114 with respect to a particular principle and obtaining a value stream 119 independent principle score for each value stream 119. The facility 114 independent principle scores automatically distributed to value stream 119 may be integrated to obtain an integrated principle score for facility 114, as will be described in the following example. Organization 100 may desire to accord more or less weight to any of the value stream 119 independent principle scores or facility 114 independent principle scores, with a factor incorporated to reflect so. The total score for facility 114 may then be calculated by adding together the facility 114 integrated principle scores for each guiding principle of organization 100.

An example will show this particular embodiment in the context of an organization 100 producing heavy machinery, such as construction equipment. Specifically, organization 100 may include one facility 114 assembling skid loaders. Within that facility 114, one or more value streams 119 may, for example, produce individual components of a skid loader or contribute to the actual assembly of the skid loader. In particular, one value stream 119 may assemble a coupler for attaching various work tools to the skid loader (VS1). Another value stream 119 may assemble the hydraulics (VS2), and yet another may construct the cab for the skid loader (VS3). In this example, for purposes of the assessment, personnel assigned to complete question statement responses for VS1, using the web-based application described, may complete all responses for each value stream 119 level statement for each of the guiding principles of organization 100. Specifically, as noted above, an authorized individual for VS1 may access the computer application and locate the applicable portion of that application concerned with question statements at the level of value stream 119. Within that portion of the computer application, the authorized individual for VS1 would further locate the question statements for a single principle, e.g., principle 340, Chase Waste (P1) (see FIG. 3). Within that area of the computer application for P1 may be one or more specific question statements requiring response. Using the scoring scale previously described, the value stream 119 level question statements for P1 may be scored from zero (0) to five (5). The computer application may then calculate a VS1 independent principle score for P1. The authorized individual may continue to score value stream 119 level question statements for the remaining principles (P2, P3 . . . ). The individuals of organization 100 responsible for the assessment at VS2 and VS3 may likewise complete the identical process to arrive at VS2 and VS3 independent principle scores. Personnel assigned to complete question statement responses for facility 114, using the computer application described, may also complete all responses for facility 114 level statements for each of the guiding principles, obtaining a facility 114 independent principle score for each principle (P1, P2, P3 . . . ).

As this particular embodiment of the methodology initially concerns individual principle scores, a specific scoring example will further illustrate the scoring steps. Specifically, if P1 includes four questions at the value stream 119 level and two questions at the facility 114 level, with VS1 scoring 15 total for P1, VS2 scoring 12 total for P1, VS3 scoring 14 total for P1, and the facility 114 scoring 8 total for P1, using the scoring criteria described above, a facility 114 integrated principle score for P1 may be calculated as:

VS1 independent principle score, P1=(15/4)=3.75

VS2 independent principle score, P1=(12/4)=3

VS3 independent principle score, P1=(14/4)=3.5

Facility independent principle score, P1=(8/2)=4.

At this point, an integrated principle score for P1 for each value stream 119 may be established. If no particular weighting is to be given any particular question statement, to now integrate the facility 114 independent principle score for P1 for each value stream 119 in one embodiment may require acknowledging the number of question statements scored at each level. This example used four responses at the value stream 119 level and two responses at the facility 114 level. Therefore, for VS1, (3.75×(4/6))+(4×(2/6))=3.83. Likewise, VS2=(3×(4/6))+(4×(2/6))=3.33 and VS3=(3.5×(4/6))+(4×(2/6))=3.67. The facility 114 integrated principle score for P1 would then equal the P1 score for each value stream 119 divided by the number of value streams. Here, (3.83+3.33+3.67)/3=3.44. To arrive at a total facility score, similar calculations for P2, P3, P4 . . . would be calculated for VS1, VS2, and VS3. The sum of the facility 114 integrated principle score for each principle equates to the total facility score.

As well known to one skilled in the art, any factor could easily be mathematically combined with value stream 119 scores or facility 114 scores in order to weight either for any number of reasons. Alternatively, organization 100 may desire a facility 114 integrated principle score for P1 to merely represent the average of the combined value stream 119 principle score for P1 with the facility 114 independent principle score for P1, giving equal weight to value streams 119 and facility 114. Such mathematical methods are well understood and need not be discussed further.

In a scoring system as earlier described, with question statement scoring values from zero (0) to five (5), the highest score achievable for facility 114 would be five multiplied by the number of guiding principles selected by organization 100. If, for example, the fifteen principles previously described are selected, the highest possible score for facility 114 would be 5×15=75. Organization 100 may then selectively target desired scoring levels, with or without glide path concepts, for one or more facilities 114, thereby quantifying performance expectations and results. Facility 114 scores may be reported on an executive scorecard, to be further described.

In another embodiment, scoring may be accomplished with an initial focus not on each individual principle, but on each individual value stream 119. In this manner, an assessment score for an individual value stream 119 may be identified and utilized as desired within organization 100. To illustrate using previous value streams 119, if organization 100 realizes only three guiding principles, P1, P2, and P3, each including four questions for each principle at the level of value stream 119 and three questions for each principle at the level of facility 114, with VS1 scoring 15 total for P1, 12 total for P2, and 14 total for P3, and facility 114 scoring 8 total for P1, 14 total for P2, and 13 total for P3, a VS1 score may be calculated as:

$$\begin{matrix}Score , VS 1 = ( \frac{P 1 score}{no . of P 1 value stream level statements} ) + \\ ( \frac{P 2 score}{no . of P 2 value stream level statements} ) + \\ ( \frac{P 3 score}{no . of P 3 value stream level statements} ) + \\ = ( 15 / 4 ) + ( 12 / 4 ) + ( 14 / 4 ) \\ = 10.25 out of a possible 15 using a zero ( 0 ) to \\ five ( 5 ) scoring scale .\end{matrix}$$

This represents an assessment score for VS1, which may be used for independent evaluation of VS1. In a similar manner, assessment scores for VS2, VS3, and the remaining value streams 119 throughout facility 114 may be obtained. The facility 114 independent principle score may similarly be calculated as:

$$\begin{matrix}Score = ( \frac{P 1}{no . of P 1 facility level statements} ) + \\ ( \frac{P 2}{no . of P 2 facility level statements} ) + \\ ( \frac{P 3}{no . of P 3 facility level statements} ) + \\ = ( 8 / 3 ) + ( 14 / 3 ) + ( 13 / 3 ) \\ = 11.67 out of a possible 15 using a zero ( 0 ) to \\ five ( 5 ) scoring scale .\end{matrix}$$

As before, facility 114 independent principle score may be integrated into the value stream 119 scores at the level of each value stream 119, proportioned if desired, using various commonly known techniques. As with the principle-based calculations, organization 100 may then formulate quantitative scoring targets for facilities 114, as previously described.

In order to further benchmark organization 100 goals and progress, each guiding principle may include a statement among its pre-defined question statements that more clearly emphasizes a quality desired by organization 100 for short-term focus. This statement, referred to as a trigger statement, may be determinative in its scoring as a maximum score, such that, for example, for each value stream 119, the independent principle score, as calculated above, may not numerically be greater than the trigger statement score. This trigger statement may also quantitatively vary depending on the short-term focus of organization 100. Such trigger statements may be found at the value stream 119 or facility 114 levels, although, as the scoring methodology is initiated at the value stream 119 level (whether scoring by value stream 119 or by guiding principle), the effect of the trigger statements will occur at the value stream 119 level. In another embodiment, additional trigger statements may be added per principle, facilitating an emphasis on additional organizational qualities.

As described above, assessment 400, which may include waste categories 200, subsystems 300, and guiding principles 335 (see FIGS. 1b, 2b, 3), as well as practices related thereto, may be accomplished using a general-purpose computer 550 connected to a network 560, such as that shown in FIG. 5a. FIG. 5b illustrates an exemplary general-purpose computer 550, which may be, for example, a mainframe, a server, a desktop, a laptop, or other commonly known computing device, fixed or mobile, and may include one or more hardware and/or software components configured to collect, monitor, store, analyze, evaluate, distribute, report, process, record, and/or sort information. For example, general-purpose computer 550 may include a central processing unit (CPU) 570 configured to execute computer program instructions to perform various processes and methods; a random access memory (RAM) module 572 and read-only memory (ROM) module 574 configured to access and store information and computer program instructions; a memory 576 to store data and information; a database 578 to store tables, lists, or other data structures; one or more input/output (I/O) devices 580; and an interface 582 for external communication. Each of these components is well-known in the art and will not be discussed further.

General-purpose computer 550 may be configured to transmit and/or receive data via network 560. Network 560 may be any appropriate communication network allowing communication between or among one or more entities, e.g., general-purpose computers 550. Network 560 may include, for example, the Internet, a local area network, a workstation peer-to-peer network, a direct link network, a wireless network, or any other suitable communication platform. Connection with network 560 may be wired, wireless, or any combination thereof.

General-purpose computer 550 may include additional, fewer, and/or different components than those listed above and it is understood that the listed components are exemplary only and not intended to be limiting.

B. Processes

Referring to FIG. 1b, while assessment 400 of organizational production system 150 offers a direct evaluation of the adherence of organization 100 to guiding principles 335, organizational production system 150 may be implemented through one or more discrete practices, or processes 600. Specifically, organizational production system 150 may be process focused, in which processes 600 are treated similarly to the way products are traditionally treated in an organization. Processes 600 may have designated process managers accountable for assessing and strategizing all aspects of continuous improvement regarding that process. Each process may have a strategy, discrete performance metrics, and a process plan that outlines the goals and actions of the process. In addition, each process may operate to enable specific principles of organization 100. To that end, organization 100 may focus the production system on one or more types of processes, as exemplified below.

FIG. 6 depicts an exemplary flowchart of three categories of processes 600 that may be defined by organization 100. These exemplary processes 600 may include core processes 610, governing processes 620, and enabling processes 630.

Core processes 610 may generally include production floor operational processes encompassing floor activities required to physically produce a finished good. Core processes 610 may be considered fundamental to the routine planning and execution of the business of organization 100 from the customer order stage to the delivery of the final product. Governing processes 620 may generally include processes related to governance activities associated with tracking and measuring personnel well-being and product quality throughout organization 100 facilities. These processes provide guidance and influence through the use of standards, targets and defined measures. Enabling processes 630 may generally be directed to the management of information at one or more levels, activities related to people and culture, or transformation of value streams 119. Enabling processes 630 provide the capability and means for change within the environment of organization 100.

Core processes 610 may include a process 640, Capacity Planning, a common global process capturing all demand streams. This process may capture demand requirements for products produced by organization 100 such that organization 100 may accurately plan future internal production requirements as well as external supply and distribution needs. Process 640 may provide a single platform for communicating with internal and external suppliers and may provide the details required to make investment decisions in advance of the actual need. For example, a large order from a customer for heavy-duty trucks may require a future forecast that accounts for current production capacity for that product, potential new investment to increase capacity to complete the order, advanced notice to parts suppliers, and/or consideration of existing or anticipated orders from other customers. Process 640 may enable principles 340, Chase Waste, by reducing waste throughout the supply chain; 342, Pull, by acting as the foundation for Pull replenishment; 346, Drive Standard Work, by using common processes as the basis for continuous improvement; 354, Take the Customer's View, by addressing demand streams; 356, Go, See, Act, by working capacity processes in a real production setting; 366, Align the Targets, by aligning capacity plans such that the same plan is used throughout organization 100, eliminating second-guessing and conflicting capacity-need signals; and 368, Act Decisively, by ensuring that process 640 is adhered to by all organization 100 personnel (see FIG. 3).

Core processes 610 may include a process 642, Demand Management, focusing on the creation of demand and supply inputs. In particular, process 642 may focus on the development of forecasts of anticipated customer demand as well as on forecasts of supply capabilities of organization 100 in response to that demand, enabling proactive actions to be taken to deal with inevitable variations. Process 642 may enable principles 340, Chase Waste, by reducing variation in forecasts and supply plans; 342, Pull, by continuously executing based on actual customer demand while planning according to the forecast; 344, Make Value Flow, by managing the product options of organization 100 through an exception-based process; 348, Even the Load, through the creation of supply plans that meet demand and balance production resources; and 354, Take the Customer's View, by creating supply plans that prepare organization 100 to execute in accordance with customer expectations. Metrics for process 642 may include Forecast Accuracy, which represents how close a forecast of demand for future periods was to the actual demand that occurred; Forecast Bias, which indicates if the forecast is consistently pessimistic or optimistic; Forecasted Dealer Inventory Turns, representing how quickly inventory is moving through the dealership; Supply Plan Bias, which indicates whether supply plans have a consistently pessimistic or optimistic tendency; Committed Ship Date Performance, which represents the organization's ability to ship product on the date promised; and Product Availability, which represents the elapsed time from receipt of the order to shipment.

Core processes 610 may include a process 644, Supply Chain/Materials Management, which focuses on a strategy based on internal supply replenishment between one or more value streams 119 or among any levels within a value stream 119. In particular, this may involve altering the strategy from pushing materials or products based on a requirement schedule to one of pulling material, as described earlier, based on actual consumption. This allows organization 100 to meet customer commitments while achieving sustained differentiated product availability with low cost and high quality. Process 644 may promote flexibility in the face of changing market demand. Process 644 may enable principles 340, Chase Waste, by reducing transportation costs and repackaging and over packaging; 342, Pull, by reducing supply chain response times; 344, Make Value Flow, through real time communication for quick identification and correction of issues; 348, Even the Load, by communicating package sizes and weights to optimize transportation and reduce costs; and 346, Drive Standard Work, by allowing the use of the same size packaging and the capability to reuse. Metrics for process 644 may include On Time Delivery Performance, which is an audit of compliance by the supplier and carrier to schedule based on on-time supplier shipment and on-time carrier delivery performance; Percent Spend of Pull, which determines compliance with the push to pull replenishment strategy; Point of Use Availability, which determines material availability at the point of consumption and specifically concerns unavailable parts per operation; and Inventory Record Accuracy, which validates the accuracy of on-hand inventory in the facility 114 with Information Technology support records.

Core processes 610 may include a process 646, Orders Management, in which the processing of orders may be simplified and consequently made faster and more accurate with increased automation. Equipment dealers of organization 100 may, in real-time, configure specific orders, quote, and track the order from order entry to product delivery. The orders may be available at all levels of organization 100 and available to all employees within those levels at any time. Customer inventory and replenishment orders may be differentiated to allow facilities 114 to better prioritize orders, meet shipping dates, and create sustainable levels of product availability. Process 646 may enable principles 340, Chase Waste, by reducing the need for human intervention; 342, Pull, through inventory matching and focused replenishment; 344, Make Value Flow, by streamlining the ordering process; 348, Even the Load, through the use of common order scheduling to balance day-to-day production; 354, Take the Customer's View, by simplifying product configuration, automatically prioritizing orders, and providing real-time order status reporting; 364, Make It Visual, by using enhanced visual methods, such as real-time order status reporting; and 366, Align the Targets, through the use of metrics to track progress in moving to differentiated orders and common scheduling. Metrics for process 646 may include Order Data Accuracy, which tracks the percentage of orders received in the review period with total accuracy; Order Acknowledgment Conformance, representing the time from when an order is received until an approximate ready-to-ship date is communicated; Committed Ship Date Performance, representing the ability of organization 100 to ship a product on the date it was promised; Demonstrated Availability, which represents the time from order receipt to final shipment from a facility 114; and Scheduled Availability, which represents the time from order receipt to the approximate ready-to-ship date provided by a facility 114.

Core processes 610 may include a process 648, Sales and Operations Planning, focusing on providing a common operating plan across organization 100. This process provides visibility to demand and available supply in a manner allowing effective business decisions to be made on an ongoing basis. In particular, process 648 may evaluate projections for demand and supply and the resulting financial implications to organization 100 on a monthly basis. From that, a production plan may be realized over a rolling planning horizon spanning a plurality of months, potentially over a timeframe comprising a year or longer. Process 648 may enable principles 340, Chase Waste, by meeting customer demand at lower costs; 344, Make Value Flow, through periodic and continuous reviews of the sales and operations planning process; 348, Even the Load, by the creation of feasible and executable supply plans; 350, Validate Our Processes, through the validation of plans that keep demand and supply in balance; and 354, Take the Customer's View, along with 364, Make It Visual, both through customer-centered performance metrics. Metrics for process 648 may include, among others, Sales Forecast Bias, which indicates if the forecast is consistently pessimistic or optimistic; Sales Forecast Accuracy, which measures the organization's ability to predict the level of demand for products; Committed Ship Date Performance, representing the ability of organization 100 to ship a product on the date it was promised; Product Availability, a customer-centric metric that measures the elapsed time between the placement of the order and when the product is shipped; and Mean Dealer Repair Frequency, which measures the number of quality failures per 100 hours of operation within approximately the first year of operation.

Core processes 610 may include a process 650, Manufacturing Engineering, focused on specifying procedures and resources to transform a product design to a finished product. For example, process 650 may provide plans for machining, fabrication, assembly, cleaning, and finishing, as well as planning a working area for production and specifying equipment required for construction. The manufacturing engineering process may also determine how to specify and purchase tooling as well as plan facility 114 layouts. Process 650 may comprise one or more sub-processes, including Process Planning, Tool Design, Tool Selection, Heat Treat Engineering, and Robotic Programming, as examples. Process 650 may enable principles 340, Chase Waste, through virtual planning; 342, Pull, through facility 114 layouts and operations that support continuous flow, pull replenishment, capacity planning, and a future-state value stream; 344, Make Value Flow, through efficiencies created by manufacturing engineering planning; 346, Drive Standard Work, by using standard tools and equipment validated before production release; 348, Even the Load, with manufacturing processes designed to optimize efficiency; 350, Validate Our Processes, by validating new or changed processes before production release; 352, Put Safety First, by developing factory layouts and manufacturing processes with operator safety as the top priority; 356, Go, See, Act, through the personal involvement of manufacturing engineers in day-to-day factory operations; 358, Stop to Fix, through the involvement of manufacturing engineers in root cause corrective action activities during a factory process stoppage; and 364, Make It Visual, through the use of visual methods and displays as part of the development of standard work, such methods and displays including job instructions and layouts.

Core processes 610 may include a process 652, Manufacturing Production Execution, which may be any value adding process that transforms resources, raw materials, components, or subassemblies into finished products for customer consumption, and may include sub-processes within those value adding processes. This process may utilize automation where feasible to separate personnel from the process, enabling a safer work area, reduced product variability, and increased productivity. Process 650 may comprise one or more sub-processes. In particular, some of the sub-processes of process 652 may be machining, assembly, fabrication, (e.g., cutting, forming, or joining), heat treating, and/or finishing, (e.g., painting, or cleaning). Organization 100 may emphasize commonality of sub-processes over a specified time period in conjunction with strategic procurement of equipment to further production efficiencies. Process 652 may enable principles 340, Chase Waste, through understanding and value stream mapping of the work areas; 342, Pull, through operations according to standard work to achieve production stability; 344, Make Value Flow, through the reduction of manufacturing setups; 348, Even the Load, through the participation by production personnel in the Sales & Operations Planning process; 350, Validate Our Processes, through the validation of automated equipment to improve safety, reduce process variability, and increase efficiency; and 352, Put Safety First, by requiring safe procedures for all processes and ergonomic assessments for all new processes. Metrics for process 652 may include Overall Equipment Effectiveness, which is a measure of how effectively equipment is being utilized, and Recordable Injury Frequency, which is a standardized measure of the rate in which 100 people working for 2000 hours will experience a recordable injury, although other quantitative variations may be used.

Core processes 610 may include a process 654, Manufacturing Support, focused on providing support to processes 650 and 652 by defining requirements of at least the sub-processes of maintenance, quality and in-process validation, material handing, and packaging. A maintenance sub-process may include repair of manufacturing and manufacturing support equipment to ensure availability for production. A quality and in-process validation sub-process may include all measurements made during or after a process 652 defined sub-process to provide that a product conforms to all engineering requirements. A quality and in-process validation sub-process may also include measurements to ensure the stability of a process 652 sub-process. A material handling sub-process may include one or more activities that move one or more of raw materials, sub-assemblies, finished components, or finished products to the next step in a value stream 119 and/or the groups 120, areas 122, or cells 124 within that value stream 119. A packaging sub-process may include securing and presenting for movement and transportation materials entering or exiting organization 100, for example, raw materials, sub-assemblies, or finished goods. Process 654 may enable principles 340, Chase Waste, through the use of quality and maintenance systems for the elimination of defects; 346, Drive Standard Work, by using common processes such that the processes are maintained and practices and standards are followed; 344, Make Value Flow, by improving Overall Equipment Effectiveness; 350, Validate Our Processes, validating manufacturing support processes before production release to ensure safety and quality; 352, Put Safety First, by having manufacturing support personnel alert to ergonomic and safety hazards and the safety performance of all areas; and 364, Make It Visual, through the application of a visual signal/system used to notify others of workstation issues (commonly referred to as Andon systems) for reporting operational status of certain machines.

Core processes 610 may include a process 656, Finished Goods Distribution, focused on providing a framework for distribution of finished products on a global scale, in one or more distribution tracks to provide customer choice while maintaining cost-effective distribution, reduced inventory, and production balance. For example, the distribution network may provide a distribution track in which a customer may request a product with a significantly shorter lead time but with limited choices for configuration. The distribution network may also provide a distribution track in which the customer has a wide variety of configuration options with a corresponding increase in product lead time. It is contemplated that many other distribution tracks may be implemented based upon product type and/or other factors. Process 656 may enable principles 340, Chase Waste, by lowering costs through packaging efficiency, and 354 Take the Customer's View, by improving product choice and availability.

Core processes 610 may include a process 658, Transportation, focused on the management of the movement of products to and from facilities 114 of organization 100. Specifically, process 658 may focus on facilitating efficient transportation of products to and from organization 100 material suppliers and product distributors while optimizing transportation costs. As such, this process may be highly integrated with ordering, manufacturing processes, dealers, and suppliers, and may provide tracking of all shipments throughout the world. Process 658 may enable principles 340, Chase Waste, by reducing unnecessary transportation expenses, and 354, Take the Customer's View, by providing increased shipping choice to customers. Metrics for process 660 include Total Supply Chain Cost, which is the cost of moving a product from origin to destination; Total Transit Time, which is the total amount of time it takes for a product to move from origin to destination; and Total Variability of Transit Time, which is the variability in a sample population of the product to and from the same origin and destination.

Governing process 620 may include a process 660, Quality Management, focused on delivering products and services free of defects to customers both internal and external to organization 100. Specifically, process 660 may develop and implement quality planning processes for any of the manufacturing processes, previously described, across all levels of organization 100, including value stream 119 and/or groups 120, areas 122, or cells 124 within that value stream 119. Such processes may include quality standards and associated documentation for adherence to those standards, for example, traceability and audit documentation. Process 660 may also develop validation strategies for determining quality while a product or component is being processed within organization 100. Process 660 may enable the 15 guiding principles previously described. For example, Process 660 may emphasize eliminating quality-related waste and making value flow by quickly identifying and resolving issues across the enterprise. A customer acceptance validation (CAV) process may be focused on defining standard work as the foundation of continuous improvement. The validation and verification chain created through full implementation of the CAV process ensures that processes and technologies are effectively proven before they are introduced to production. With CAV, all inspections and audits may be based on customer priorities, ensuring that products delivered to dealers meet all customer requirements for quality and performance. The CAV process emphasis on audits of incoming supplier material as well as quality gates and in-process validation may specifically embody principle 358, Stop to Fix.

Governing process 620 may include a process 662, Governance and Assessment, focused on enabling a common measurement system across organization 100. Process 662 may facilitate the measure of performance against organization 100 targets in the context of guiding principles through the use of metrics displayable in all facilities 114 of organization 100. This display of metrics may allow for immediate facility 114 performance comparisons by anyone in a facility 114 and may provide a location for dialogues among organization 100 personnel. This process may also create a framework across organization 100 for monitoring, guiding, and supporting the implementation of the production system. Process 662 may enable the principles 340, Chase Waste, through periodic evaluation of organization performance; 364, Make It Visual, by providing visual displays for monitoring performance; and 366, Align the Targets, through the cascading of metrics (further explained below).

Enabling process 630 may include a process 664, Environment, Health and Safety, focusing on the engagement of employees in safety issues within organization 100. Process 664 may include facilitating the training of all employees of organization 100 in safety and ergonomic issues. Process 664 may also provide the process for conducting safety and ergonomic evaluations in manufacturing process equipment. Process 664 may enable principles 352, Put Safety First, and may also impact principle 340, Chase Waste, through reduction in lost time due to employee unavailability and 350, Validate Our Processes, by incorporating an environment, health, and safety review into all planned operational changes to ensure processes are proven effective. Metrics for process 644 may include Recordable Injury Frequency; Lost Time Case Frequency Rate, which may be the number of lost-time injuries (resulting in one or more days of missed work) per 100 production team members, although other quantitative variations may be used; and % Recycled, defined as the mass of materials recycled, reused, or reclaimed divided by that same mass plus the mass of waste materials that are landfilled or incinerated.

Enabling process 630 may include a process 666, Capability Building, focused on the development of employee skills and the identification of training needs. Process 666 may also enhance awareness within organization 100 of the production system. Process 666 may enable the 15 guiding principles previously described. For example, process 666 may focus learning on wastes, safety, and the processes and tools for continuous improvement, thereby enabling principle 340, Chase Waste; may explain production system methodologies, processes and tools to identify issues and increase efficiency, enabling principle 344, Make Value Flow; may provide standardized learning material and tools for deploying and implementing the production system, enabling principle 346, Drive Standard Work; may provide learning and tools to reduce process variability, enabling principle 348, Even the Load; and may provide training and tools to identify the root cause of problems, enabling principle 358, Stop to Fix.

Enabling process 630 may include a process 668, Value Stream Transformation, focusing on identifying and eliminating waste within organization 100 and improving the performance of a value stream 119 as a whole. Process 668 may drive the execution of organizational production system 150 within all value streams 119. Process 668 may encompass four defined processes, including value stream mapping, a Value Stream Transformation Project, a Six Sigma Rapid Improvement Workshop, and a Continuous Improvement process (further explained below). Process 668 may enable the 15 guiding principles previously described and teach the system elements while providing a tangible way for organization 100 personnel to apply the principles. Enabling process 630 will be described in more detail below.

Enabling process 630 may include a process 670, Tools Development, which focuses on enabling access to, and storage of, tools used for implementation of the production system. For example, a tool may be anything that supports the completion of a task within a process, such as computer applications, documents, visual aids, checklists, scorecards, or metric displays (e.g., displays 800-1370, see FIG. 1b and further explained below), some of which will be further defined and explained below. Process 670 may provide a single secure source for production system information to increase its availability and use across organization 100. Process 670 may enable the 15 guiding principles previously described. For example, process 670 may provide an outlet for sharing solutions, help control overprocessing by providing one central access point for production system tools, and eliminate excess motion by making searches more efficient, enabling principle 340, Chase Waste; may allow users to choose the exact tools they need, when they need them, enabling principle 342, Pull; may promote user collaboration through Process Improvement Dialogues, enabling principle 366, Align the Targets; may provide business units with access to processes and tools in a standard format, enabling principle 346, Drive Standard Work; may encourage feedback from users to let tool developers know when they need a tool created or updated, enabling principle 362, Actively Listen; and may provide clear and understandable layout and linked content for each production system process, enabling principle 364, Make It Visual.

Enabling process 630 may include a process 672, Information Management, focused on providing real-time information for all processes within organization 100 and implementing and managing the technology to provide such information. Specifically, Process 672 may include a fully integrated organization 100 resource planning tool providing real-time visibility to material and information flow, as well as systems that manage individual cells 124 and assets for execution on the production floor. Such a process may result in a common technology across organization 100 supporting common processes, which in turn may permit coordinated, effective, and timely decision making across organization 100. Process 672 may therefore enable, among others, principles 354, Take the Customer's View and 368, Act Decisively.

Processes 600 may be accomplished using a general purpose computer within organization 100 (see FIGS. 5a, 5b).

1. Metrics

As described above, process 662, Governance and Assessment, may control processes 600 within organizational production system 150. To accomplish this, the governance process may define and display organizational metrics throughout and within processes 600 to link productivity and value from process to process, i.e., each process 610-672 (see FIG. 6) may have specific metrics 700 (see FIG. 1b) to ensure process conformance through common measurement. Metrics 700 are standards of measurement, and their use may be conceptually linked to guiding principles 335, specifically to principle 364, Make It Visual, and principle 366, Align the Targets (see FIG. 3). Additionally, metrics 700 may link to assessment 400 through specific assessment questions that provide both feedback on how the implementation of process 662 is progressing as well as annual metric targets. In accordance with the hierarchy of organization 100, metrics 700 may be “cascaded” such that executive headquarters 110, divisions 112, and all elements within production facilities 114 (groups 120, areas 122 and cells 124) may view, monitor, react to, and influence them. Specifically, improvements at a lower hierarchical level may be seen at upper hierarchical levels. This cascading of metrics 700 will be more fully described below.

Metrics 700 may generally be classified as operating or financial. Operating metrics may be used to drive organization 100 and help define at all hierarchical levels how each part of organization 100 is contributing to the ultimate objectives of the business. For example, of most importance to cell 124 may be operating metrics directly related to the assembly process of that cell 124. On the other hand, some financial metrics may be of importance to executive headquarters 110. Other metric classifications are possible and the focus of metrics may change at each hierarchical level. The details of such metrics will be discussed below.

Organization 100 may choose to assign one or more individuals to be responsible for the upkeep and storage of metrics 700 in order to maintain consistency and integrity. For example, a facility metric coordinator may be responsible for collecting and posting metrics 700 for a particular facility 114. Such a facility metric coordinator may also work closely with other metric coordinators to ensure timeliness and integrity of metric numbers. Likewise, a group metric coordinator may be responsible for collecting and posting metrics 700 for a group 120 and an area metric coordinator may be responsible for collection and posting for an area 122. A team member may be responsible for updating metrics 700 for a cell 124 and for actively involving a section manager or team leader in a Process Improvement Dialogue process, as further explained below. A section manager or team leader may likewise be responsible for helping team members update metrics 700 for a cell 124 and for using recorded metrics to conduct the Process Improvement Dialogues. An executive scorecard coordinator may be responsible for periodic collection of metrics 700 and submission of the data for use in an executive scorecard, also described below.

In addition, organization 100 may choose to have one or more individuals accountable for specific functions of each individual metric of metrics 700. For example, each metric may include a metric sponsor, coordinator, administrator, and/or other individual with particular roles for each metric. A metric sponsor may have overall accountability for an individual metric and may be best able to explain its purpose and how it helps organization 100 achieve its goals. A metric coordinator may be the subject matter expert within a portion of the business of organization 100, setting the methodology and parameters for how the particular metric is to be calculated. The metric coordinator may continuously evaluate the metric and maintain the required content concerning that metric within a metric library, as further discussed below. A metric administrator may be responsible for collecting and reporting metric results to hierarchical levels of organization 100 based on a pre-defined frequency of metric reporting.

Metrics 700 may be defined and stored in a single metrics library, which may be a database, for example, a Lotus Notes™ database, containing specific metric information, for example, a metric definition, description, sponsor, coordinator, administrator, and any specific calculation method used. This method may provide metric consistency across organization 100, as each metric may be used identically within the hierarchical levels. As with the assessment process, a web-based or other computer application may be used to store metrics 700 and perform metric calculations. The computer application may be an application designed and maintained by organization 100 and may include security or other parameters. Such a computer application may allow facility 114 personnel the ability to securely update metric performance as necessary or desired. Each metric itself may include a specific name, definition, purpose, and/or calculation methodology, along with other characteristics desired by organization 100. A web-based application of this embodiment may also provide for automated real-time metric calculations. In particular, a spreadsheet application, such as Microsoft Excel™ or a similar application, may be used for the entry of raw data collected in any given metric. Once the raw data has been entered into the spreadsheet, a metric graph may be created using the data and calculations for use in a metrics display, discussed below. Metric spreadsheets may exist for the facility 114, group 120 and area 122 levels.

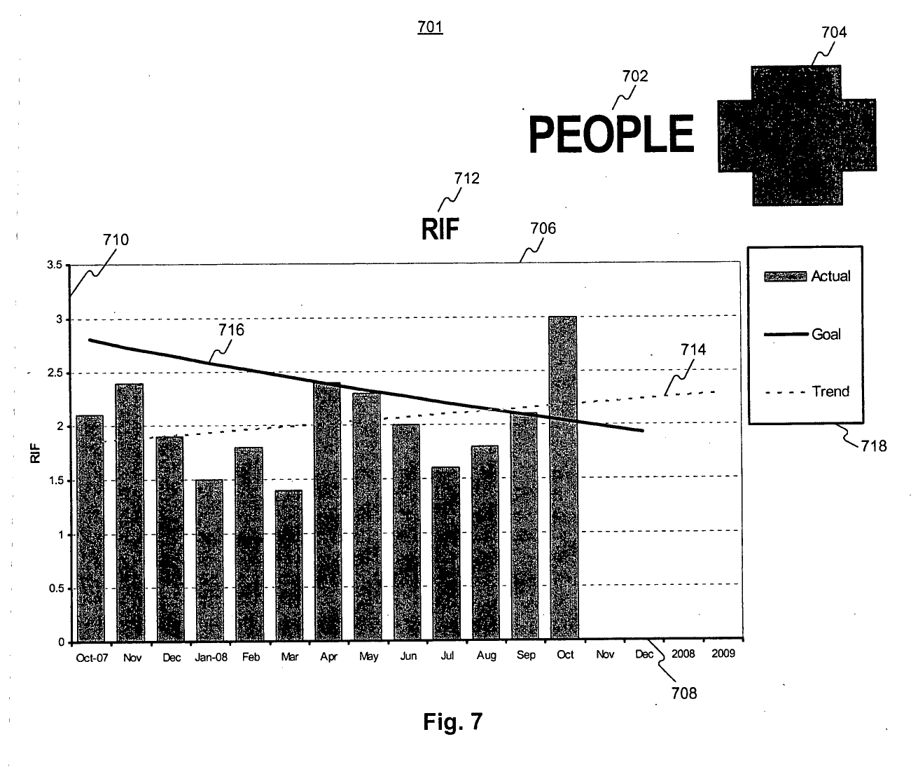

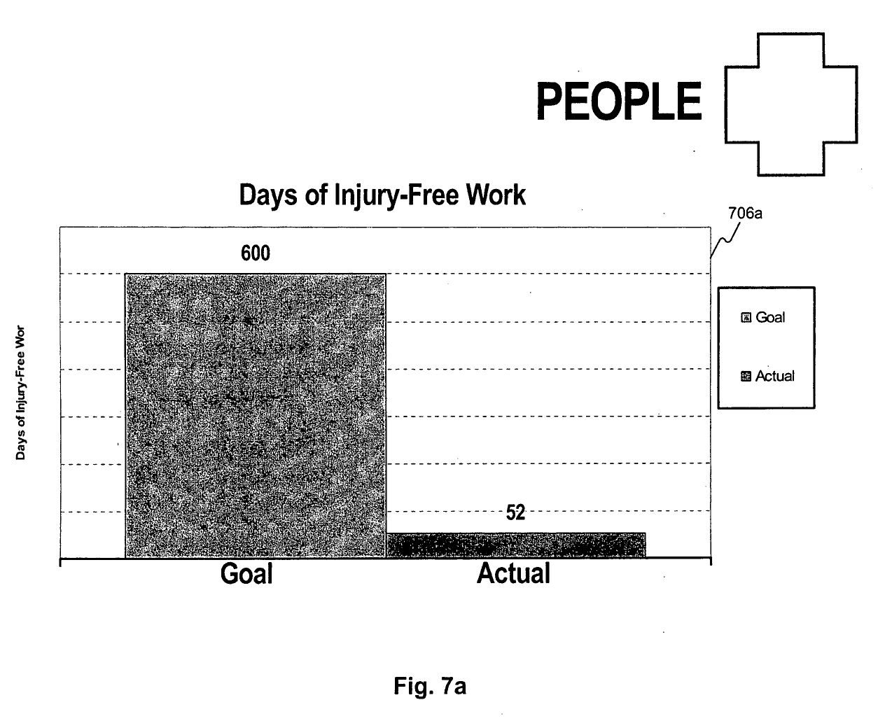

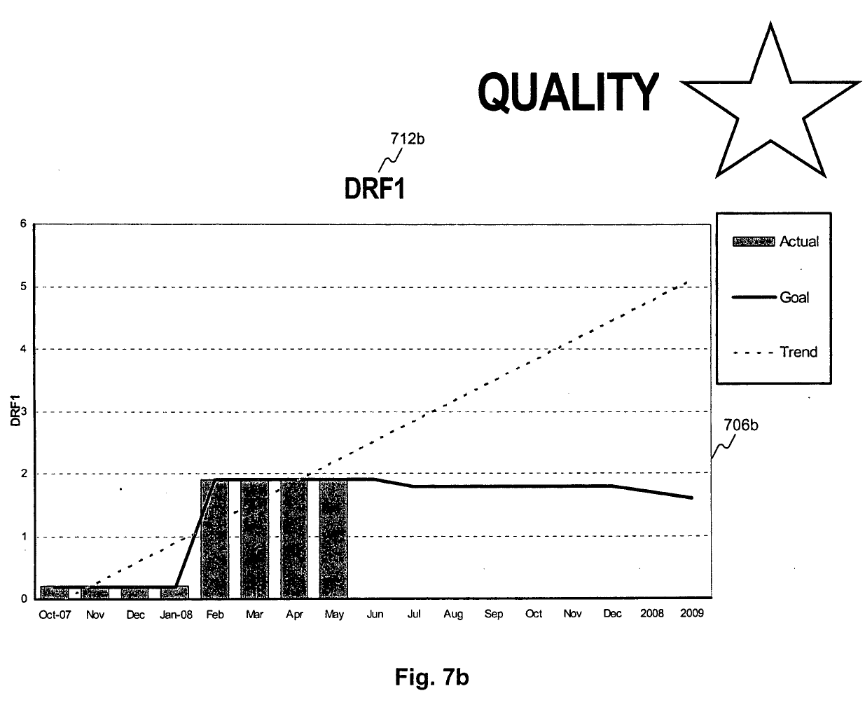

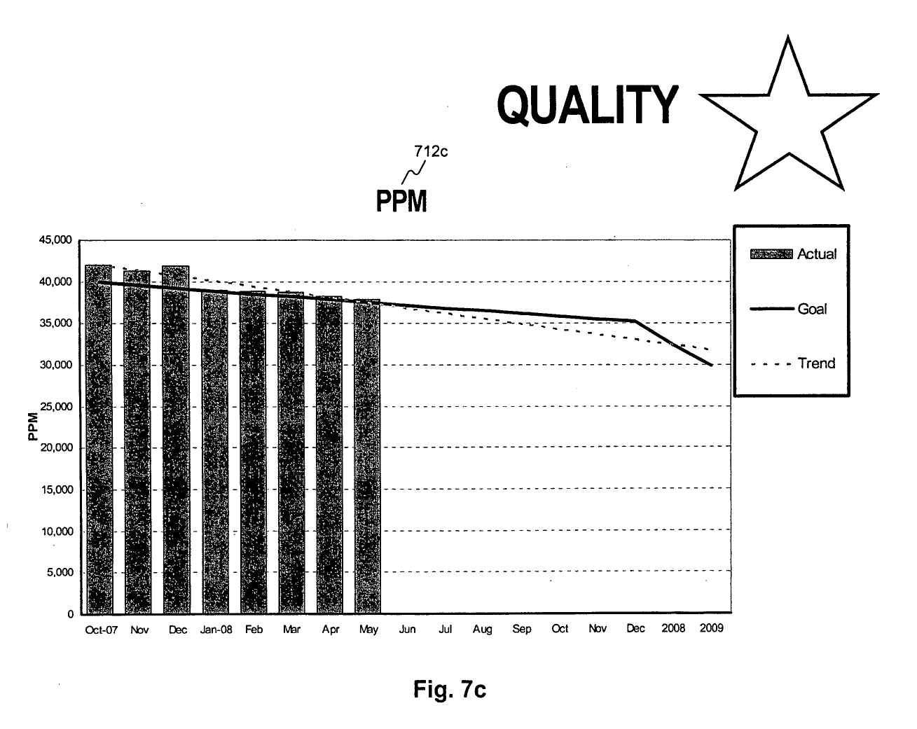

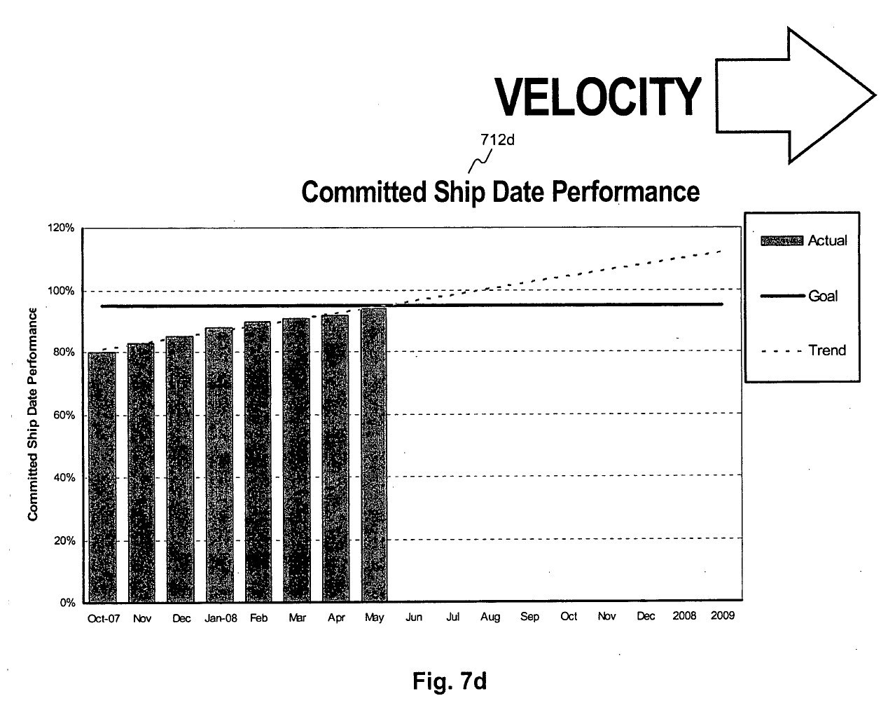

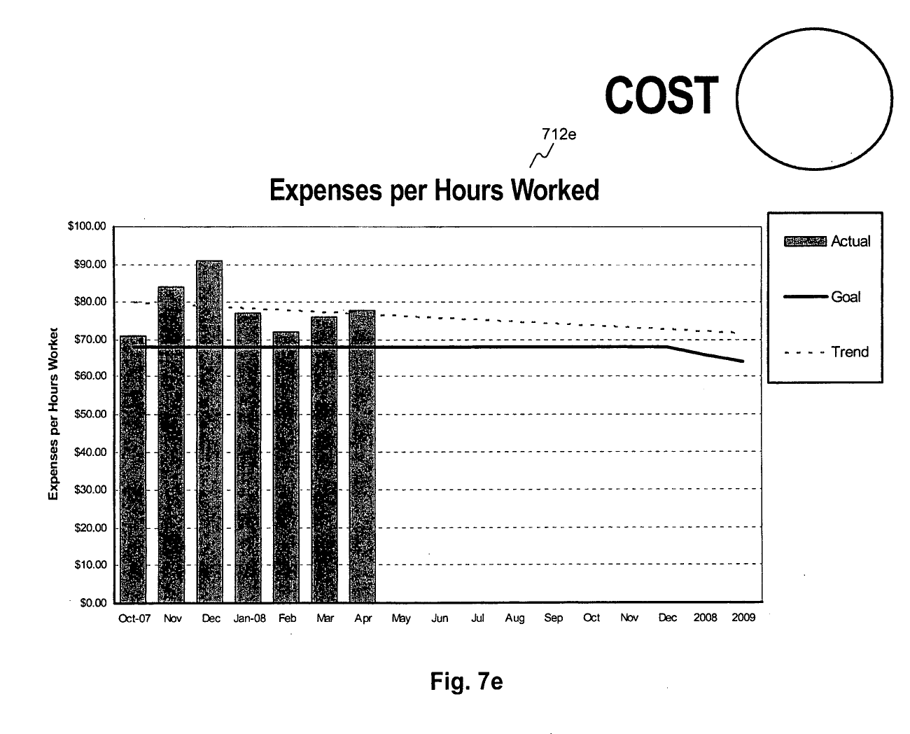

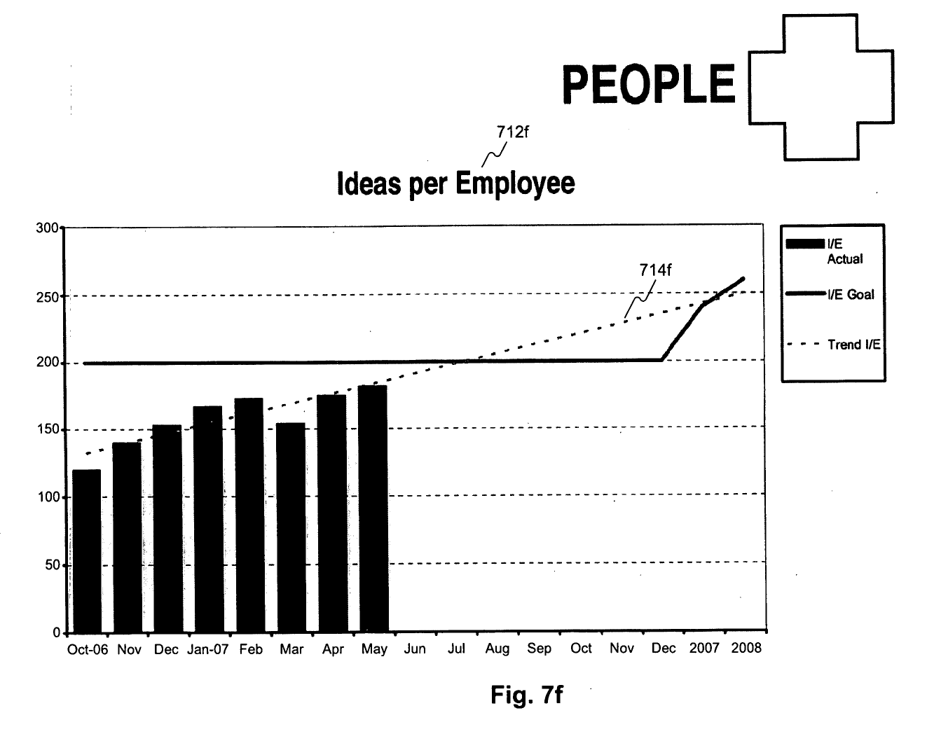

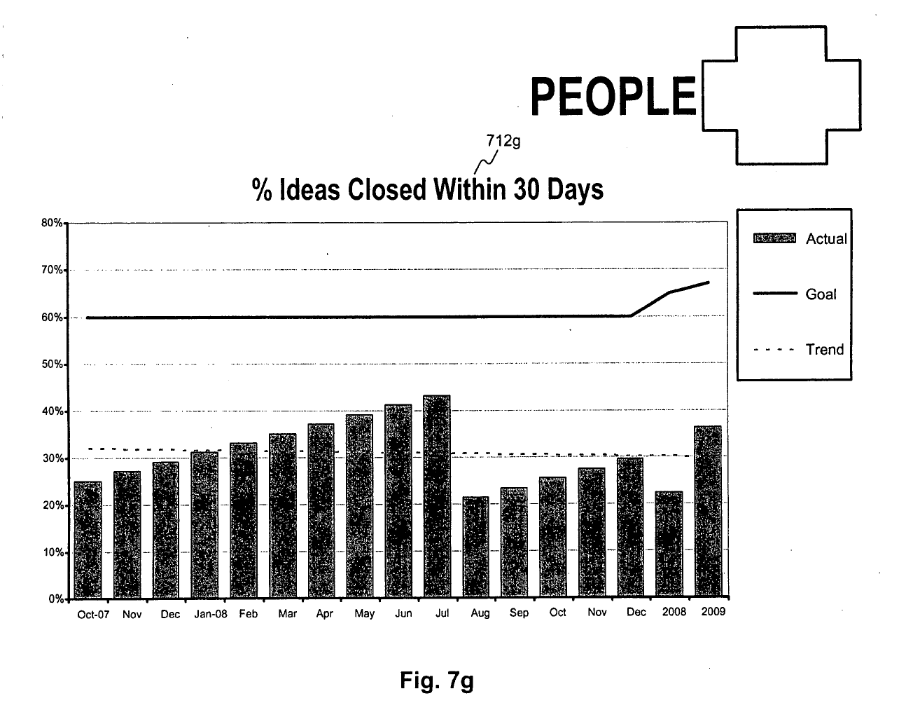

FIG. 7 depicts an example of a metric graph 701. Metric graph 701 may include a factor title 702 of one of critical success factors 190 (see FIG. 1b) with which the metric is associated. As shown in the embodiment of FIG. 7, factor title 702 indicates that the metric of metric graph 701 is associated with critical success factor 192, People (see FIG. 2a). Metric graph 701 may also include a visual indicator 704, one of four symbols corresponding to particular critical success factors 190 identified by factor title 702. For example, visual indicator 704, in the form of a cross, may be present in metric graph 701 to further represent critical success factor 192, People. Visual indicator 704 may then be used for quick visual identification and association of metric graph 701 with one of critical success factors 190 noted on a metric display, to be later described in detail. In one embodiment, visual indicator 704 may take the form of a star for critical success factor 194, Quality; may take the form of an arrow for critical success factor 196, Velocity; or may take the form of a circle for critical success factor 198, Cost. Visual indicator 704 may also include an additional visual identifying characteristic in metric graph 701, such that the status of that particular metric is readily identifiable upon viewing. For example, visual indicator 704 may be color-coded with a representative color and the first letter of that color within visual indicator 704 to visually signal to the viewer the status of that particular metric. In one embodiment, the color green may be used in visual indicator 704, indicating the metric is meeting or exceeding the metric goal; the color yellow may be used to represent that the metric is quantitatively superior to an established baseline value but not yet meeting the metric goal; and the color red may be used to signal that the metric is not only not meeting the metric goal but is quantitatively inferior to the established baseline value. Other identifying means, based on color or otherwise, may be used for this purpose.

The information provided within metric graph 701 may be in the form of a chart 706. For example, in the embodiment of FIG. 7, the x-axis 708 of chart 706 may indicate time, such as through a calendar timeline, in periodic increments. The y-axis 710 may represent some desired quantitative value specifically measured against x-axis 708. Specifically, y-axis 710 of chart 706, as shown in FIG. 7, may represent a Recordable Injury Frequency, which may be indicated as an acronym RIF on chart title 712. Y-axis 710 therefore displays the number of recorded injuries at a particular facility 114, group 120, or area 122. In addition, metric graph 701 may include a trend line 714, representing the trend or direction of that particular metric toward or away from that metric goal. Metric graph 701 may also include a goal line 716, representing the metric goal. Metric graph 701 may also include a legend 718 to aid in understanding metric graph 701. The production of graphs is common and one of skill in the art will readily understand various parameters that may be used in constructing a suitable graph from a set of data. The production of graphs may be accomplished by use of a general-purpose computer (see FIGS. 5a, 5b).

The creation of metrics 700 is dependent on the needs of organization 100. As discussed above, metrics 700 may be associated with specific critical success factors 190. Metrics 700 may further be subdivided and reflect a focus on operational aspects of the business of organization 100 or on the implementation of organizational production system 150 within organization 100. For example, operationally, under critical success factor 192, People, organization 100 may evaluate Days of Injury-Free Work, as shown in FIG. 7a, wherein chart 706a may describe a running total of days within facility 114, group 120, or area 122 without time lost, as that term may be defined by organization 100. Under critical success factor 194, Quality, organization 100 may track the Dealer Repair Frequency, indicated as an acronym DRF1 on chart title 712b of chart 706b of FIG. 7b, which may be described as the number of repairs performed by a dealer per 100 hours of operation. Specifically, a record of this particular frequency specified during the first 20-200 hours of time in service, may be recorded. Again, quantitative specifics may be varied by organization 100 and one or more charts 706 may display a current total against a historical record, as shown, for example, in FIG. 7b. As shown in FIG. 7c, a further embodiment under critical success factor 194 may be Parts per Million, indicated as an acronym PPM on chart title 712c, referring to the number of defective parts per million produced. A shown in FIG. 7d, a further embodiment of a metric for critical success factor 196, Velocity, may be Committed Ship Date Performance, chart title 712d, which may represent the percentage of orders meeting or exceeding their confirmed ship date. As shown in FIG. 7e, an additional embodiment of a metric for critical success factor 198, Cost, may be Expenses per Hours Worked, chart title 712e, which may represent a particular expense associated with a product per employee hour worked producing that product. FIGS. 7a-7e, of course, use the same nomenclature as described in FIG. 7.

Other metrics 700 may reflect a focus on the implementation and/or effectiveness of organizational production system 150 within organization 100. This may be more helpful during the early stages of execution of organizational production system 150, but may also be utilized throughout the life of organizational production system 150 as a periodic check. For example, metrics 700 detailing the completion of training concerning organizational production system 150 itself may indicate the speed of the production system implementation. In addition, some metrics 700 may be specially designed by organization 100 to capture certain behavioral aspects of organization 100 personnel.

To illustrate such a “specialty” metric, organization 100 may encourage the use of the intellectual resources of all organization 100 employees and may choose to provide a corresponding metric for all employees within organization 100 or a subset group of employees, depending on the quantifiable data desired. Within a selected group of personnel, for example, organization 100 may choose to record the number of proposals or ideas offered by a specified group of employees. Such ideas may include ideas for improving or changing a particular process or any ideas offered to increase production efficiency or eliminate current or potential issues. In addition to these variations, the ideas offered may or may not take into account a plurality of ideas from a single employee or may only record ideas offered at certain times. Variations will depend on the needs of organization 100. In one embodiment, as shown in FIG. 7f, the ideas obtained from the specified group of employees may be divided by the number of individuals within that group to obtain ideas per employee. As shown in FIG. 7f, such a metric may be recorded on a monthly basis as Ideas per Employee, chart title 712f, although any time increment desired by organization 100 may be used. Such recording may then permit metric trending with trend line 714f over the time span shown. As shown in FIG. 7g, a further embodiment is a specific deviation of Ideas per Employee, which may be % Ideas Closed within 30 Days, chart title 712g. Such a metric may track not only the ideas input from a pool of employees, but may further record those ideas actually implemented in some form within a specified time period by organization 100. This concept will be further explained below, Again, the production of graphs may be accomplished by a general-purpose computer.

a. Displays

Metrics of the various processes may be communicated throughout organization 100 using a combination of visual tools with targeted communications that show any organization 100 employee at any of the organization 100 hierarchical levels performance priorities of organization 100, specifically, how organization 100 is performing vis-à-vis specific metrics and what actions are needed to achieve the overall strategy of organization 100. In one embodiment, this is accomplished by use of a display. As shown in FIG. 8, each hierarchical level within organization 100 may have a specific display, which generally may be a physical medium such as a board or similar structure and may include various symbols and/or words to communicate desired information. For example, a facility display 800 may be used at the facility 114 level, a group display 900 or group tower 1000 may be used at the group 120 level, an area display 1100 may be used at the area 122 level, and a cell display 1200 may be used at the cell 124 level. These displays 800, 900, 1000, 1100, 1200 may use dry-erase markers, magnets, or other temporary markings in conjunction with permanent markings and may also be configured for securing one or more sheets of paper or other tangible media for ready viewing. One or more of displays 800-1200 may be wall mounted, or alternatively, stand mounted with or without wheels. An additional option for particular displays may be desk mounting at various angles for optimal use. Displays 800-1200 may also comprise a laminate structure. A sound system, such as a public announcement system, may be included to facilitate communications. Displays 800-1200 may be cascaded throughout one or more hierarchical levels within facility 114 such that the information contained therein may be readily viewed and analyzed. Such a cascade of information at least through these hierarchical levels within facility 114 may offer distinct benefits for organization 100 in its drive for continuous improvement, for example, engaging employees in understanding the current status of organization 100 goals and spurring action, using, for example, Process Improvement Dialogues (described later) and root cause problem solving.

1) Facility Display

FIGS. 8a and 8b refer to a facility display 800. Facility display 800 provides a visual indicator of the status of metrics 700 of facility 114 and may require two physical boards for that purpose. In one embodiment, each facility 114 may have one facility display 800. Facility display 800 may be mounted on a wall or may be a standing structure, in which facility display 800 may include casters for ease of transportation. Facility display 800 may also include options for desk mounting. Facility display 800 may additionally include a public announcement system depending on its placement within facility 114. In certain situations, facility display 800 may serve as a physical building board, e.g., a particular facility 114 may have a separate physical structure for a specific process or value stream 119, in which case a separate facility display 800 for that structure may display the metrics for all of the processes or value streams 119 within. Facility display 800 may encompass any practicable dimensions, but each board of facility display 800 (one board as shown in FIG. 8a, one in FIG. 8b) may stand approximately four feet in height by approximately six feet in length. In another embodiment, facility display 800 may be made available to facility 114 via a general-purpose computer.

Organization 100 may organize facility display 800 around critical success factors 190 (see FIG. 1b), which may themselves be aligned with specific metrics, as previously discussed. This strategy may further help to ensure that facilities 114 comply with specific principles of organization 100, for example, principle 366, Align the Targets.

Referring to FIGS. 8a and 8b, within the critical success factor framework described, facility display 800 may generally be divided into six discrete sections. The first, section 810, may be a generally columnar region in which one or more critical success factors 190 may be displayed. As shown in the embodiment of FIG. 8a, critical success factors 192-198 (People, Quality, Velocity, and Cost, see FIG. 2a) may be exhibited by a factor name 812 generally, or specifically, for example, such as 812a, 812b, 812c, and 812d. Factor names 812 may be displayed vertically in section 810 along the left side of facility display 800. As with metric graph 701, each factor name 812 may include a symbol 814 generally, or specifically as, for example, such as 814a, 814b, 814c, and 814d, which may be one of the four symbols (cross, star, arrow, or circle) corresponding to one of critical success factors 190 identified by factor name 812, as described earlier. In FIG. 8a, for example, symbol 814a, in the form of a cross, represents critical success factor 192, People.

Each symbol 814 may further include an internal table 816 generally, or specifically, for example, such as 816a, 816b, 816c, and 816d. Table 816 may be numbered, with each number representing a day of a specified time period, such as a month. Specifically, a metric indicator 817 generally, or specifically, for example, such as 817a, 817b, 817c, and 817d, may present the name of a particular metric in a separate portion of facility display 800 being tracked within table 816 for the corresponding critical success factor such that each number 818 generally, or specifically, for example, such as 818a, 818b, 818c, and 818d, within table 816 serves as a visual indicator of that particular metric, specifically the trend of that metric over time. For example, a number 818a (as shown in symbol 814a) may be colored-coded green, yellow, or red to indicate the relative status of the corresponding metric, as with metric graphs 701. Specifically, the color green may be used to indicate the referenced metric is meeting or exceeding the metric goal; the color yellow may be used to represent that the referenced metric is quantitatively superior to an established baseline value but not yet meeting the metric goal; and the color red may be used to signal that the referenced metric is not only not meeting the metric goal but is quantitatively inferior to the established baseline value. In this manner, anyone may be able to quickly glimpse within section 810 the status of the metrics associated with the corresponding critical success factor.

A second vertical section of facility display 800 may be section 820, Plan. In one embodiment, section 820 may be adjacent to section 810 and may allow employees to view parameters organization 100 is employing to reach a future state of metrics 700 while preparing employees for any potentially accompanying changes. Referring to FIG. 8a, within section 820 may be posted or displayed one or more individual objective plans 822. Objective plans 822 may generally include a detailed explanation of the critical success factor goals and objectives at that hierarchical level, in this embodiment, for facility 114.

As shown in FIG. 8c, a representative objective plan 822 may include a title 824, such as “Business Plan Development.” Category 826 may denote into which critical success factor such objective plan 822 belongs and will, therefore, determine to which critical success factor in section 810 objective plan 822 will be adjacent. Objectives section 828 may include an overall organizational goal 829, which may be developed by a section manager of facility 114 along with other management personnel A goal list 830 of the specific goals of organization 100 may be created to meet overall organizational goal 829. As shown in FIG. 8c, representative goals in goal list 830 may include, for example, reducing recordable injuries to certain quantitative levels, continuing and improving employee attendance, formally appraising all employees, and continuing to improve scheme methods. Each goal in goal list 830 may be further subdivided to deconstruct any goal into discrete parts. It will be noted that various goals within goal list 830 may exist without limit, depending on the priorities of organization 100. Goal list 830 may, as a result, also initiate employee discussions, including Process Improvement Dialogues, discussed in detail below.

Target section 832 may include one or more targets 834 corresponding to each enumerated goal in goal list 830. Targets 834 may include specific quantitative or qualitative values that indicate in what manner each specific goal in goal list 830 may be monitored, or alternatively, what is required to achieve the goal. For example, a goal within goal list 830 of formally appraising all employees within facility 114 may be reached if 100% of the employees have been appraised by the end of the year, as shown. Any number of variations may be applicable for specific situations.

Section 836, Department Responsible, may indicate which departments 838 may have accountability over any given enumerated goal in goal list 830. Any indicator may be suitable for this purpose, as, for example, department initials 839 as shown in FIG. 8c. Section 840 may highlight goal progress through a predetermined timeframe, for example, a calendar year, and may be divided into subsections. In one embodiment, a year-long timeframe may be divided into monthly segments, with markers 842 indicating a state of progress. Referring to FIG. 5c, the markers 842 may be in the form of shapes, with the interior of the shapes filled, depending on the progress state. A marker box 844 may be included as a legend to indicate the precise marker 842 used and how it is to be interpreted. In the embodiment shown in FIG. 8c, a white triangle may indicate a planned control or check, while a darkened triangle may indicate an actual control or check of the goal progress. Any other type of marker 842 may be suitable for indicating this progress. External support section 846 may be included in objective plan 822 to, for example, allow for external support member acknowledgment. Similarly, signoff section 848, if included, may permit an additional facility 114 section manager or other individual in a position of authority, for example, an operations manager or facility manager, to approve a particular goal from goal list 830, or to acknowledge progress within section 840. A comments section 850 may be included to communicate any additional information. Objective accountability section 852 may effectively create accountability of the objectives within a particular objective plan 822 and may include areas for various section managers and management personnel within facility 114 to approve those objectives.

Referring back to FIG. 8a, a third section of facility display 800 may be section 860, Do. In this embodiment, section 860 is adjacent to section 820, Plan, and may display metrics 700 (see FIG. 1b) indicating how a specific facility 114 is progressing against established goals. In accordance with one purpose of facility display 800, all facilities 114 may display identical metrics 700 in substantially the same location on each facility display 800. Referring to FIG. 8a, within section 860 may be one or more metric sheets 862, which may be comprised of metric graphs 701, previously discussed and shown in FIG. 7. Specifically, metric sheets 862 may be divided into prescribed metric sheets 864 and choice metric sheets 866 (see FIG. 8b). Prescribed metric sheets 864 may show metrics that have been designated by organization 100 as required to be displayed for the associated critical success factor 192-198. Referring to FIGS. 5a and 8b, prescribed metric sheets 864 are indicated by a specific metric name, for example, Storage Location Accuracy. Choice metric sheets 866, in contrast, may show metrics that are “open” on facility display 800 and may include metrics local to that facility 114. For example, choice metric sheet 866 labeled “People Choice” in FIG. 8b may indicate the position of such a choice metric sheet 866 for the critical success factor of People. As can be seen, various prescribed metric sheets 864 (identified by a specific name) and choice metric sheets 866 (identified by the word “choice”) may populate section 860. The number of prescribed metric sheets 864 in a facility display 800 may vary by critical success factor and one or more metric sheets 862 may be situated within any single metric sheet slot. These metric sheets 862 may be physically attached to facility display 800 through the use of adhesives, clips, or other means of attachment known in the art. For example, an attachment device, such as a Grip-a-Strip or other commonly known device, may be used for this purpose such that metric sheets 862 may be easily removed, replaced, or updated. In another embodiment, metric sheets 862 may be made available via a general-purpose computer.

As shown in FIG. 8b, a fourth section of facility display 800 may be section 870, Check. In one embodiment, section 870 is adjacent to section 860, Do, and may convey a visual system using arrows 872 to indicate if the overall evaluation of the metrics is meeting the objective plan 822 for the corresponding critical success factor and progressing in an acceptable direction. Arrows 872 may be colored to further identify progress and may include the first letter of the color adjacent to the structure of arrow 872. As shown in FIG. 8b, section 870 may include a plurality of arrows 872.

In one embodiment, a single arrow 872 may be pointed upward, a single arrow 872 may be pointed downward, and a two-headed arrow may point laterally with respect to facility display 800. Section 870 may concern the collective status of metrics 700 within section 860 and may reflect their overall trend. One aspect of this collective status is a color-coding of arrows 872. Metric sheets 862 of section 860 may provide a foundation for the color-coding of arrows 872, as each metric sheet 862 is comprised of a metric graph 701 with a color-coded visual indicator 704 (as previously described and shown on FIG. 7). Therefore, for example, in one embodiment, an arrow 872 may be colored green if 66% or more metric sheets 862 within the adjacent section 860 row include a green visual indicator 704 while less than two metric sheets 862 within the row include a red visual indicator 704. Alternatively, an arrow 872 may be colored red if 33% or more metric sheets 862 within the row include a red visual indicator 704. An arrow 872 may be colored yellow if the metric sheets 862 include any combination of colors outside of those conditions.

Another aspect of the collective status of the metrics of section 860 involves which particular arrow 872 within section 870 may be color-coded. Again, metric sheets 862 of section 860 may provide a foundation for this selection, as each metric sheet 862 is comprised of a metric graph 701 with trend line 714 (as previously described and shown on FIG. 7). Therefore, for example, in one embodiment, a single arrow 872 pointed upward may be colored, if, for example, 66% or more of metric sheets 862 within the adjacent section 860 include a trend line 714 trending positively and less that two metric sheets 862 include a trend line 714 trending negatively. A single arrow 872 pointed downward may be colored, if, for example, 33% or more of the metric sheets 862 include a trend line 714 trending negatively. A two-headed arrow 872 may be colored if the metric sheets 862 in the row have any combination of trending outside the above-mentioned conditions. In this manner, section 870 may provide a quick visual aid to immediately determine both the current collective status and trend of metrics 700 shown on metric sheets 862 for the chosen critical success factor, i.e., a quantitative evaluation of the metric with respect to its baseline and goal, in addition to historical information as to metric progress. It is well known to anyone of skill in the art the many variations of color, direction, shape, or other identifying characteristic that may be employed in symbolically conveying such information. In addition, an owner of facility display 800 may be ultimately responsible for determining the arrow color and direction, e.g., a particular metric shown in a metric sheet 862 may be more heavily weighted than other metrics in section 860, in which case the facility display 800 owner may decide to color an arrow in contradiction to the exemplary parameters described above.

A fifth section of facility display 800 may be section 880, Act. In one embodiment, section 880 is adjacent to section 870, Check, and may provide an area for root cause corrective actions, which involve an analysis showing the source of problems identified in metrics 700 and the action(s) that are being done to correct the problems. For example, if any arrow 872 within section 870 is colored red or yellow, then section 880 may be used to show the proposal or plan being utilized to improve the particular metric(s) to, for example, a green condition and/or trending positively. Section 880 may also provide those who review the display the opportunity to see actions required to correct the color and/or trend of the metric(s).

Referring to FIG. 8d, an example of a root cause corrective action chart 882 for the facility 114 level may include a value stream identification section 883, identifying which particular value stream 119 may be associated with the problem. Adjacent to value stream identification section 883 may be a root cause area 884, in which a specific cause of an underperforming metric may be identified. A corrective action area 886 may detail one or more actionable items deemed helpful to improve the metric. Such an action may be derived from a Process Improvement Dialogue or as part of a Continuous Improvement process, as will be further described. Also included within root cause corrective action chart 882 may be an ownership area 887 for acknowledging accountability for performing each actionable item listed in corrective action area 886. An implementation area 888 may further provide a target date for action, and a status area 889 may symbolically provide a visual determination of actionable item progress. As shown, status area 889 may include a status chart 890 indicating a percentage of completion of the actionable item of corrective action area 886.

As shown in FIG. 8b, a sixth area of facility display 800 may be section 892, Principles/Communications. In one embodiment, section 892 may be adjacent to section 880, Act, and may contain one or more spider charts 894, such as, for example, spider charts 894a, 894b, and 894c. Each spider chart 894 displayed may be based on previously defined subsystems 300, such as operating subsystem 310, cultural subsystem 320, and management subsystem 330. The “spokes” on spider chart 894 may, as a result, represent the associated principles of each subsystem 300, respectively. For example, spider chart 894a may provide information assessing how well facility 114 is performing within the operating subsystem 310 with respect to its associated principle 340, Chase Waste; principle 342, Pull; principle 344, Make Value Flow; principle 346, Drive Standard Work; principle 348, Even the Load; and principle 350, Validate Our Processes (see FIG. 3). Referring to FIG. 8b, each “spoke” of each spider chart 894 may include six levels, representing the five possible scores from zero to five available using the assessment scoring scale discussed above for assessment 400 (see FIG. 1b). Alternatively, section 892 of facility display 800 may include a generally open space 896 for various communications of organization 100 personnel, as shown in FIG. 8e.

2) Group Display

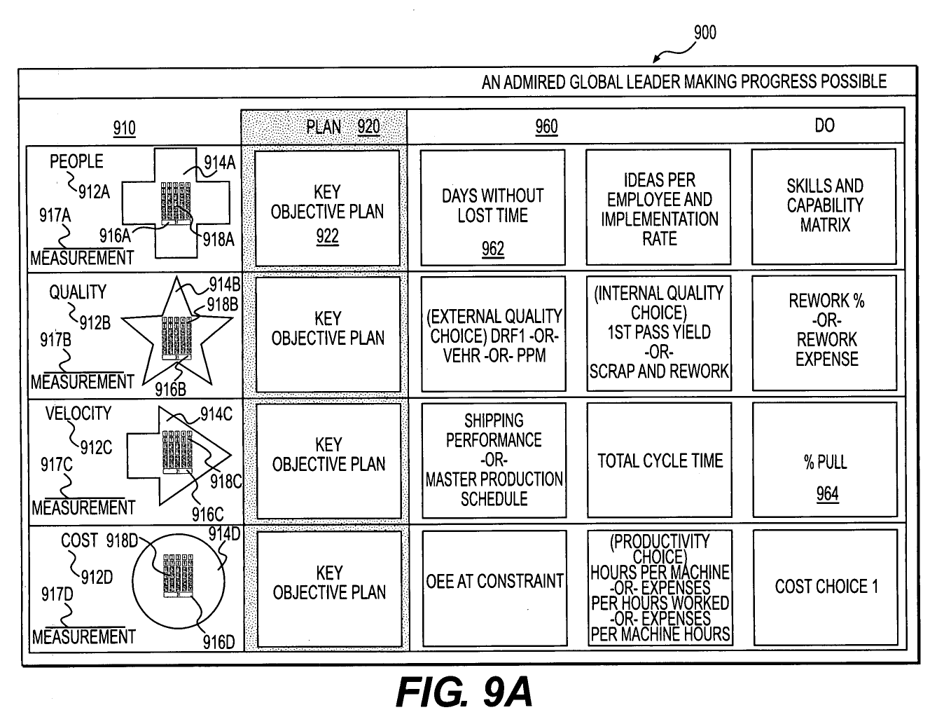

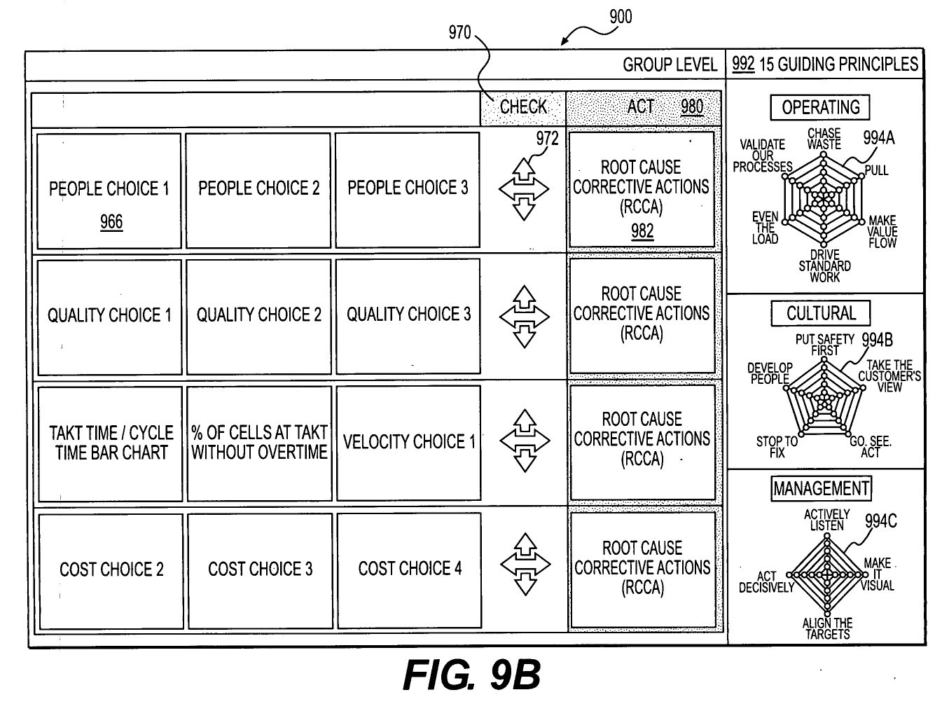

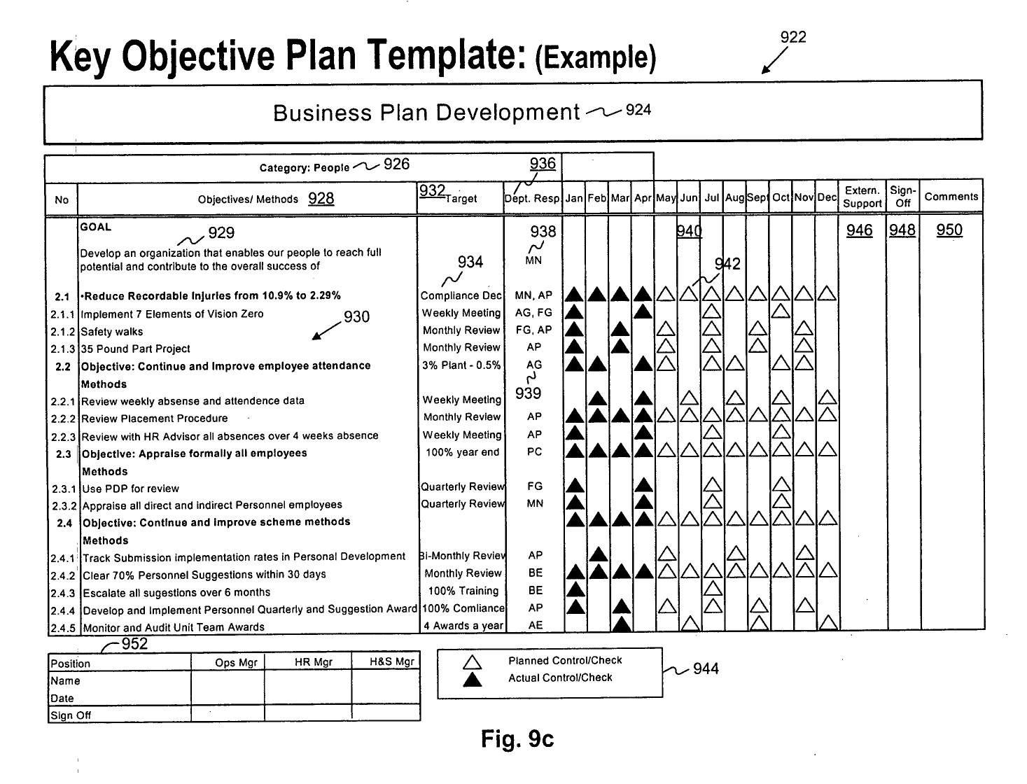

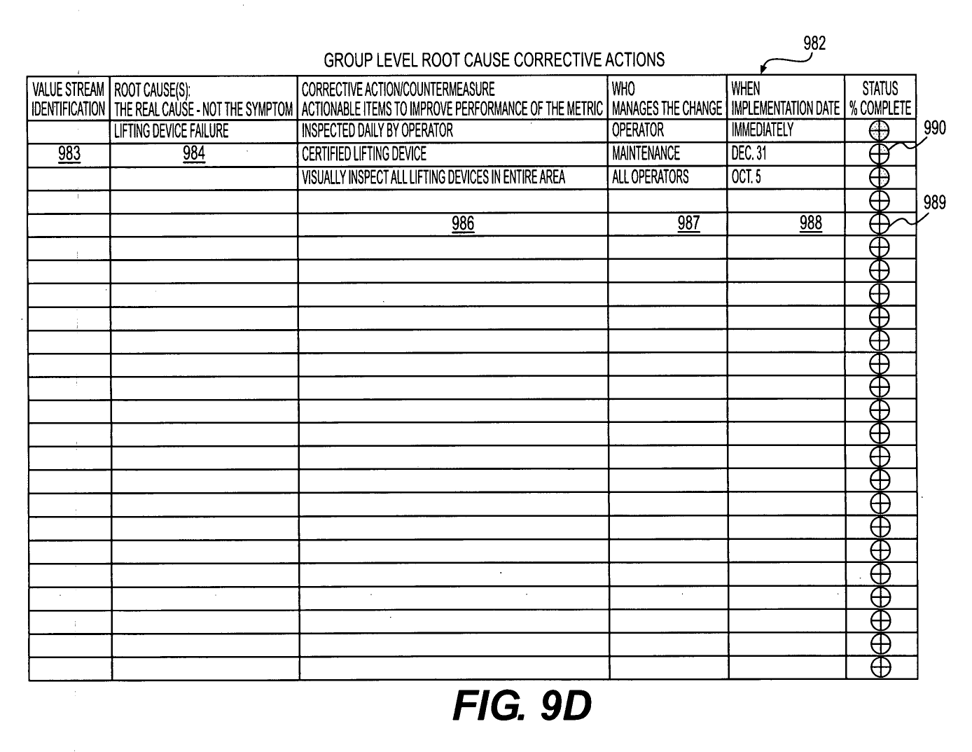

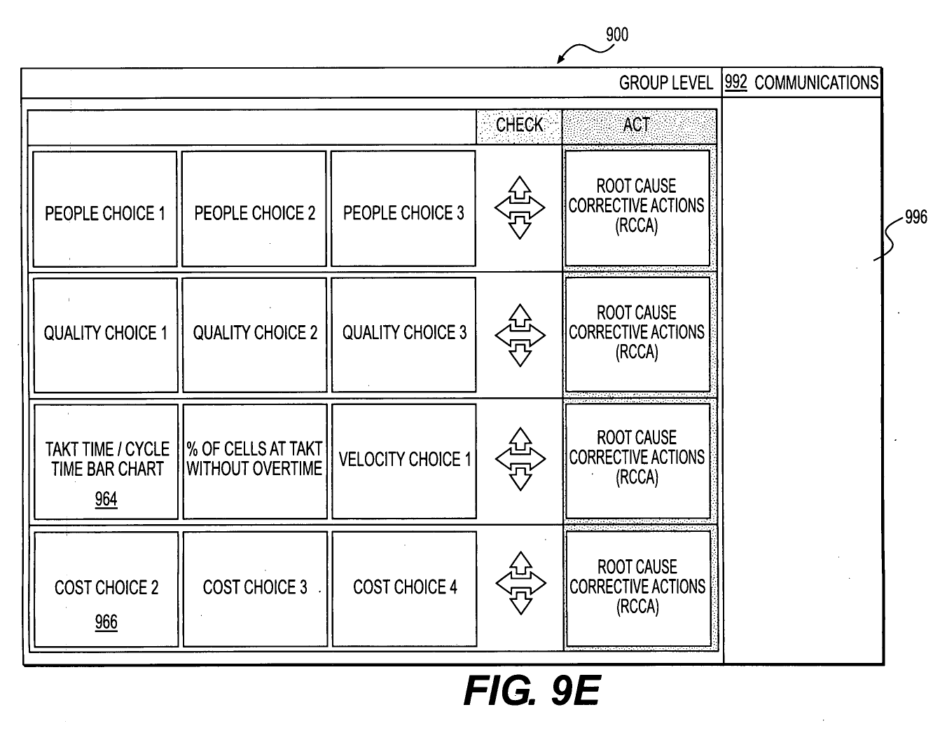

Referring to FIGS. 9a and 9b, group display 900 is generally similar in appearance to facility display 800. Group display 900 may provide a visual indicator of the status of metrics 700 through the level of group 120 and may require two physical boards for that purpose. Each group 120 may have one group display 900. As with facility display 800, group display 900 may be mounted on a wall or may be a standing structure, in which case group display 900 may include casters for ease of transportation. Group display 900 may also include options for desk mounting and may include a public announcement system. Group display 900 may encompass any practicable dimensions, but each board of group display 900 (one board as shown in FIG. 9a, one in FIG. 9b) may stand approximately four feet in height by approximately six feet in length. In another embodiment, group display 900 may be made available to group 120 via a general-purpose computer.

Referring to FIG. 9a, organization 100 may organize group display 900 around critical success factors 190 (see FIG. 1b), which are themselves aligned with specific metrics, as previously discussed. This further helps to ensure that groups 120 comply with specific principles of organization 100, for example, principle 366, Align the Targets (see FIG. 3).

Referring to FIGS. 9a and 9b, within the critical success factor framework described, group display 900 may generally be divided into six discrete sections. The first, section 910, may be a generally columnar region in which one or more critical success factors 190 may be displayed. As shown in the embodiment of FIG. 9a, the critical success factors 192-198 (People, Quality, Velocity, and Cost, see FIG. 2a) may be exhibited by a factor name 912 generally, or specifically, for example, such as 912a, 912b, 912c, and 912d. Factor names 912 may be displayed vertically in section 910 along the left side of group display 900. As with metric graph 701, each factor name 912 may include a symbol 914 generally, or specifically as, for example, such as 914a, 914b, 914c, and 914d, which may be one of the four symbols (cross, star, arrow, or circle) corresponding to one of critical success factors 190 identified by factor name 912, as described earlier. In FIG. 9a, for example, symbol 914a, in the form of a cross, represents critical success factor 192, People.

Each symbol 914 may include an internal table 916 generally, or specifically as, for example, such as 916a, 916b, 916c, and 916d. Table 916 may be numbered, with each number representing a day of a specified time period, such as a month. Specifically, a metric indicator 917 generally, or specifically, for example, such as 917a, 917b, 917c, and 917d, may present the name of a particular metric in a separate portion of group display 900 being tracked within table 916 for the corresponding critical success factor such that each number 918 generally, or specifically, for example, such as 918a, 918b, 918c, and 918d, within table 916 serves as a visual indicator of that particular metric, specifically the trend of that metric over time. In particular, a number 918a (as shown in symbol 914a) may be colored-coded green, yellow, or red to indicate the relative status of a corresponding metric, as with metric graphs 701. Specifically, the color green may be used to indicate the referenced metric is meeting or exceeding the metric goal; the color yellow may be used to represent that the referenced metric is quantitatively superior to an established baseline value but not yet meeting the metric goal; and the color red may be used to signal that the referenced metric is not only not meeting the metric goal but is quantitatively inferior to the established baseline value. In this manner, anyone may be able to quickly glimpse within section 910 the status of the metrics associated with the corresponding critical success factor.

A second vertical section of group display 900 may be section 920, Plan. In one embodiment, section 920 is adjacent to section 910 and may allow employees to view the parameters organization 100 is employing to reach a future state of metrics 700 while preparing employees for any potentially accompanying changes. Referring to FIG. 9a, within section 920 may be posted or displayed individual objective plans 922. Objective plans 922 may generally include a detailed explanation of the critical success factor goals and objectives at this hierarchical level.

As shown in FIG. 9c, a representative objective plan 922 may include a title 924, such as “Business Plan Development.” Category 926 may denote into which critical success factor such objective plan 922 belongs and will, therefore, determine to which critical success factor in section 910 objective plan 922 will be adjacent. Objectives section 928 may include an overall organizational goal 929, which may be developed by a section manager of group 120 along with other management personnel. A goal list 930 of the specific goals of organization 100 may be created to meet overall organizational goal 929. As shown in FIG. 9c, representative goals in goal list 930 may include, for example, reducing recordable injuries to certain quantitative levels, continuing and improving employee attendance, formally appraising all employees, and continuing to improve scheme methods. Each goal in goal list 930 may be further subdivided to deconstruct any goal into discrete parts. It will be noted that various goals within goal list 930 may exist without limit, depending on the priorities of organization 100. Goal list 930 may, as a result, also initiate employee discussions, including Process Improvement Dialogues, discussed in detail below.

Target section 932 may include one or more targets 934 corresponding to each enumerated goal in goal list 930. Targets 934 may include specific quantitative or qualitative values that indicate in what manner each specific goal in goal list 930 may be monitored, or alternatively, what is required to achieve the goal. For example, a goal within goal list 930 of formally appraising all employees within group 120 may be reached if 100% of the employees have been appraised by the end of the year. Any number of variations may be applicable for any specific situations.

Section 936, Department Responsible, may indicate which departments 938 may have accountability over any given enumerated goal in goal list 930. Any indicator may be suitable for this purpose, as, for example, department initials 939 as shown in FIG. 9c. Section 940 may highlight goal progress through a predetermined timeframe, for example, a calendar year, and may be divided into subsections. In one embodiment, a year-long timeframe may be divided into monthly segments, with markers 942 indicating a state of progress. Referring to FIG. 9c, the markers 942 may be in the form of shapes, with the interior of the shapes, depending on the progress state. A marker box 944 may be included as a legend to indicate the precise marker 942 used and how it is to be interpreted. In the embodiment shown in FIG. 9c, a white triangle may indicate a planned control or check, while a darkened triangle may indicate an actual control or check of the goal progress. Any other type of marker 942 may be suitable for indicating this progress. External support section 946 may be included in objective plan 922 to, for example, allow for external support member acknowledgment. Similarly, signoff section 948, if included, may permit an additional group 120 section manager or other individual in a position of authority to approve a particular goal from goal list 930, or to acknowledge progress within section 940. A comments section 950 may be included to communicate any additional information. Objective accountability section 952 may create accountability of the objectives within a particular objective plan 922 and may include areas for various section managers and management personnel within group 120 to approve those objectives.

Referring back to FIG. 9a, a third section of group display 900 may be section 960, Do. In one embodiment, section 960 is adjacent to section 920, Plan, and may display metrics 700 (see FIG. 1b) indicating how a specific group 120 is progressing against established goals. In accordance with one purpose of group displays 900, all groups 120 may display identical metrics 700 in substantially the same location on each group display 900. Referring to FIG. 9a, within section 960 may be one or more metric sheets 962, which will be comprised of metric graphs 701, previously discussed and shown in FIG. 7. Specifically, metric sheets 962 may be divided into prescribed metric sheets 964 and choice metric sheets 966, as shown in FIGS. 9a and 9b. Prescribed metric sheets 964 may show metrics specifically designated by organization 100 to be displayed for the associated critical success factor 192-198. Referring to FIGS. 9a and 9b, prescribed metric sheets 964 are indicated by a specific metric name, for example, “% Pull.” Choice metric sheets 966, in contrast, may show metrics “open” on group display 900 and may include metrics local to that group 120. For example, choice metric sheet 966 labeled “People Choice 1” in FIG. 9b may indicate the position of such a choice metric sheet 966 for the critical success factor of People. As can be seen, various prescribed metric sheets 964 (identified by a specific name) and choice metric sheets 966 (identified by the word “choice”) may populate section 960. The number of prescribed metric sheets 964 in a group display 900 may vary by critical success factor and one or more metric sheets 962 may be situated within any single metric sheet slot. These metric sheets 962 may be physically attached to group display 900 through the use of adhesives, clips, or other means of attachment known in the art. For example, an attachment device, such as a Grip-a-Strip or other commonly known device, may be used for this purpose such that metric sheets 962 may be easily removed, replaced, or updated. In another embodiment, metric sheets 962 may be made available via a general-purpose computer.

As shown in FIG. 9b, a fourth section of group display 900 may be section 970, Check. In one embodiment, section 970 is adjacent to section 960, Do, and may convey a visual system using arrows 972 to indicate if the overall evaluation of the metrics is meeting the objective plan 922 for the corresponding critical success factor and progressing in an acceptable direction. Arrows 972 may be colored to further identify progress and may include the first letter of the color adjacent to the structure of arrow 972. As shown in FIG. 9b, section 970 may include a plurality of arrows 972.

In one embodiment, a single arrow 972 may be pointed upward, a single arrow 972 may be pointed downward, and a two-headed arrow may point laterally with respect to group display 900. Section 970 may concern the collective status of metrics 700 within section 960 and may their overall trend. One aspect of this collective status is a color-coding of arrows 972. Metric sheets 962 of section 960 may provide a foundation for the color-coding of arrows 972, as each metric sheet 962 is comprised of a metric graph 701 with a color-coded visual indicator 704 (as previously described and shown on FIG. 7). Therefore, for example, in one embodiment, an arrow 972 may be colored green if 66% or more metric sheets 962 within the adjacent section 960 row include a green visual indicator 704 while less than two metric sheets 962 within the row include a red visual indicator 704. Alternatively, an arrow 972 may be colored red if 33% or more metric sheets 962 within the row include a red visual indicator 704. An arrow 972 may be colored yellow if the metric sheets 962 include any combination of colors outside of those conditions.

Another aspect of the collective status of the metrics of section 960 involves which particular arrow 972 within section 970 may be color-coded. Again, metric sheets 962 of section 960 may provide a foundation for this selection, as each metric sheet 962 is comprised of a metric graph 701 with trend line 714 (as previously described and shown on FIG. 7). Therefore, for example, in one embodiment, a single arrow 972 pointed upward may be colored, if, for example, 66% or more of metric sheets 962 within the adjacent section 860 include a trend line 714 trending positively and less that two metric sheets 962 include a trend line 714 trending negatively. A single arrow 972 pointed downward may be colored, if, for example, 33% or more of metric sheets 962 include a trend line 714 trending negatively. A two-headed arrow 972 may be colored if metric sheets 962 in the row have any combination of trending outside the above-mentioned conditions. In this manner, section 970 may provide a quick visual aid to immediately determine both the current collective status and trend of metrics 700 shown on metric sheets 962 for the chosen critical success factor, i.e., a quantitative evaluation of the metric with respect to its baseline and goal, in addition to historical information as to metric progress. It is well known to anyone of skill in the art the many variations of color, direction, shape, or other identifying characteristic that may be employed in symbolically conveying such information. In addition, an owner of group display 900 may be ultimately responsible for determining the arrow color and direction, e.g., a particular metric shown in a metric sheet 962 may be more heavily weighted than other metrics in section 960, in which case the group display 900 owner may decide to color an arrow in contradiction to the exemplary parameters described above.

A fifth section of group display 900 may be section 980, Act. In one embodiment, section 980 is adjacent to section 970, Check, and may provide an area for root cause corrective actions, which involves an analysis showing the source of problems identified in metrics 700 and the action(s) that are being done to correct the problems. For example, if any arrow 972 within section 970 is colored red or yellow, then section 980 may be used to show the proposal or plan being utilized to improve the particular metric(s) to, for example, a green condition and/or trending positively. Section 980 may also provide those who review the display the opportunity to see actions required to correct the color and/or trend of the metric(s).

Referring to FIG. 9d, an example of a root cause corrective action chart 982 for the group 120 level may include a value stream identification section 983, identifying which particular value stream 119 may be associated with the problem. Adjacent to value stream identification section 983 may be a root cause area 984, in which a specific cause of an underperforming metric may be identified. A corrective action area 986 may detail one or more actionable items deemed helpful to improve the metric. Such an action may be derived from a Process Improvement Dialogue or as part of a Continuous Improvement process, as will be further described. Also included within root cause corrective action chart 982 may be an ownership area 987 for acknowledging accountability for performing each actionable item listed in corrective action area 986, an implementation area 988 for further providing a target date for action, and a status area 989 for symbolically providing a visual determination of actionable item progress. As shown, status area 989 may include a status chart 990 indicating a percentage of completion of the actionable item of corrective action area 986.

As shown on FIG. 9b, a sixth area of group display 900 may be section 992, Principles/Communications. In one embodiment, section 992 may be adjacent to section 980, Act, and may contain one or more spider charts 994, such as, for example, spider charts 994a, 994b, and 994c. Each spider chart 994 displayed may be based on previously defined subsystems 300, such as operating subsystem 310, cultural subsystem 320, and management subsystem 330. The “spokes” on spider chart 994 may, as a result, represent the associated principles of each subsystem 300, respectively. For example, spider chart 994a may provide information assessing how well the facility 114 of which the group 120 is a part is performing within the operating subsystem 310 with respect to its associated principle 340, Chase Waste, principle 342, Pull, principle 344, Make Value Flow, principle 346, Drive Standard Work, principle 348, Even the Load, and principle 350, Validate Our Processes (see FIG. 3). Referring to FIG. 9b, each “spoke” of each spider chart 994 may include six levels, representing the five possible scores from zero to five available using the assessment scoring scale discussed above for assessment 400 (see FIG. 1b). Alternatively, section 992 of group display 900 may include a generally open space 996 for various communications of organization 100 personnel, as shown in FIG. 9e.

As mentioned, at the group 120 level, a two-board group display 900 may be used as previously described within a facility 114 to provide a visual status of the performance of the group 120, or a group tower 1000 may be used for this purpose. Group display 900 or group tower 1000 may be owned by a group manager.

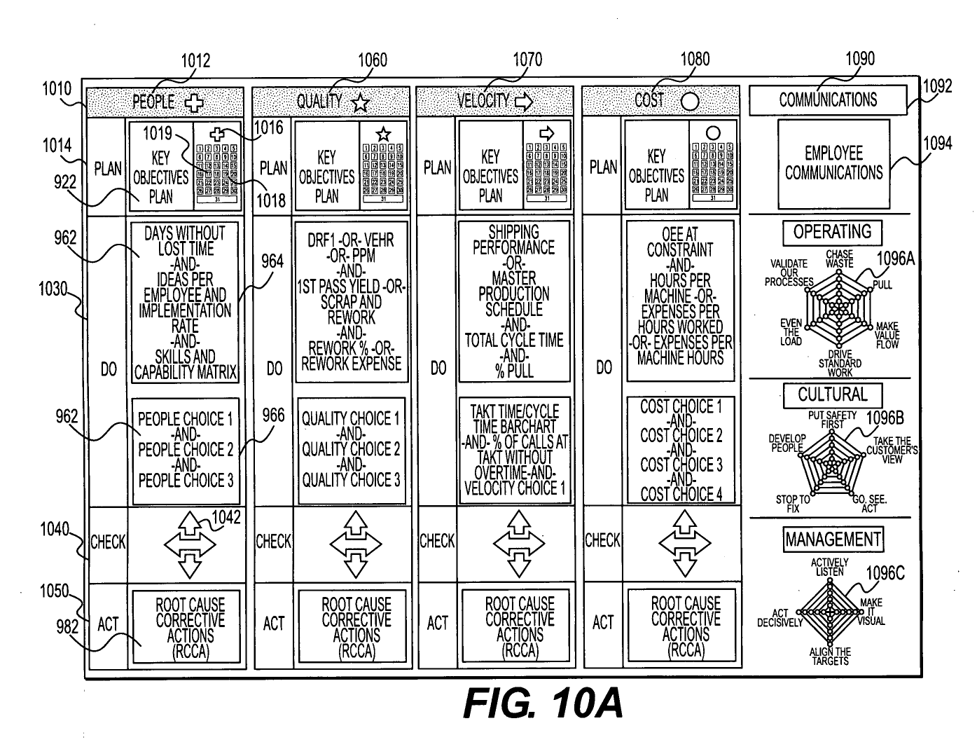

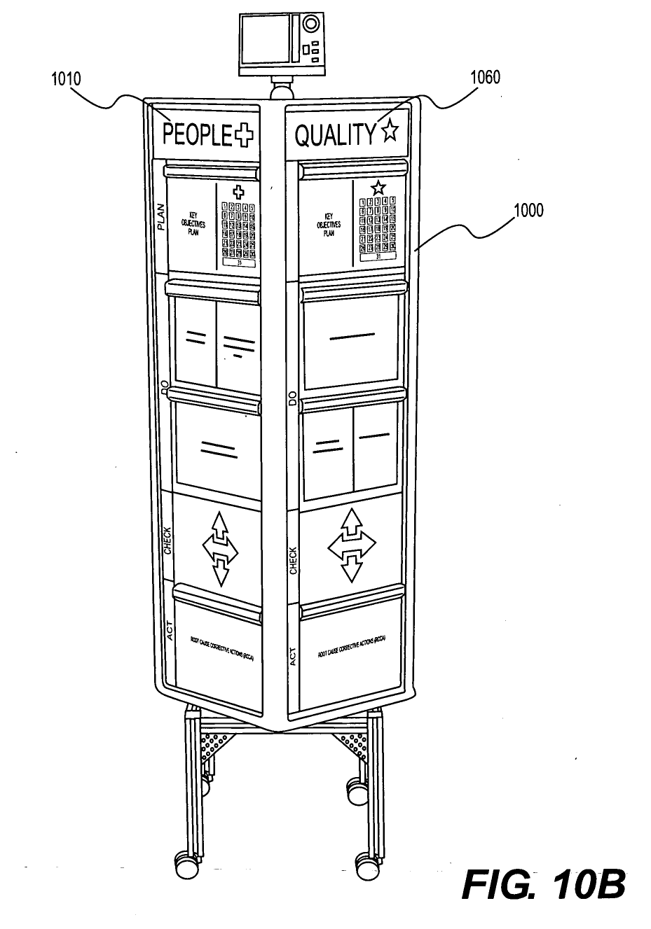

Referring to FIGS. 10a and 10b, group tower 1000 is a five-sided tower and may be an alternative to group display 900 if space is an issue. Group tower 1000 may be any reasonable height but may be approximately 79 inches tall and may be rotatable. FIG. 10a, as shown, details the makeup of each of the five sides. As can be seen, group tower 1000 varies the display and orientation of the information provided from facility display 800 and group display 900. In one embodiment, a first side 1010 may include a heading 1012. Heading 1012 may depict one of critical success factors 190 previously noted for organization 100, which in the present embodiment may be one of People, Quality, Velocity, and Cost. Below heading 1012, in section 1014, Plan, may be a symbol 1016 used to associate the critical success factor 192-198 (see FIG. 2a) with one or more metrics 700 (see FIG. 1b). Symbol 1016 may be identical to symbols 814, 914, described above for facility display 800 and group display 900, respectively. Internal table 1018 may be numbered, with each number 1019 representing a day of a specified time period, such as a month, with a particular metric in a separate portion of group tower 1000 being tracked within table 1018 for the corresponding critical success factor such that each number 1019 within table 1018 serves as a visual indicator of that particular metric, specifically the trend of that metric over time. Specifically, the color scheme previously described with facility display 800 and group display 900 may be used with group tower 1000. Section 1014, as with group display 900, allows employees to view the parameters organization 100 is employing to reach a future state of metrics 700 through the placement of individual objective plans 922 (as described previously). Objective plans 922 generally include a detailed explanation of the critical success factor goals and objectives and has been previously described. Section 1030, Do, may display metrics indicating how a specific group 120 is progressing against the established goal and baseline. As with group display 900, within section 1030 may be one or more metric sheets 962, which may be divided into prescribed metric sheets 964 and choice metric sheets 966. Within section 1030, one or more metric sheets 962 may be stacked on top of each other, as vertical space may limit the number of metric sheets 962 viewable. These metric sheets 962 may be physically attached to group tower 1000 through the same means previously described for group display 900. Section 1040, Check, may include a visual identification system using arrows 1042 similar to those within section 970 of group display 900 and based upon the metric sheets 962 of section 1030. Section 1050, Act, may provide an area for root cause corrective actions, which, as with group display 900, may involve an analysis showing the source of problems identified in metrics 700 and the action(s) that are being done to correct the problems. Section 1050 may display root cause corrective action chart 982 for the purpose previously described. Second side 1060, third side 1070, and fourth side 1080 may be substantially similar in detail to first side 1010 for the remaining critical success factors 194-198 (Quality, Velocity, and Cost, respectively). Fifth side 1090 may include a title 1092, such as “Communications” and may include a generally open space 1094 for the display of various communications to or from organization 100 personnel. Fifth side 1090 may also include one or more spider charts 1096, such as, for example, spider charts 1096a, 1096b, and 1096c, used in a similar manner as spider charts 994 on group display 900, or may alternatively include accessories such as a separate writing surface, an area for employee suggestions, or an area for document or other storage. FIG. 10b provides an additional perspective of group tower 1000, showing first side 1010 and second side 1060. In an alternative embodiment, the information on FIG. 10a (and FIG. 10b) may be made available via a general-purpose computer.

3) Area Display

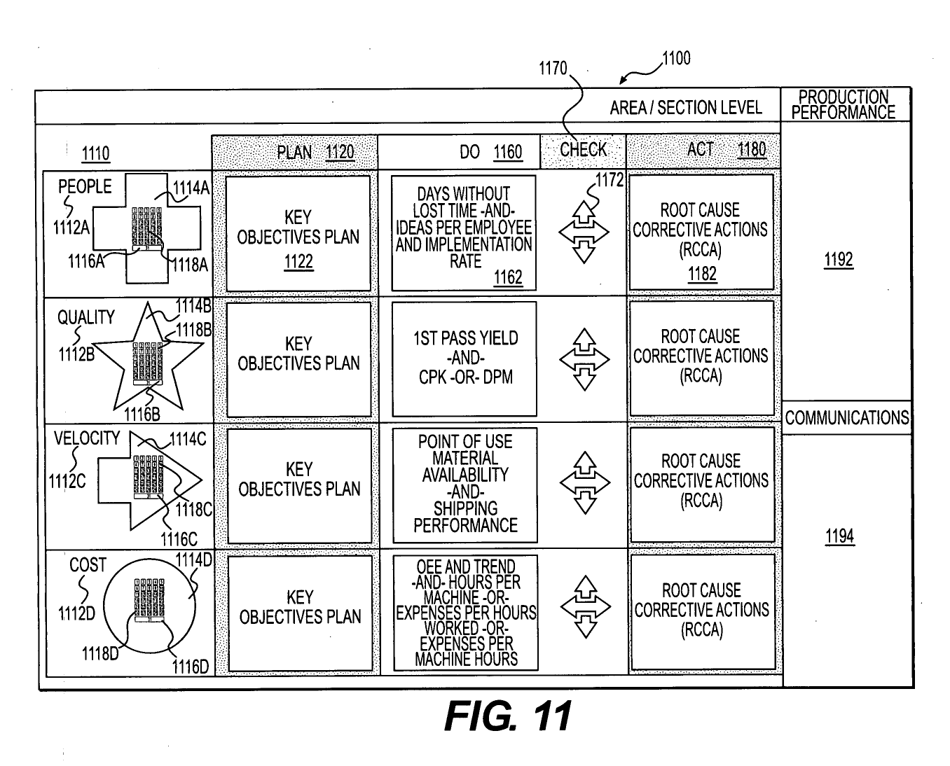

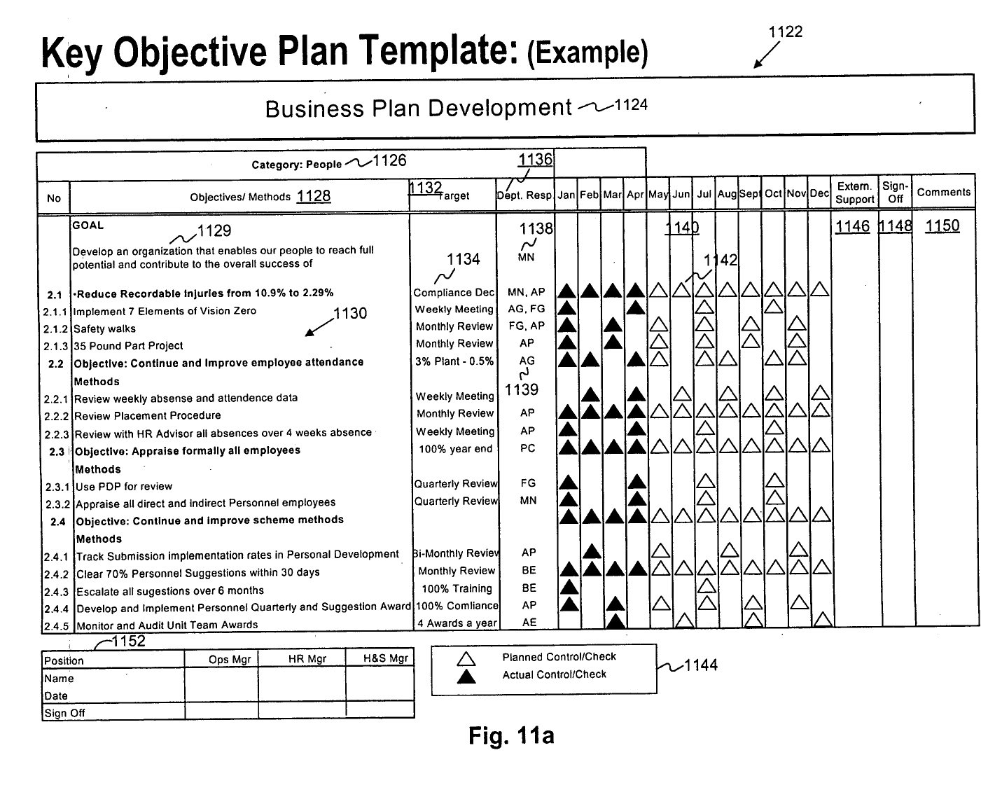

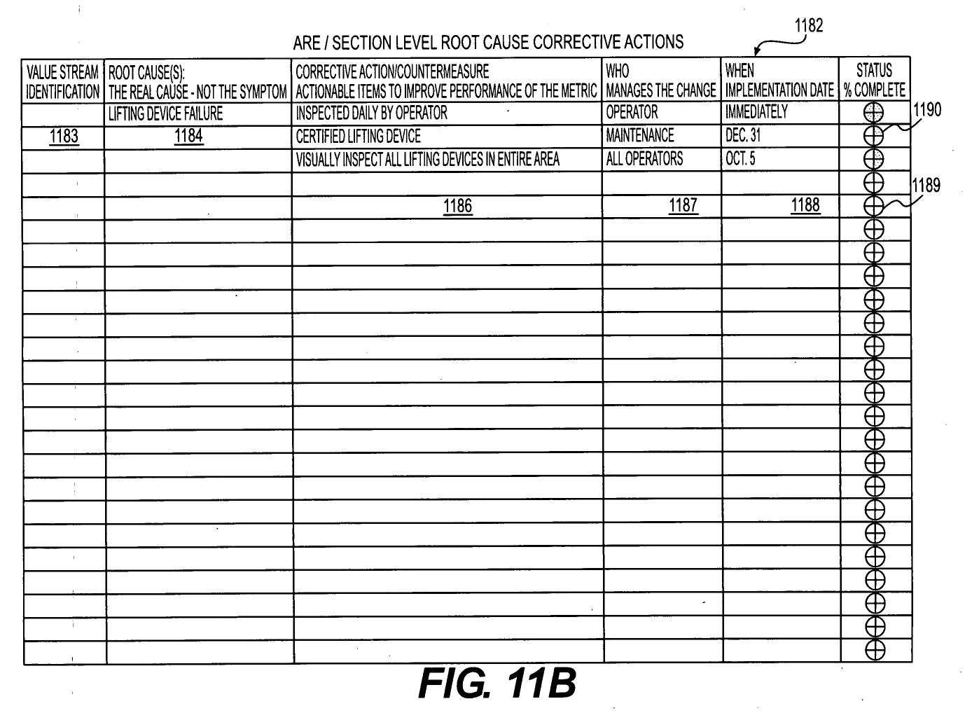

Referring to FIG. 11, area display 1100 may be similar to facility display 800 and group display 900, but may be a one-board system used to provide a visual status of the performance of an area 122 within a group 120. Area display 1100 may also be similar in size to a single board of facility display 800, but may alternatively be approximately four feet high by approximately five feet long, depending on the inclusion of an end section, as described below. With the end section included, area display 1100 may be approximately four feet high by approximately six feet long. FIG. 11 shows such an area display 1100. Each area 122 may have one area display 1100. As with group display 900, area display 1100 may be mounted on a wall or may be a standing structure, in which area display 1100 may include casters for ease of transportation. Area display 1100 may also include options for desk mounting. Alternatively, the information on FIG. 11 may be made available via a general-purpose computer.

Still referring to FIG. 11, organization 100 may organize area display 1100 around critical success factors 190 (see FIG. 1b), which are themselves aligned with specific metrics, as previously discussed. Again, this focuses not only area 122 but all levels within organization 100 on at least principle 366, Align the Targets (see FIG. 3).

Within the critical success factor framework described, area display 1100 may generally be divided into five discrete sections. A first section 1110 may be a generally columnar region in which one or more of critical success factors 190 may be displayed. As shown in the embodiment of FIG. 11, critical success factors 192-198 (People, Quality, Velocity, and Cost) may be exhibited by a factor name 1112 generally, or specifically, for example, such as 1112a, 1112b, 1112c, and 1112d. Factor name 1112 may be displayed vertically in section 1110 along the left side of area display 1100. As with metric graph 701, each factor name 1112 may include a symbol 1114 generally, or specifically as, for example, such as 1114a, 1114b, 1114c, and 1114d, which may be one of the four symbols (cross, star, arrow, or circle) corresponding to one of critical success factors 190 identified by factor name 1112, as previously described. In FIG. 11, for example, symbol 1114a, in the form of a cross, represents critical success factor 192, People.

In FIG. 11, an internal table 1116 generally, or specifically, for example, such as 1116a, 1116b, 1116c, and 1116d, may be numbered, with each number 1118 generally, or specifically, for example, such as 1118a, 1118b, 1118c, and 1118d representing a day of a specified time period, such as a month. A particular metric in a separate portion of area display 1100 may be tracked within, for example, table 1116a for the corresponding critical success factor 192-198 such that each number 1118a within table 1116a serves as a visual indicator of that particular metric, specifically the trend of that metric over time. As with facility display 800 and group display 900, a number 1118a (as shown in symbol 1114a) may be colored-coded green, yellow, or red to indicate the relative status of a corresponding metric. Specifically, the color green may be used to indicate the referenced metric is meeting or exceeding the metric goal; the color yellow may be used to represent that the referenced metric is quantitatively superior to an established baseline value but not yet meeting the metric goal; and the color red may be used to signal that the referenced metric is not only not meeting the metric goal but is quantitatively inferior to the established baseline value. In this manner, anyone may be able to quickly glimpse within section 1110 the status of the metrics associated with the corresponding critical success factor.

A second section of area display 1100 may be section 1120, Plan. In one embodiment, section 1120 may be adjacent to section 1110 and may include posted or displayed one or more individual objective plans 1122 for the associated critical success factor. Objective plans 1122 may include a detailed explanation of the critical success factor goals and objectives at this hierarchical level. As shown in FIG. 11a, a representative objective plan 1122 may include a title 1124, such as “Business Plan Development.” Category 1126 may denote into which critical success factor such objective plan 1122 belongs and will, therefore, determine to which critical success factor in section 1110 objective plan 1122 will be adjacent. Objective section 1128 may include an overall organizational goal 1129, which may be developed by a section manager of area 122 along with other management personnel. A goal list 1130 of the specific goals of organization 100 may be created to meet overall organizational goal 1129. As shown in FIG. 11a, representative goals in goal list 1130 may include, for example, reducing recordable injuries to certain quantitative levels, continuing and improving employee attendance, formally appraising all employees, and continuing to improve scheme methods. Each goal in goal list 1130 may be further subdivided to deconstruct any goal into discrete parts. It will be noted that various goals within goal list 1130 may exist without limit, depending on the priorities of organization 100. Goal list 1130 may, as a result, also initiate employee discussions, including Process Improvement Dialogues, discussed in detail below.

Target section 1132 may include one or more targets 1134 corresponding to each enumerated goal in goal list 1130. Targets 1134 may include specific quantitative or qualitative values that indicate in what manner each specific goal in goal list 1130 may be monitored, or alternatively, what is required to achieve the goal. For example, a goal within goal list 1130 of formally appraising all employees within area 122 may be reached if 100% of the employees have been appraised by the end of the year. Any number of variations may be applicable for specific situations.

Section 1136, Department Responsible, may indicate which departments 1138 may have accountability over any given enumerated goal in goal list 1130. Any indicator may be suitable for this purpose, as, for example, department initials 1139 as shown in FIG. 11a. Section 1140 may highlight goal progress through a predetermined timeframe, for example, a calendar year, and may be divided into subsections. In one embodiment, a year-long timeframe may be divided into monthly segments, with markers 1142 indicating a state of progress. Referring to FIG. 11a, the markers 1142 may be in the form of shapes, with the interior of the shapes filled, depending on the progress state. A marker box 1144 may be included as a legend to indicate the precise marker 1142 used and how it is to be interpreted. In the embodiment shown in FIG. 11a, a white triangle may indicate a planned control or check, while a darkened triangle may indicate an actual control or check of the goal progress. Any other type of marker 1142 may be suitable for indicating this progress. External support section 1146 may be included in objective plan 1122 to, for example, allow for external support member acknowledgment. Similarly, signoff section 1148, if included, may permit an additional area 122 section manager or other individual in a position of authority to approve a particular goal from goal list 1130, or to acknowledge progress within section 1140. A comments section 1150 may be included to communicate any additional information. Objective accountability section 1152 may create accountability of the objectives within a particular objective plan 1122 and may include areas for various section managers and management personnel within area 122 to approve those objectives.

Referring back to FIG. 11, a third section of area display 1100 may be section 1160, Do. In one embodiment, section 1160 may be adjacent to section 1120, Plan, and may display metrics 700 (see FIG. 1b) indicating how a specific area 122 is progressing against established goals. In accordance with one purpose of area displays 1100, all areas 122 may display identical metrics 700 in substantially the same location on each area display 1100. Referring to FIG. 11, within section 1160 may be one or more metric sheets 1162, which may include metric graphs 701, previously discussed and shown in FIG. 7. As can be seen, various metric sheets 1162 may populate section 1160 and the number of metric sheets 1162 within section 1160 may vary by critical success factor 192-198. As with the previously described displays 800, 900, metric sheets 1162 may be physically attached to area display 1100 through the use of adhesives, clips, or other means of attachment known in the art such that metric sheets 1162 may be easily removed, replaced, or updated. In another embodiment, metric sheets 1162 may be made available via a general-purpose computer.

A fourth section of area display 1100 may be section 1170, Check. In one embodiment, section 1170 may be adjacent to section 1160, Do, and may convey a visual system using arrows 1172 to indicate if the overall evaluation of the metrics is meeting the objective plan 1122 for the corresponding critical success factor and progressing in an acceptable direction. Arrows 1172 may be colored to further identify progress and may include the first letter of the color adjacent to the structure of arrow 1172. As shown in FIG. 11, section 1170 may include a plurality of arrows 1172. Arrows 1172 are similar to arrows 872 of facility display 800 and function in a similar manner to provide the same information concerning the collective status of the metrics within section 1160 for the associated critical success factor. As with facility display 800 and group display 900, an owner of area display 1100 may be ultimately responsible for determining the arrow color and direction, e.g., a particular metric shown in a metric sheet 1162 may be more heavily weighted than other metrics in section 1160, in which case the area display 1100 owner may decide to color an arrow in contradiction to the exemplary parameters described above.

A fifth section of area display 1100 may be section 1180, Act. In one embodiment, section 1180 may be adjacent to section 1170, Check, and may provide an area for root cause corrective actions in the same manner as previously described displays 800, 900. Referring to FIG. 11b, an example of a root cause corrective action chart 1182 for the area 122 level may include a value stream identification section 1183, identifying which particular value stream 119 may be associated with the problem. Adjacent to value stream identification section 1183 may be a root cause area 1184, in which a specific cause of an underperforming metric may be identified. A corrective action area 1186 may detail one or more actionable items deemed helpful to improve the metric. Such an action may be derived from a Process Improvement Dialogue or as part of a Continuous Improvement process, as will be further described below. Also included within root cause corrective action chart 1182 may be an ownership area 1187 for acknowledging accountability for performing each actionable item listed in corrective action area 1186, an implementation area 1188 for further providing a target date for action, and a status area 1189 for symbolically providing a visual determination of actionable item progress. As shown, status area 1189 may include a status chart 1190 indicating a percentage of completion of the actionable item of corrective action area 1186.

An optional sixth area of area display 1100 may be section 1192, Production Performance, along with section 1194, Communications. In one embodiment, section 1192 may contain a generally open space for various production notes for area 122 while section 1194 may allow for general communications of organization 100 personnel, as needed. In an alternative embodiment, area display 1100 may be made available via a general-purpose computer.

As with group 120, a tower display may be utilized in an alternative embodiment for area 122 where space is an issue.

4) Cell Display

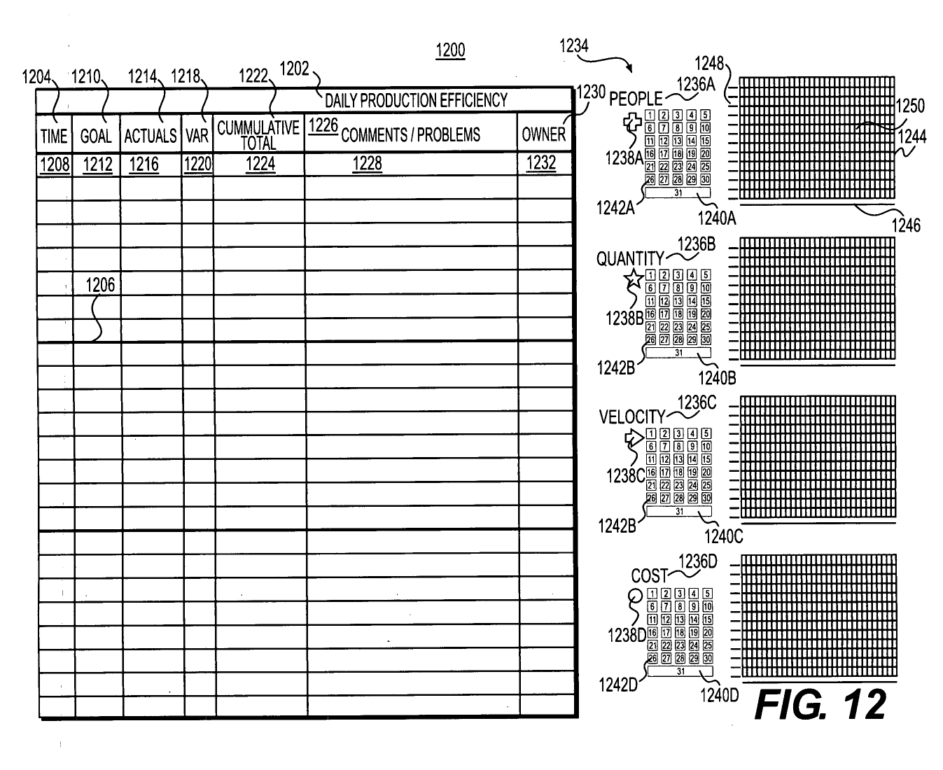

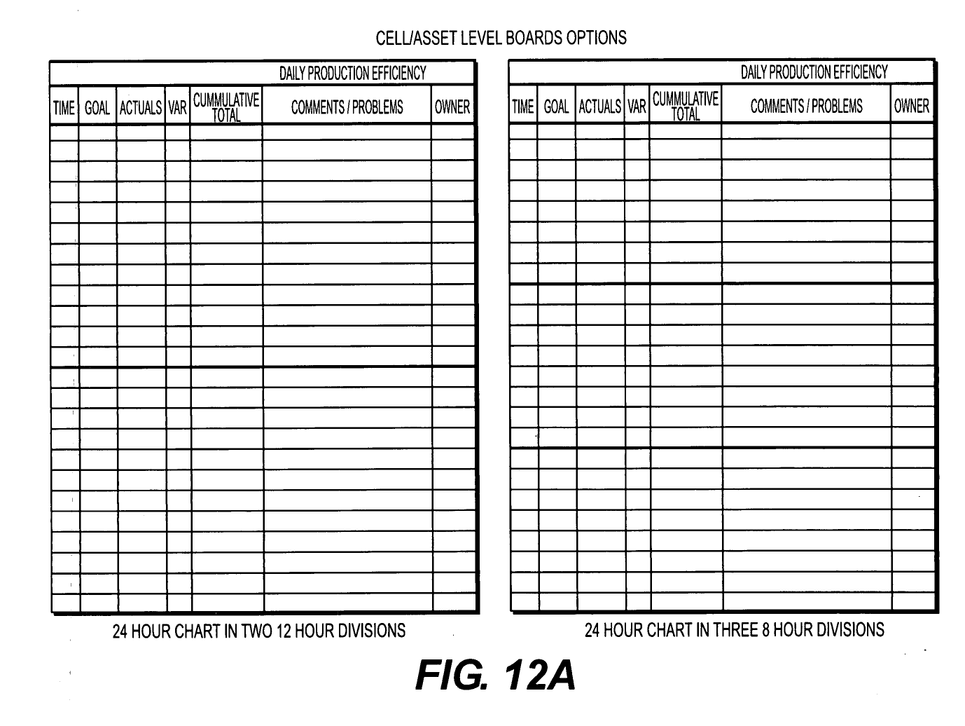

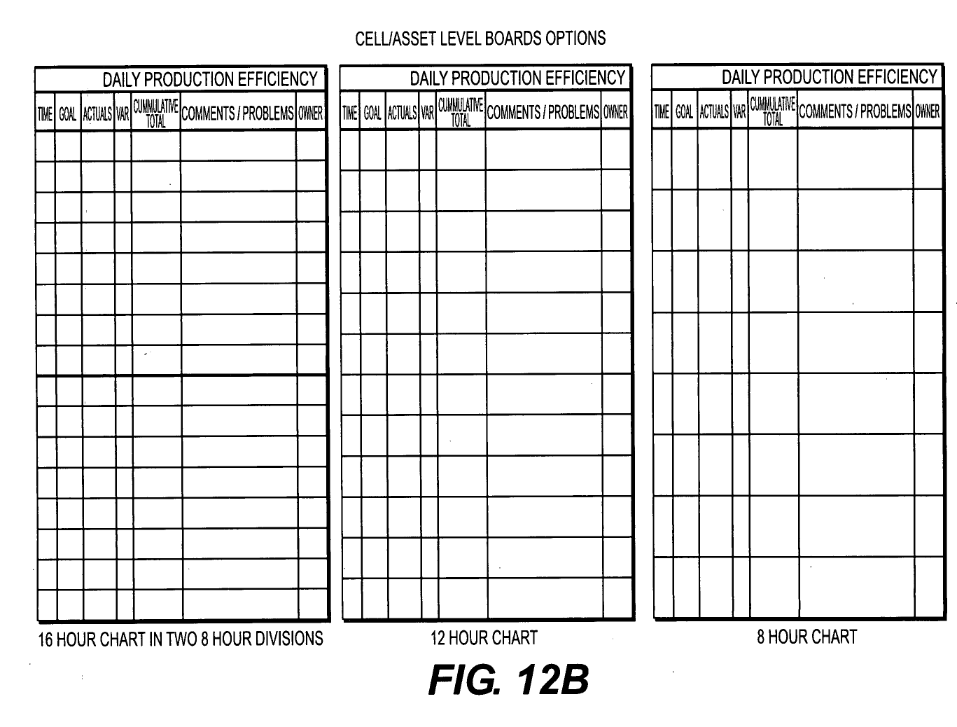

Referring to FIG. 12, cell display 1200 may differ from facility display 800, group display 900, and area display 1100 in one or more respects. Cell display 1200 affords the opportunity for direct interaction between a team member of that cell 124, who may be responsible for updating the metrics 700 (see FIG. 1b) on cell display 1200, and the supporting members of that cell 124, often through Process Improvement Dialogues, discussed in more detail below. Cell display 1200 may display the current production status of that cell 124 and document corresponding production issues that arise. Cell display 1200 may be a freestanding structure or a structure suited for hanging or adhering to a flat surface, such a wall. Cell display 1200 may be any reasonable size, but may be three feet high by four feet long. Alternatively, a cell display may be produced for smaller areas and may be sized approximately 17 inches high by 22 inches long, or 600 mm high by 800 mm long. These alternatives may comprise a laminate structure. Cell display 1200 may use dry-erase markers for written communications and may include trays and other accessories to store and access additional materials. In another embodiment, cell display 1200 may be made available to cell 124 via a general-purpose computer.

As shown in FIG. 12, cell display 1200 may generally provide a visual status of the daily production efficiency of the cell 124 and may be titled as such, using, for example, a title 1202, “Daily Production Efficiency.” Cell display 1200 may be divided into discrete sections, such as, for example, nine sections.

In one embodiment, a first section 1204, Time, may be a generally columnar region for displaying each increment of production shift time for the team members of cell 124. More specifically, cell display 1200 may encompass a 24-hour period in, for example, two twelve-hour or three eight-hour shifts, as shown in FIG. 12a. Alternatively, cell display 1200 may include a 16-hour period in two eight-hour divisions, a single 12-hour period, or a single eight-hour period, as shown in FIG. 12b. Each shift may be further subdivided into each incremental hour of that shift, as represented by shift line 1206, as shown in FIG. 12. A section manager may enter a time, for example, by the hour, within an individual time cell 1208, for which the remaining data in cell display 1200 may correspond. Time may be entered each hour or at other suitable times within a work shift, for example, 7:00 AM, 8:00 AM, and so forth.

A second section 1210, Goal, may include a goal for cell 124 that has been established or pre-determined for production for the time increment in the adjacent time cell 1208. Such a goal may be input by the section manager in goal cell 1212 and may include a quantitative value of product to be completed or assembled, although any production goal acceptable for the work of that cell 124 may be input. Specifically, such a goal may be, for example, 60 tack welds, or 20 brake assemblies, etc. Alternatively, for products with a longer production time, the goal may be expressed as a percentage of completion for the time increment of first section 1204, Time.

A third section 1214, Actuals, may include the actual production output for cell 124 based on the production within the time increment initiated at the time referenced in time cell 1208. This actual output will be entered in actual cell 1216 prior to the subsequent time increment to be input in first section 1204 and will be stated in the identical units of measure as in goal cell 1212.

A fourth section 1218, Var, represents the variance between the value entered in goal cell 1212 and the value entered in actual cell 1216. The value entered in variance cell 1220 may be in any form desired by the members of cell 124, for example, a negative value may represent that the actual production for that time increment was less than the production goal, although variations are possible. This value within variance cell 1220 may reveal the capacity and efficiency of cell 124 in relation to its established production goals.

A fifth section 1222, Cumulative Total, may represent a time-accumulated total of the output production of cell 124 (as shown in actual cells 1216) within accumulation cells 1224. Alternatively, section 1222 may represent a time-accumulated total of the variance within variance cells 1220. This time-accumulated total may accumulate through a particular shift or through an entire 24-hour period.

A sixth section 1226, Comments/Problems, may include comment cells 1228 for detailing comments regarding events occurring within the time increment of first section 1204. More specifically, sixth section 1226 may focus comments concerning the quantitative value within fourth section 1218, Var. For example, if actual cell 1216 shows that the actual production was less than the production goal within goal cell 1212 (as displayed in variance cell 1220), comment cells 1228 may detail an explanation or reason, for example, a particular issue with a production tool or material supply. Sixth section 1226, Comments/Problems, as a result facilitates dialogs at the level of cell 124, as will be further explained below. The parameters of the information that may be conveyed within comment cells 1228 may be flexible, such that any comment providing information regarding operations or production of that cell 124 may be appropriate.

A seventh section 1230, Owner, may provide spaces for initials or other identifying marks of a team member of cell 124 within owner cells 1232. For continuity and to provide a first-level accountable individual who may provide additional information, this team member may be the individual who generated the preceding comments and notations in sections 1204, 1210, 1214, 1218, 1222, and 1226, although more than one team member may provide notations and comments in any given shift. The first seven sections may stand alone as an alternative version of cell display 1200, standing approximately three feet high by 30 inches long.

An eighth section 1234 may provide a visual aid to performance with respect to the critical success factors 190 chosen by organization 100. Section 1234 may be similar to section 810 of facility display 800. As shown in the embodiment of FIG. 12, critical success factors 192-198 (People, Quality, Velocity, and Cost) are exhibited by a factor name 1236 generally, or specifically, for example, such as 1236a, 1236b, 1236c, and 1236d, which may be displayed vertically in section 1234. As with metric graph 701 (as shown in FIG. 7), each factor name 1236 may include a symbol 1238 generally, or specifically, for example, such as 1238a, 1238b, 1238c, and 1238d, which may be one of the four symbols (cross, star, arrow, or circle) corresponding to one of critical success factors 190 identified by factor name 1236, as previously described. In FIG. 12, for example, symbol 1238a, in the form of a cross, represents critical success factor 192, People.

Each factor name 1236/symbol 1238 may include a corresponding internal table 1240 generally, or specifically, for example, such as 1240a, 1240b, 1240c, and 1240d. Table 1240 may be numbered, with each number 1242 generally, or specifically, for example, such as 1242a, 1242b, 1242c, and 1242d, representing a day of a specified time period, such as a month, with a particular metric being tracked within, for example, table 1240a for the corresponding critical success factor 192, People, such that each number 1242a within table 1240a serves as a visual indicator of that particular metric, specifically the trend of that metric over time. A number 1242a may be colored green, yellow, or red within table 1240a to indicate the relative status of the single associated metric, with the color scheme representing metric states in a manner previously described for displays 800-1100. For example, if the particular metric chosen for critical success factor 192, People, represents the number of injuries occurring within cell 124, a number 1242a colored green may represent an injury-free day, while a red number 1242a may represent an injury. In this manner, anyone may be able to quickly glimpse the status of the metrics associated with the corresponding critical success factor.

A chart 1244 within cell display 1200 may offer additional visual guidance of the status of cell 124. As shown in FIG. 12, chart 1244 may effectively serve as a bar chart, with the horizontal component 1246 representing a period of time, for example, hours or days of a month. The vertical component 1248 of chart 1244 may consists of a measured quantity of a particular metric with each chart cell 1250 representing a single unit of the metric. Other variations are, of course, possible. As a specific example, chart 1244 adjacent critical success factor 194, Quality, may describe a particular metric corresponding to the number of part defects occurring within cell 124 over a particular month.

In addition, cell display 1200 may include accessories such as a separate writing surface, an area for employee suggestions, or an area for document or other storage. In another embodiment, input options for employee suggestions may be made possible via a general-purpose computer. An alternative cell display 1200, without chart 1244, may be used and may be approximately three feet in height and three feet long. As noted above, in another embodiment, cell display 1200 may be made available via a general-purpose computer.

5) Executive Scorecard

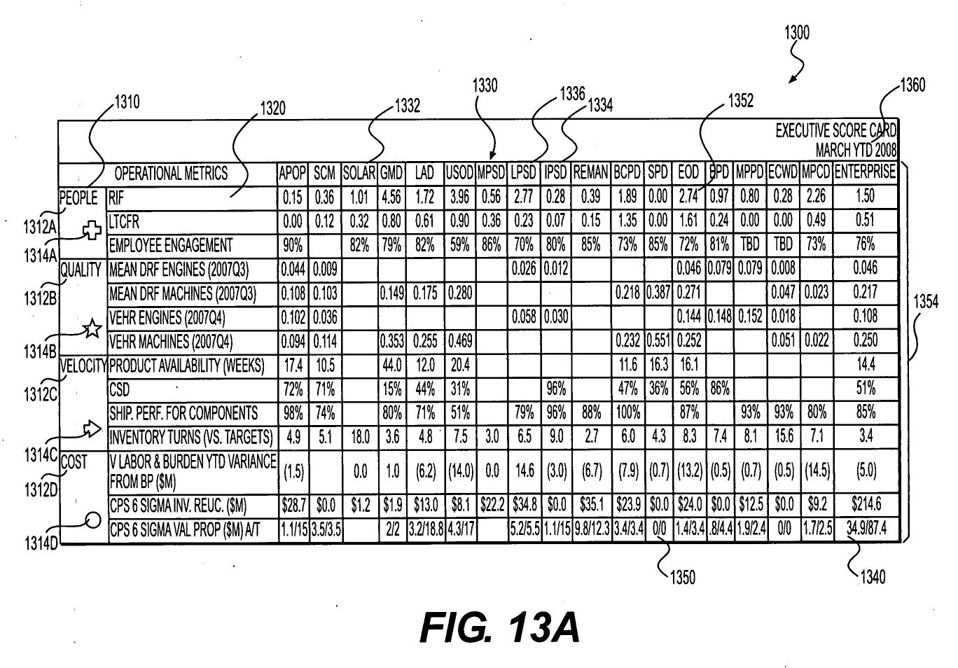

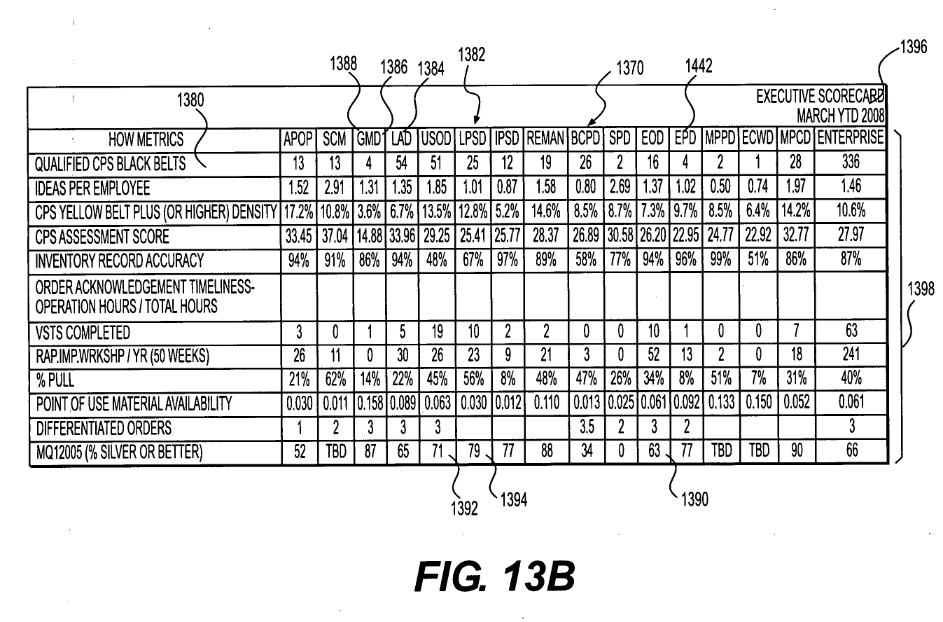

Referring to FIGS. 13a and 13b, an executive scorecard may be created periodically based on specified divisional metrics, i.e., representing metrics 700 at the level of divisions 112. These divisional metrics may contain operating metrics, which detail operational aspects of the business of organization 100, such as Committed Ship Date, Recordable Injury Frequency, and Parts per Million, previously described, and “how” metrics, which are metrics specifically tailored to track how well organization 100 is progressing with implementation of organizational production system 150. For example, Ideas per Employee and Rapid Improvement Workshops Completed may be classified as “how” metrics.

Referring to FIG. 13a, operational executive scorecard 1300 may be a one-board system used to provide visual status of the performance of the overall organization 100. Operational executive scorecard 1300 may generally be divided into three discrete sections. In one embodiment, a first section 1310 may be a generally columnar region in which one or more critical success factors 190 may be indicated. As shown in the embodiment of FIG. 13a, critical success factors 192-198 (People, Quality, Velocity, and Cost) are exhibited by a factor name 1312 generally, or specifically, for example, such as 1312a, 1312b, 1312c, and 1312d. As with metric graph 701 (as shown in FIG. 7), each factor name 1312 may include a symbol 1314 generally, or specifically, for example, such as 1314a, 1314b, 1314c, and 1314d, which may be one of the four symbols (cross, star, arrow, or circle) corresponding to one of critical success factors 190 identified by factor name 1312, as previously described.

A second section 1320 of operational executive scorecard 1300 may identify the titles of one or more operational metrics associated with each critical success factor 192-198. In one embodiment, section 1320 may be adjacent to section 1310 and may display a list specifically identifying the one or more metrics 700 that may be the focus at the executive level. As shown in FIG. 13a, certain metrics may correspond to specific critical success factors 190.

A third section 1330 of operational executive scorecard 1300 includes a division row 1332, which may detail one or more divisions 112 to which the operational metrics named within section 1320 correspond. For example, division row 1332 may be divided into name cells 1334, each of which contains an identifying mark 1336 to indicate a specific division 112. As shown in FIG. 13a, identifying mark 1336 may contain a short name, acronym, or abbreviation to represent a specific division 112. Below division row 1332 may be a results matrix 1340. Results matrix 1340 may show a corresponding metric numerical value 1350 in a matrix cell 1352 for the specified time period displayed at date identifier 1360. Within results matrix 1340, any matrix cell 1352 may also serve as a visual indicator for that particular metric and division 112, specifically the trend of that metric over time. For example, a particular matrix cell 1352 may be colored green, yellow, or red to indicate the relative status of a corresponding metric, with the color scheme identical to that previously described for other displays.

A final section 1354, Enterprise, provides the previous information for each metric totaled for all divisions 112 of organization 100. In this manner, anyone at the executive level of organization 100 may be able to quickly ascertain the status of the divisions 112 within organization 100 based on the metrics.

In an alternative embodiment, operational executive scorecard 1300 may be made available via a general-purpose computer.

FIG. 13b shows an exemplary “how” executive scorecard 1370. “How” executive scorecard 1370 may be similar to operational executive scorecard 1300 in look and purpose, but may provide the executive level of organization 100 with information on the progress of organizational production system 150 itself. “How” executive scorecard 1370 may be divided into two discrete sections. A first section 1380 may identify the titles of one or more “how” metrics, as described above, displaying a list specifically identifying the one or more metrics 700 that may be the focus at the executive level. A second section 1382 may function identically to that of third section 1330 of operational executive scorecard 1300, and may include a division row 1384 detailing one or more divisions 112 to which the “how” metrics named within section 1380 correspond. For example, division row 1384 may be divided into name cells 1386, each of which may contain an identifying mark 1388 to indicate a specific division 112. As shown in FIG. 13b, identifying mark 1388 may contain a short name, acronym, or abbreviation to represent a specific division 112. Below division row 1384 may be a results matrix 1390. Results matrix 1390 may show a corresponding metric numerical value 1392 in a matrix cell 1394 for the specified time period displayed at date identifier 1396. Within results matrix 1390, any matrix cell 1394 may also serve as a visual indicator for that particular metric and division 112, specifically the trend of that metric over time. For example, a particular matrix cell 1394 may be colored green, yellow, or red to indicate the relative status of a corresponding metric, with the color scheme identical to that previously described for other displays. A final section 1398, Enterprise, provides the previous information for each metric totaled for all divisions 112 of organization 100. In this manner, anyone at the executive level of organization 100 may be able to quickly ascertain the status of the divisions 112 within organization 100 based on the metrics.

In an alternative embodiment, “how” executive scorecard 1370 may be made available via a general-purpose computer.

6) Metrics Cascade

One process goal of using metrics 700 may be to create a series of “cascaded metrics,” stemming from one of the principles of organization 100, specifically, principle 366, Align the Targets. Such a focus on deploying cascaded metrics with process targets throughout all levels of organization 100 may permit continuous monitoring of production progress of organization 100. Specifically, cascaded metrics may provide the ability to align from the executive level to the cell 124 level, allowing everyone within organization 100 a clear view of the targeted metrics. Cascaded metrics may also provide a focal point for the daily Process Improvement Dialogues that occur at the displays (described below). In addition, cascading of metrics may allow leaders within organization 100 the ability to move from facility to facility and immediately understand and directly compare performance among facilities 114. To facilitate this cascading of metrics, metric coordinators, as previously described, may initiate a process to assemble, or “roll up” metrics that are common to the displays. To do so, the quantitative elements of a metric need to be properly recorded.

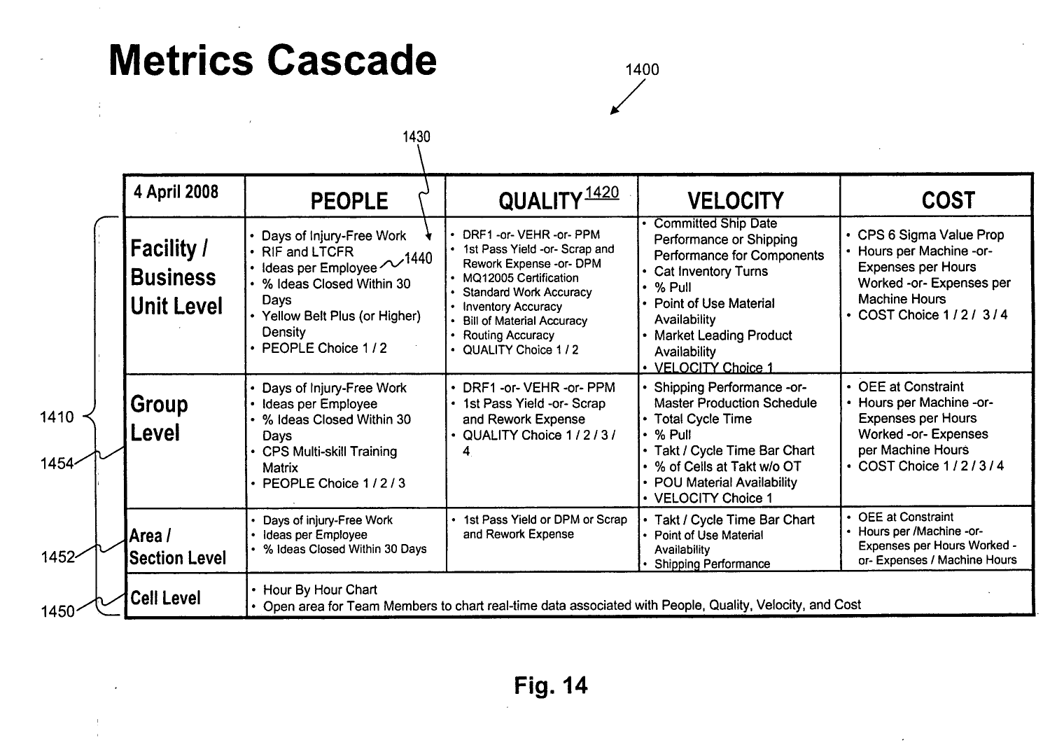

FIG. 14 depicts the cascading of certain metrics 700 through levels of organization 100, in which various metrics 700 may be aligned by critical success factors 190. As shown, FIG. 14 includes a chart 1400 with a first section 1410 indicating various levels within organization 100, for example, facility 114, group 120, area 122 and cell 124. A horizontal section 1420 in this embodiment includes the names of critical success factors 192-198 (People, Quality, Velocity, and Cost) (see FIG. 2a). Within the chart body 1430 is a listing of metrics 700 that may be displayed at each level. Metrics 700, identified by metric names 1440, for example, “Ideas per Employee,” that appear within chart body 1430 from area 122 to group 120 to the facility 114 level for a specific critical success factor 192-198 in horizontal section 1420 have therefore been rolled up through those specific levels for that critical success factor. Many other variations and additional metrics 700 may be cascaded as organization 100 desires. And, as an alternative embodiment, chart 1400 may be made available via a general-purpose computer.

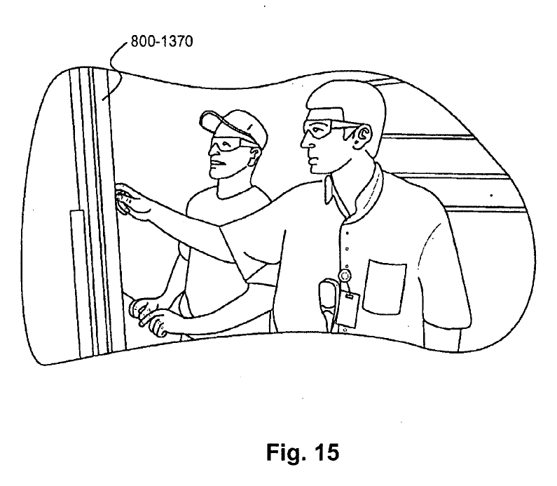

Specifically, at the level of cell 124, a team member may capture cell 124 metrics by each particular shift from cell display 1200. Referring to FIG. 15, cell level row 1450 may include one or more metrics 700 tracked in table 1240 or chart 1244 of cell display 1200 (as shown in FIG. 12). As some of these metrics 700 may roll up to the next level of area 122, an area 122 section manager may be responsible for capturing, recording, and rolling them to area displays 1100 from the particular cells 124. For example, if all members of cells 124 within an area 122 worked all shifts of a particular day without an injury (a metric associated with critical success factor 192, People), a “green” colored day would be recorded in number 1242a for table 1240a of critical success factor 192 in cell displays 1200 as well as in number cell 1118a of table 1116a of critical success factor 192 within area display 1100 for that particular day of the month. Once all of the metrics 700 for cell display 1200 are reported each day, area display 100 for that area's cells 124 may be updated. All cell 124 metrics targeted for roll up may be so reported and displayed.

Metrics 700 within area display 1100 also may collectively roll up to the next level on group display 900. For example, metrics 700 detailing ideas implemented per employee or days without lost time may roll up to the next level. Area level row 1452 of FIG. 14 shows examples of metrics 700 from area displays 1100 that may roll up to group displays 900 for each critical success factor 192-198. In the same manner, metrics 700 from all groups 120 of a facility 114 may be reported on facility display 800, as exemplified in group level row 1454 of FIG. 14, again for each critical success factor 192-198. In one embodiment, a particular facility 114 may physically exist across one or more buildings, in which case each building may choose to implement a building metric display that incorporates all of the reporting within that building. Metrics 700 that may be reported to facility display 800 or a building metric display may include metrics concerning ideas per employee, production yield, and expenses per hours worked, as a few examples. Facility metrics from facility display 800 may be directly reported to the division 112 level, or alternatively, to a business unit 113 level, which may then be reported to the division 112 level. As the division 112 and business unit 113 levels may not include separate displays, a facility display 800 may be used as needed. The metric activity at the division 112 and business unit 113 levels may consist of metrics consolidation for executive scorecards 1300, 1370. In an embodiment where information is available via a general-purpose computer, this information would be available via the computer or network of organization 100 or any of its subparts.

a) Process Improvement Dialogues

A feature of displays 800-1200 and executive scorecards 1300, 1370, is that they may facilitate a fact-based discussion, referred to herein as a Process Improvement Dialogue (PID). Such a discussion may focus on analyzing a particular process and an issue or problem that may currently exist within that process, and may be centered around critical success factors 190 (see FIG. 1b). PIDs may also provide for consistent coaching and feedback among organization 100 workers, and may reinforce accountability, trust, and a mindset that value is created in the work area. The discussion may be built around metrics 700 and goals that have been established and at how a particular area has progressed toward achieving those goals. As shown in FIG. 15, A PID may occur systematically through regular discussions at the facility display 800, group display 900, group tower 1000, area display 1100, cell display 1200, and at the executive scorecards 1300, 1370. PIDs may occur at these displays and/or scorecards to ensure visibility of metrics 700 during the discussion, more easily identify issues, take corrective action and track progress of a resolution, and engage in root cause problem solving at the lowest level within organization 100 possible. Alternatively, a PID may occur via a general-purpose computer, which provides similar benefits. PIDs may include finding a root cause of a problem and establishing actions to correct problems. Root cause problem solving techniques are commonly known in the art and need not be further detailed.

A PID may focus on the process, as opposed to organization personnel. The output of such a dialogue may be a Continuous Improvement card that initiates a Continuous Improvement process (further described in a later section) or a Six Sigma project, although the output focus in general may be an initiation of a root cause problem correction.

A PID may include evaluating and understanding current trends and performance gaps of one or more metrics 700 and formulating action plans with accountability and timelines. For example, a PID may occur at a facility 114 level in front of facility display 800, wherein a facility manager may conduct the PID periodically or when desired for other purposes, for example, during particular visits by executive-level personnel or outside guests. During this PID, the facility manager may review the facility's monthly performance, review progress of any current initiatives, review trends in performance and gaps from target levels in metrics 700 for each of the critical success factors 190, and may agree on project plans or prioritize those plans.

A group manager may conduct daily PIDs in front of group display 900, at which the group manager may review trends in performance and gaps from target levels in metrics 700 for each of the critical success factors 190, root cause problem solve issues previously unresolved, review anticipated needs or outstanding action items, and may pass along communications.

A section manager of an area 122 may likewise conduct daily PIDs in front of an area display 1100. As the area 122 level is further removed from the executive and facility 114 levels, the section manager may also conduct PIDs in direct response to specific production issues. PIDs, while occurring between a manager and that manager's respective facility, group, or area members, may also occur between the manager of these levels and that manager's supervisor for the same purpose.

At the level of cell 124, the team leader may conduct daily dialogues at cell display 1200 with the cell team members, but, as this is the lowest and most direct level of the production team, may lead additional PIDs as needed in response to specific production issues, In an exemplary cell 124 PID, the team leader may discuss a plurality of topics, For example, for each of the critical success factors 190 the manager may review trends in performance metrics and any issues previously discussed. The manager may also recognize positive performances and encourage team members to propose and track ideas for continuous improvement. A PID may be also be facilitated at the executive scorecard level by an organization 100 executive during a pre-determined periodic meeting, such as a monthly meeting.

Of course, alternatively, PIDs at any level may also occur electronically via a general-purpose computer.

2. Value Stream Transformations

A Value Stream Transformation (VST) process (process 668 of FIG. 6) may be conducted by organization 100. As noted previously, a value stream 119 is a group of linked value-added processes, wherein a “process” refers to a series of two or more steps that may transform one or more inputs into an output to meet the need(s) of an external or internal customer. Some of the more common issues occurring at the various steps of a value stream 119 and addressed by a VST may include: the presence of waste, in one or more of the categories of waste described earlier (see FIG. 2b); fluctuations in work, which may be due to inefficient production scheduling; or unnecessary burdens placed on workers or equipment, exhibited through risks to personnel, poor ergonomic design, unclear specifications, or inadequate tooling. A VST involves analyzing the interactions of each step in any particular process and making changes designed to improve one or more aspects of those interactions, such that the value stream 119 is improved as a whole. A VST may be initiated to improve target measures within critical success factors 190 (see FIG. 1b). Some of these improvement targets may include, for example, improvements in well being of personnel, as may be reflected in the metric Recordable Injury Frequency (as shown in FIG. 7). Other improvements may be in the areas of internal quality, inventory, increased capacity, reduction in labor, or reduction in material costs.

The VST process may enable principle 352, Put Safety First (as shown in FIG. 3 along with other principles noted below), as the process may focus on safety within a value stream 119, including specific requirements for safety improvements. Principle 340, Chase Waste, may be built into the VST process through, for example, documentation of excess inventory on the value stream map, described below. In addition, value stream mapping may capture the current state of the value stream 119 and develop a future state to Make Value Flow, i.e., principle 344. The VST process may focus on establishing Pull, principle 342, in a value stream 119 to connect processes capable of flow. As the VST process may include PIDs in the presence of metric displays 800-1200 or executive scorecards, 1300, 1370, this may facilitate principle 366, Align the Targets, principle 362, Actively Listen, and principle 364, Make It Visual. Because the VST process may include development of standard work, it may enable principle 346, Drive Standard Work. The Rapid Improvement Workshop (RIW) process within the VST process may exemplify principle 368, Act Decisively, while in continuously searching to remove non-value-added process steps, the VST process may enable principle 354, Take the Customer's View, along with principle 340, Chase Waste. In addition, as the Value Stream Transformation Project and RIW methodology may include training for organization personnel, the VST process may exemplify principle 360, Develop People. Principle 356, Go, See, Act, may be an element of value stream mapping, RIW, and VST project methodology. In addition, the cultural transformation inherent in the VST process may exemplify principle 358, Stop to Fix, and the RIW and VST methodologies may inherently include principle 348, Even the Load and principle 350, Validate Our Processes.

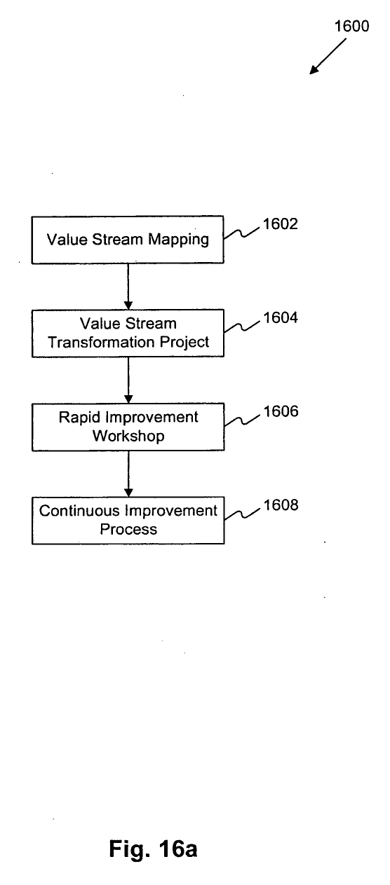

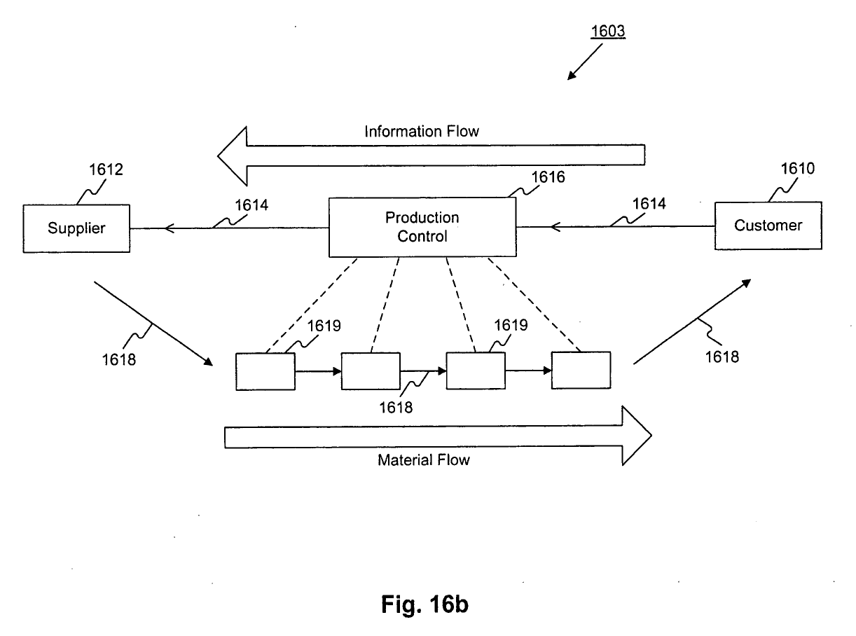

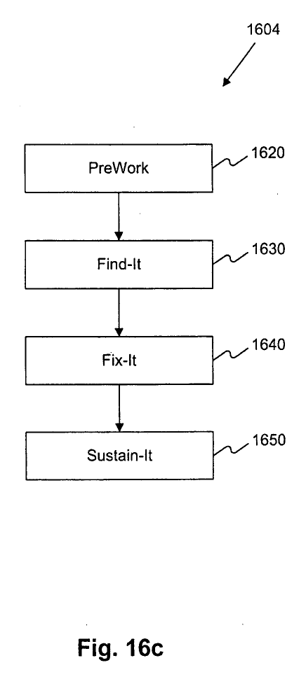

As shown in FIG. 16a, a VST process 1600 may include four defined operations including value stream mapping 1602, a Value Stream Transformation (VST) Project 1604, RIW 1606, and a Continuous Improvement process 1608. To track value stream transformation activities, activities in a value stream 119, including VST projects 1604, RIWs 1606, and other projects, may be aligned to specific value streams 119 in a software database program, such as, for example, a database program for maintaining Six Sigma projects.

Referring to FIG. 16b, a value stream map 1603 is a visual tool representing the process steps, material and information flow, and productions facts, i.e., opportunities to eliminate waste and improve, of value stream 119. While not a physical layout of a production area, value stream map 1603 consists of symbols used to indicate interactions of people, material, information, space, and equipment. Value stream mapping 1602 captures both visible and obvious characteristics of value stream 119, but may be of most value in identifying difficult to observe characteristics of value stream 119, for example, information flow parameters, an interruption in process flow, excess motion, or transportation inefficiencies. The production of a current state value stream map 1603, which reflects the existing condition of value stream 119, may then be used for focused discussions on a desired future state of value stream 119 and the production of a future state value stream map 1603, which reflects optimal and continuous flow, without waste, and may be based on anticipated customer demand. A section manager may be assigned responsibility for maintaining both the current and future state value stream maps 1603 for the particular value stream 119 under his supervision. In one embodiment, value stream maps 1603 may be made available via a general-practice computer.

Referring to FIG. 16b, an exemplary value stream map 1603 is shown. Such a value stream map 1603 shows the interrelationships between customers, suppliers, information, and material flow in an order-to-delivery process. As shown in FIG. 16b, customer information from customer 1610 may be located in an upper right area of value stream map 1603 while supplier information from supplier 1612 may be located in an upper left area of value stream map 1603. Information flow 1614, is shown directed from customer 1610 through an internal production control 1616 to supplier 1612. This information may consist of specific customer demand, additional triggers for production, production schedules, or supplier communications, for example. Material flow 1618 may start from supplier 1612 and move through one or more production process stages 1619, ending as a finished product delivered to customer 1610. In any given value stream 119, customer 1610 and supplier 1612 may be relative to the scope of the particular value stream map 1603. For example, customer 1610 may be an immediate downstream recipient within organization 100 of a good in a particular state, while supplier 1612 may be an upstream process internal to organization 100. The positions of the various features of value stream map 1603 are exemplary only and any or all features may be placed at the discretion of the creator of the map. Value stream map 1603 may be initially developed by hand on the production floor through visual assessment and communications with production team members and may then be later transferred into an electronic file using a value stream mapping tool created by organization 100. The process of creating value stream maps is well known in the art as a “Lean” manufacturing technique and need not be further detailed.

As referenced above, a VST project 1604 may be based on Six-Sigma DMAIC (Define, Measure, Analyze, Improve, and Control) methodology. A primary goal of VST project 1604 may be sustainable change in a value stream 119, with goals set based on current performance, projected customer demand, and anticipated business conditions. VST project 1604 duration may typically be 12 to 16 weeks and may include four phases, as shown in FIG. 16c: phase 1620, Prework; phase 1630, Find-It; phase 1640, Fix-It; and phase 1650, Sustain-It.

Phase 1620, Prework, may involve team and project planning and current state data collection and more specifically concern preparation for VST project 1604. A project leader of VST project 1604 may refine a project charter, consisting of the scope and goals of the project, with respect to specific objectives related to critical success factors 190. Organization 100 may develop a web-based or other computer application designed and maintained by organization 100, with security or other parameters, containing templates for VST project documents, such as the charter. A VST team may in addition gather operational and organizational data and complete a cultural assessment in preparation for phase 1630, Find-It. With VST project 1604 refined by the project leader, the resources and personnel needed for implementation may be ascertained.

VST project 1604 may utilize various organization 100 personnel for specific roles on the project. For example, a VST project sponsor may ensure the participation of certain subject matter experts in the project. A VST project leader may act as an overall team leader to provide planning, guidance, and expertise; may be responsible for overall VST project management; and may be responsible for Six Sigma aspects of the VST project. The VST project leader may also review and customize a project plan template. Depending on a VST project's scope, a VST project leader may be assigned to activities related to each of subsystems 300 (as shown in FIG. 3). In addition, VST project 1604 may have a training coordinator for verifying, tracking, and coordinating any training, for example, on VST project methodology or use of tools; a change master for creating and coordinating a change plan and providing plan awareness training; and a communications coordinator for supporting project communications. A production team member and section manager may participate as fully engaged members of the VST project team. In addition, a health and safety subject matter expert may conduct safety risk analyses and provide advice on safety issues, and a quality subject matter expert may provide assistance developing quality improvements and with quality planning. Other subject matter experts may be utilized for specific data collection or additional participation. A change master, communications coordinator, and training coordinator may work with the project team to develop one or more plans. For example, a communications plan may be developed to disseminate information about VST project 1604 to production team members and other VST teams. A learning plan may be developed to cover any topics related to the production system or job specific training for production team members and cross-training for production team leads. A reinforcement plan may be developed from a current reinforcement plan in effect for facility 114.

Phase 1630, Find-It, may include analysis, development of value stream maps 1603 for a current and future state, and a multi-generational process plan (MGPP). In the Find-It phase of VST project 1604, the VST project team may focus on documenting the current state, analyzing the current performance, and designing the future state of value stream 119 in an effort to ensure value stream 119 performs to the critical success factor goals set by organization 100. A safety and ergonomic subject matter expert may conduct a safety and ergonomic assessment of value stream 119. Additional quantitative safety and ergonomic analysis tools may be necessary depending on the assessment results. An operating system sub-team may complete a current state analysis and develop a current state value stream map that identifies waste. A future state value stream map may be developed for a specific time period based on customer demand information. A cultural system sub-team may develop plans for communication, recognition, and tools implementation and training. This team may also provide input to the specifics of the MGPP after analyzing the results of the value stream cultural assessment. A management system sub-team may be required to develop a Management System Gap Analysis, which may serve as an assessment of how well principle 362, Actively Listen, principle 364, Make It Visual, principle 366, Align the Targets, and principle 368, Act Decisively, are embedded in value stream 119 (see FIG. 3). Principle 362, Actively Listen, may be adhered to through conducting Process Improvement Dialogues at all levels, demonstrating the value of people's ideas by quickly implementing them. Principle 364, Make It Visual, may be followed through developing and maintaining the visual workplace to minimize hidden issues. Principle 366, Align the Targets, may be enabled through the use of cascaded metrics across the value chain aligned to support critical success factors 190. Principle 368, Act Decisively, may be exemplified through decision making by consensus, thoroughly considering all options, and implementing with a proper sense of urgency. To prepare such a gap analysis, the Management System sub-team may review management practices, organizational structure, visual workplace elements, Process Improvement Dialogues, the Continuous Improvement process of value stream 119, and the metrics cascade, among other factors.

The MGPP, as noted, may be an action plan detailing specific activities to be completed over a specified time period to achieve the VST project specific goals. Goals may be set with input from the Safety and Ergonomics Assessment and Quality Review. Examples of activities cited in the MGPP may include Rapid Improvement Workshops, Six Sigma VST-enabled projects, and other Six Sigma projects. The MGPP may be structured to address issues including: safety and ergonomics, in which all safety issues are resolved that may have come to light during the Find-It phase, along with any “high” rated ergonomic issues that may be mitigated to “low/medium” risk; quality, in particular stabilizing the value stream 119, fail proofing certain processes; and elimination of any obvious wastes from value stream 119. Stability in the context of value stream 119 refers to the capability to produce consistent results over time, i.e., ensuring a safe production environment, ensuring a well-trained workforce, demonstrating process capability for certain processes, following standardized and documented processes, keeping equipment capable and available for production, making materials available at the right time, right place, and in the correct quantities, and meeting Takt time (which represents a maximum time allowed to produce a product to meet demand) or customer demand consistently, for example. In this manner, stability of value stream 119 encompasses subsystems 300 of the production system. Principle 352, Put Safety First; principle 340, Chase Waste; principle 346, Drive Standard Work; principle 362, Actively Listen; principle 364, Make It Visual; principle 344, Make Value Flow; principle 366, Align the Targets; and principle 360, Develop People correlate with the establishment of stability in value stream 119 (see FIG. 3).

Phase 1640, Fix-It, may include work to complete transformational activities of the first generation of the MGPP. The Fix-It phase may involve work on the production floor, in which coaching, planning, organizing, and testing may take place. The first transformation project in a value stream 119 may concern establishing stability. Process Improvement Dialogues, metrics cascade, and metrics displays, for example, along with Continuous Improvement concepts and root cause corrective action processes may be implemented across value stream 119. A second transformation project for the same value stream may include some element of stability, but the focus may be shifted to establishing flow, which involves connecting independently capable and stable processes in a value stream; pull, which is production based on goods consumed by customer demand; and leveling, which concerns production balanced for mix and volume. Activities scoped within a process area may be addressed with the use of a Rapid Improvement Workshop, described below, Implementation of tools and techniques such as metrics cascade and metrics displays may be addressed through Six Sigma VST-enabled projects, while solutions for some issues may be developed and implemented immediately upon discovery.

Phase 1650, Sustain-It, may encompass ongoing transformational activities of subsequent generations of the MGPP and may engage organization 100 in efforts to continuously improve value stream 119. The Sustain-It phase may follow the initial focused transformation activity supported by the VST project team. The value stream process owner may continue to lead organization 100 personnel toward completion of the next generation of projects and the next level of critical success factor performance. Additional Six Sigma projects and continuous tracking of critical success factor metrics against goals may occur during the Sustain-It phase.

In one embodiment, the phases of VST project 1604 may be coordinated via a general-purpose computer.

a. Rapid Improvement Workshops

A Rapid Improvement Workshop (RIW) 1606, from FIG. 16a, provides for improvement within a specific work area or process, in one embodiment, using a DMAIC (Define, Measure, Analyze, Improve, and Control) methodology. RIW 1606 may be predicated on value stream mapping, management system gap analysis, and additional assessments, and may be identified and prioritized in phase 1630, Find-It, of VST Project 1604 (shown in FIG. 16c) based, in part, on a future state value stream map. RIW 1606 may focus on a single physical area and process and may be scoped to deliver results in a fixed number of days, whereas VST project 1604 may focus on transforming an entire value stream 119 over a longer period of time. RIW 1606 may last approximately nine weeks and is also composed of a cross-functional team of selectively chosen organization 100 personnel that moves to quickly isolate root causes of problems and implement solutions. Safety and quality RIWs may have the highest priority.

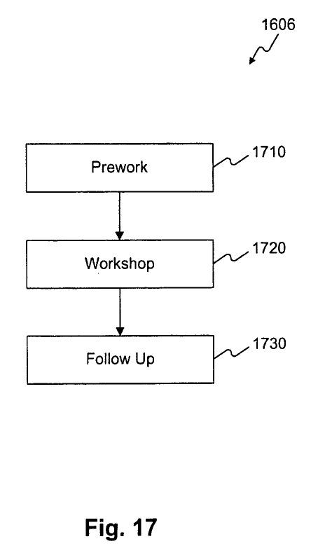

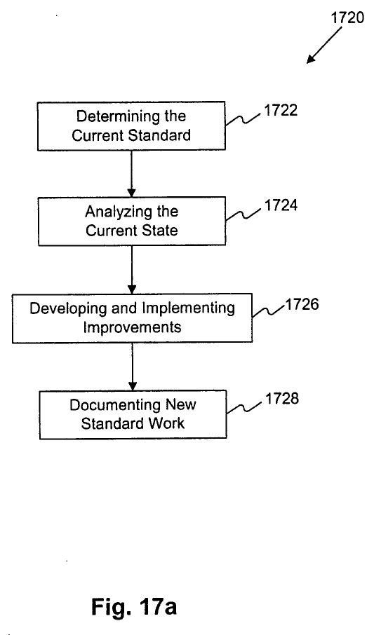

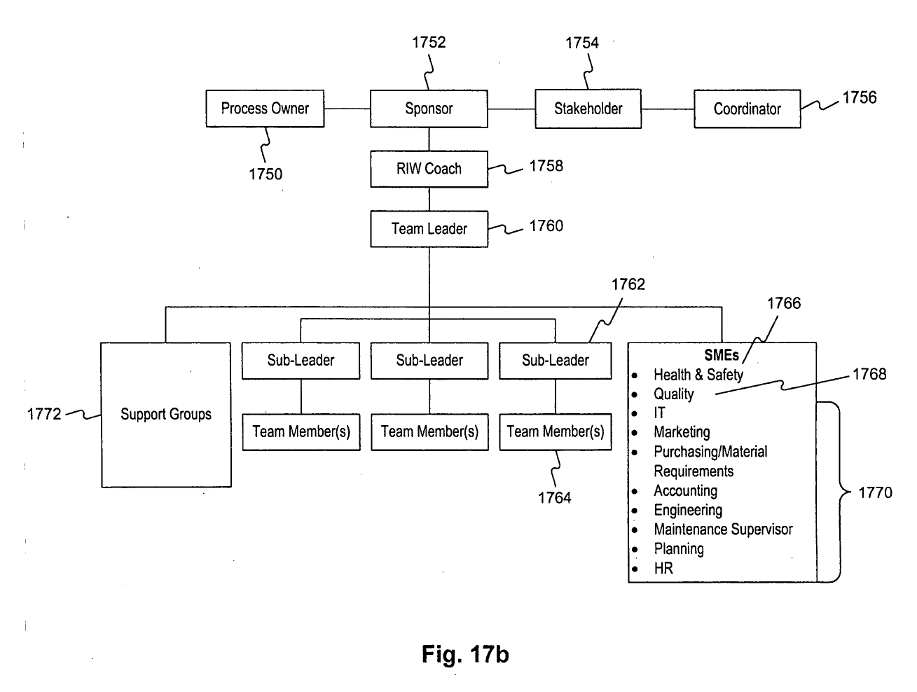

As shown in FIG. 17, RIW 1606 may include three distinct phases consisting of phase 1710, Prework, phase 1720, Workshop, and phase 1730, Follow Up. Successive RIWs may need to be conducted in the same area over a period of time in order to achieve the level of performance desired, as outlined in a future state value stream map. For example, an initial RIW in a production area may have a particular goal of the development of standard work. At some later time, a second RIW may be scheduled in the same production area to improve the layout of the area and refine standard work documents as a result of continuous improvement ideas submitted by production team members in the interim. A RIW may itself have one or more specific goals. Such exemplary goals may include implementing a minimum number of safety and quality ideas, providing significant operational impact, building local capacity, promoting cultural change, achieving workshop-specific stretch targets in a minimal amount of time, and achieving a Six Sigma Value monetary targets.

RIW 1606 may be based on Six Sigma methodologies and may be chartered in a computer program designed or implemented by organization 100, such as, for example, the previously referenced database program for maintaining Six Sigma projects. An initial charter or plan for RIW 1606 may be created and entered into a general-purpose computer.

Phase 1710, Prework, starts four weeks or more before the scheduled RIW Workshop. The Prework phase may include the steps of preparing/refining the project plan, specifying the goals of the project, identifying and notifying team members and selecting sub-team leaders, gathering and analyzing performance data, obtaining support commitments from support organizations to provide assistance during and after the workshop, communicating the RIW schedule to the production team members and leads and other pertinent personnel, and setting up the work area for phase 1720, Workshop.

Phase 1720, Workshop, may include various improvement related activities carried out by project team members. In one embodiment, a RIW Workshop phase timeline for making operational changes is typically five days, such that all training and reporting should be accomplished within that period. But, in other embodiments, a RIW Workshop phase may include fewer or more days. Phase 1720 may be aligned with Six Sigma DMAIC methodology utilizing a four stage procedure, as shown in FIG. 17a. The four stages include stage 1722, Determining the Current Standard, stage 1724, Analyzing the Current State, stage 1726, Developing and Implementing Improvements, and stage 1728, Documenting New Standard Work.

Stage 1722, Determining the Current Standard, may include completing a safety learning and assessment process, creating or updating a value stream map 1603 of the target area and identifying wastes, calculating Takt time (previously described), conducting time observations, developing a Takt time or cycle time bar chart, reviewing current standardized work documents, and starting a RIP newspaper and work board.

Stage 1724, Analyzing the Current State, may include performing a Safety and Ergonomic Assessment, conducting one or more waste walks, and engaging in root cause problem solving using Six Sigma tools.

Stage 1726, Developing and Implementing Improvements, may include selecting solutions by a pre-determined time, for example, on day three of a five day RIW Workshop; designing a new process and workstation layout; designing improvements to address safety and ergonomic issues in the area; determining the changes required to address quality issues in the area; evaluating process change risk; implementing the solutions developed; and posting progress visually, for example, on a work board.

Stage 1728, Documenting New Standard Work, may include completing implementation of solutions and documenting the new standardized work. Generally, safety is the initial focus of the documentation, although other parameters, such as quality, may be additionally emphasized.

Referring to FIG. 17, Phase 1730, Follow Up, is designed to ensure that all project documentation is completed and all remaining tasks on the RIW newspaper have been implemented. Phase 1730 may last for an extended time, for example, 30 days, and may include the steps of completing a RIW executive summary following the workshop; ensuring completion of all identified activities; assisting a project leader with acquiring resources and removing any obstacles to successful completion; holding weekly meetings to keep the sponsor, stakeholders (described below), and management informed of progress; and preparing and presenting a final status report to the project sponsor and stakeholders. At the end of the Follow Up phase, the project may be handed over to the process owner, final RIW information may be posted, and the results communicated.

RIW 1606 may include several process team members (some of whom have been previously identified), as shown in FIG. 17b. For example, a process owner 1750 may be responsible for implementation and control of the RIW project. A sponsor 1752 may scope the initial project and enter related information into the computer application, ensure management support of RIW 1606, ensure availability of support group participants, and identify significant operational goals. A stakeholder 1754 may provide input and direction during the Prework, Workshop, and Follow Up phases (see FIG. 17). A coordinator 1756 may develop facility RIW plans, line up resources, ensure the safety and effectiveness of team members, and may also manage schedules for multiple RIW teams. A RIW coach 1758 may provide RIW expertise, production system expertise, and help the RIW team align itself to the guiding principles of organization 100. A team leader 1760 may lead the RIW team, manage the project, be accountable for completion of phase 1730, Follow Up, assign sub-team leaders as necessary and formulate sub-teams for specific tasks. Team leader 1760 may also assign responsibility for completion of standard RIW deliverables (e.g., value stream map 1603), and value-added and non-value-added analysis. Sub-team leaders 1762 may spend a majority of time on the production floor and may be accountable for completion of assigned tasks, be responsible for monitoring their respective team members, and be responsible for keeping the RIW newspaper up to date with sub-team information. Team members 1764 may contribute information about the current state of a production area, contribute continuous improvement ideas, implement improvements, and train production team members from other production areas. A Health & Safety subject matter expert (SME) 1766 may conduct a health and safety assessment in the RIW area, may validate all risk reduction activities completed as part of phase 1730, may provide safety trends and history of the area within the scope of RIW 1606, and may provide expert advice on resolving health, safety, and ergonomic issues. A Quality SME 1768 may help develop quality improvements. Other SMEs 1770, including information technology, marketing, purchasing, accounting, engineering, maintenance supervisor, planning, and human resources may also be utilized. Support groups 1772 may provide resources during phases 1720 and 1730.

RIW 1606, in particular, phase 1720, Workshop, may utilize a dedicated area in which to perform the RIW methodology that supports learning, team building, and brainstorming activities. In one embodiment, this team work area may be located close to the physical location of the production area for the convenience of the team and efficiency. The team work area may also include a RIW work board used for posting information showing the progress of sub-teams, including results of assessments and surveys and value stream maps, or any other information useful for the RIW team. Alternatively, the team work area may include a general-purpose computer for posting information, either at the team work area or via a network to all employees.

With respect to FIGS. 17 and 17a, a typical goal of RIW 1606 may be to complete all Workshop items detailed on an RIW newspaper, although resolution of one or more issues may extend beyond the exemplary five day period. RIW newspaper items with lead times longer than a specified time, for example, 30 days, may be transferred to a Continuous Improvement card or Six Sigma project. A RIW newspaper may provide a channel for communicating and a resource for organizing RPW team activities. The RIW newspaper may detail what actions are to be done, by whom, and when, tracks the progress of the RIW team, facilitates follow up, and assists the team in developing a detailed action plan. The RIW team may use the RIW newspaper to track all ideas and issues identified during the workshop. All actions that will be undertaken during phase 1720, Workshop, and any actions that may carry over to the phase 1730, Follow Up, may be recorded on the RIW newspaper. The RIW newspaper may be displayed in the team work area in a workable manner, for example, on a flip chart.

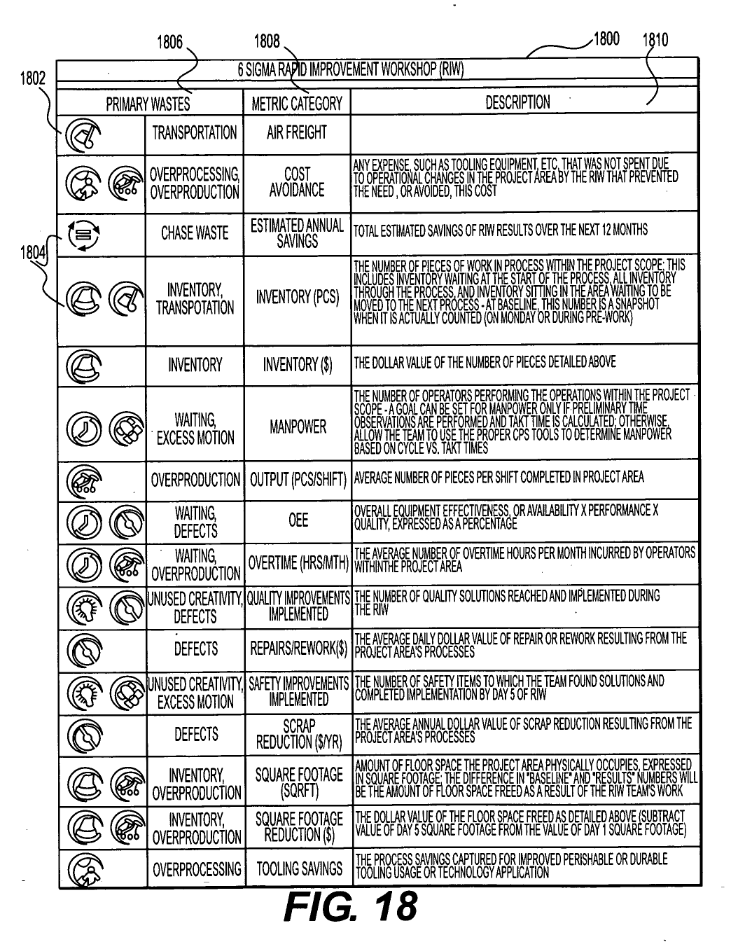

Referring to FIG. 18, a RIW project may also track and report financial benefits. As shown in FIG. 18, a RIW chart 1800 may detail an alignment of the eight wastes (see FIG. 2b), with a metric category that captures savings due to waste reduction activities during RIW 1606. In this embodiment, RIW chart 1800 may include a first column 1802 showing symbols 1804 corresponding to the wastes previously described. A second column 1806 lists by name the wastes of adjacent column 1802. A third column 1808 may list a metric category associated with each adjacent waste of column 1806. As shown, any recognized waste may be aligned with one or more metric categories. Section 1810 may include descriptions of the metric categories of column 1808. RIW chart 1800 may provide guidance to RIW personnel on capturing RIW benefits.

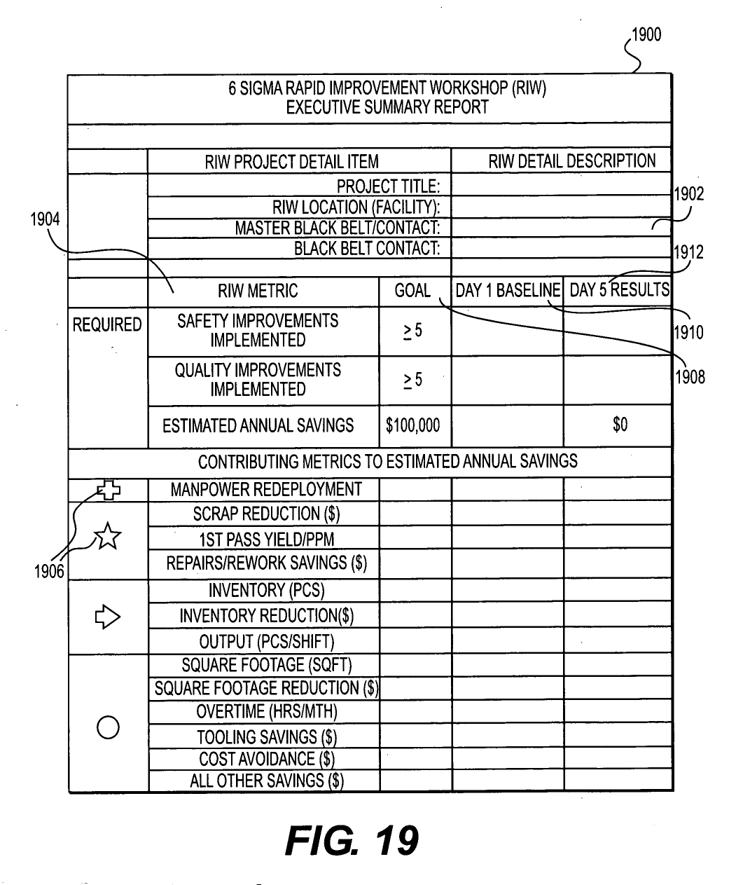

Referring to FIG. 19, an executive summary report 1900 may also be used to report RIW project benefits. As shown in FIG. 19, executive summary report 1900 may include an information section 1902 for inclusion of basic RIW project information. Executive summary report 1900 may also include column 1904, RIW metric, which may display specific metrics being analyzed during RIW 1606. Within column 1904, one or more metrics may require analysis, while certain metrics may be included for particular critical success factors 192-198 (see FIG. 1b), as shown by symbols 1906. Column 1908, Goal, may indicate a quantitative goal for the corresponding metric of column 1904 as a result of RIW 1606. Column 1910 may indicate a baseline quantitative level for the corresponding metrics, while column 1912 may show a quantitative metric value after phase 1720, Workshop, has been substantially completed.

In one embodiment, RIW chart 1800 and executive summary report 1900 may be made available via a general-purpose computer.

b. Continuous Improvement Process

The Continuous Improvement (CI) process 1608 (shown in FIG. 16a) may enable a common measurement system for all facilities 114 to focus on one of the primary goals of organizational production system 150, the elimination of waste, specifically waste 210, the unused creativity/capability of organization 100 personnel. In general, CI process 1608 may encourage and use ideas and proposals obtained from people within each level of organization 100 and provide accountability for evaluation, and, if desired, implementation of those ideas. Specifically, CI process 1608 may incorporate a visual method of displaying and tracking these ideas, initiate root cause problem solving, display accountability for ideas generated, detail actions taken, and provide feedback to the originator of the idea, all of which further drives action in a timely manner. In various embodiments, CI process 1608 may be manual or electronic, such as via a general-purpose computer.

CI process 1608 may further be integrated with VST process 1600. For example, during phase 1630, Find-It, of VST project 1604 (shown on FIG. 16c), the appropriate metric coordinator may conduct a Management System Gap Analysis to identify the current state of metrics displays 800-1200, CI boards and process, and PID process. The coordinator may draft a future state of each of these and create a plan to address the gaps identified in each analysis. This plan may be executed during phase 1640, Fix-It, of VST project 1604 (shown on FIG. 16c). Further, CI process 1608 may utilize certain tools for support, such as a CI board and a CI card. A CI board may be used in conjunction with, for example an area display 1100 to facilitate specific dialogues related to continuous improvement for critical success factors 190 (see FIG. 1b). A CI card may be used to gather data and populate a CI Board with issues and ideas. CI meetings may be held periodically, such as daily or weekly, to generate new ideas or review existing ideas at various stages of the CI process. In one embodiment, the CI board and CI card are electronic, made available via a general-purpose computer.

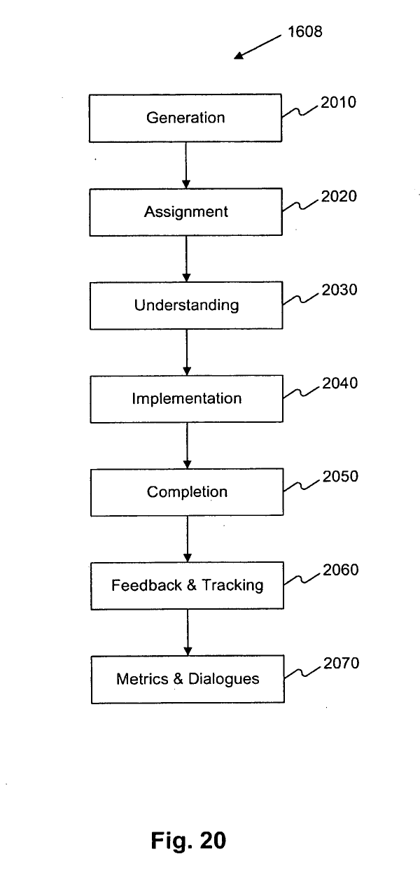

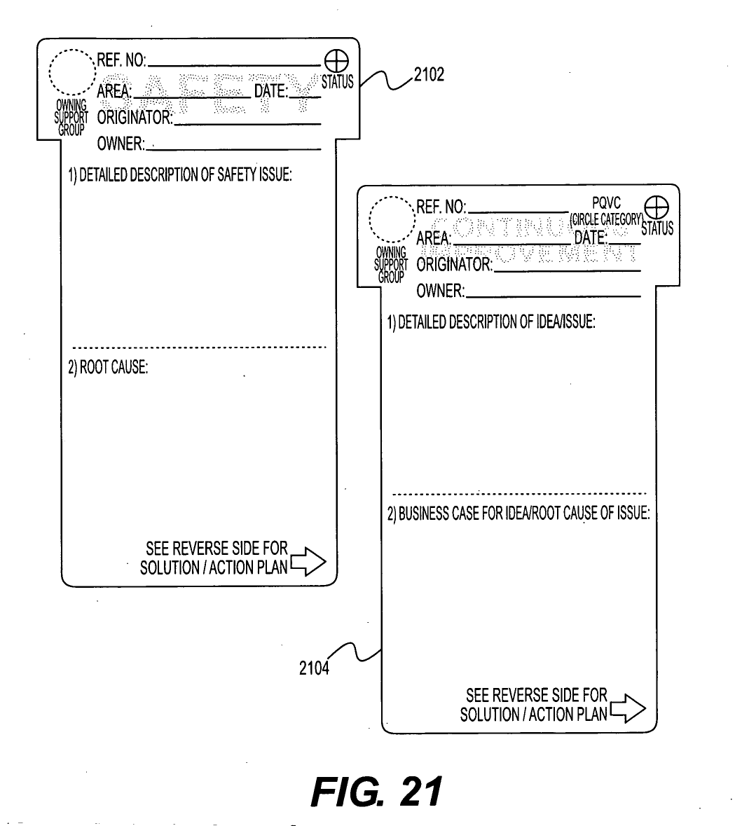

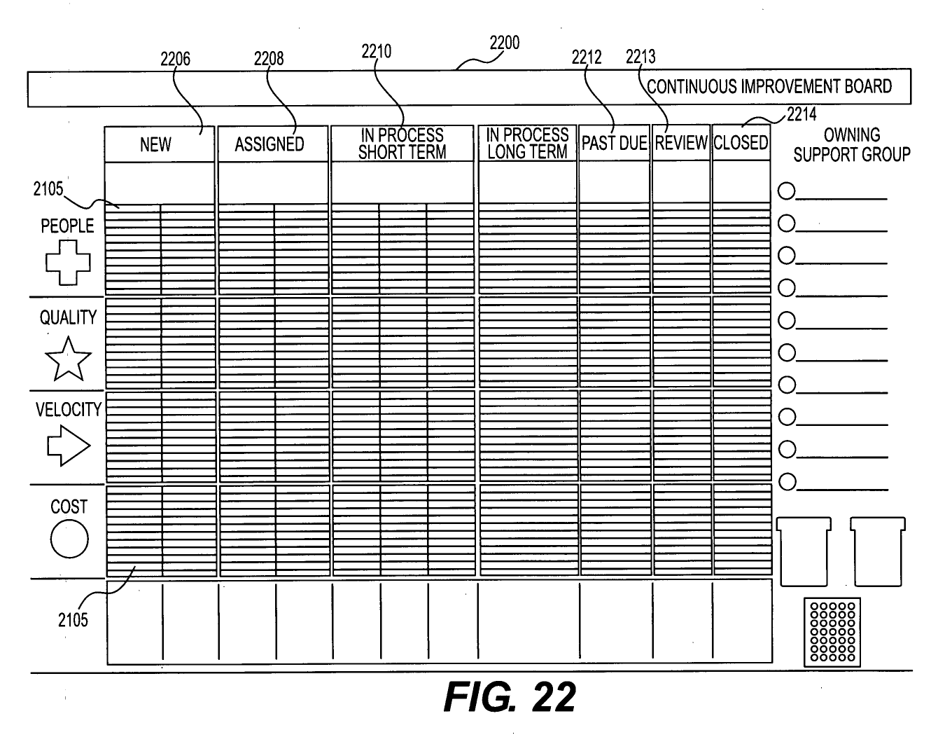

Referring to FIG. 20, the CT process 1608 may include one or more stages. In one embodiment, these stages occur after a Process Improvement Dialogue. A first stage 2010, Generation, may include generating a CI card, in which an originator with an idea fills out the card describing an issue or idea. Alternatively, first stage 2010 may be initiated as part of a discussion or meeting among organization 100 personnel. In one embodiment, an orange card 2102 may be used for safety-related issues and a yellow card 2104 may be used for non safety-related issues, as shown in FIG. 21. A card 2102, 2104 may then be displayed on CI board 2200, in slots 2105, as shown in FIG. 22, to allow the team lead of, for example, an area 122 to recognize that a specific idea or issue exists in that area 122. The team lead may then review the idea or issue with the originator to determine the most appropriate next step. For example, if a determination is made that the idea or issue is actionable, the team lead may then forward the card 2102, 2104 to the section manager. If, for example, no action can be taken on the idea or issue, the team lead may discuss the reason for this decision with the originator, at which point both the team lead and originator may jointly agree to close the issue. For an actionable idea or issue, the section manager may review card 2102, 2104 with the team lead to determine to which critical success factor 192-198 (see FIG. 2a) card 2102, 2104 most likely corresponds and which support group will take ownership of the idea or issue. This review may take place at a CI Board Review meeting. Each support group may be identified on card 2102, 2104 with an identifying characteristic. In one embodiment, the identifying characteristic may be a colored marker. The idea or issue may then be prioritized. In one embodiment, safety issues will be marked as having first priority. In addition, ideas or issues may be prioritized by critical success factor, for example, using the critical success factors 192-198 of People, Quality, Velocity, and Cost, respectively, the resulting prioritization may be People first, Quality second, Velocity third, and Cost fourth. Other methods of prioritization may include, alone or in combination with the previously described, prioritization based on overall impact of the issue within critical success factors 192-198 and prioritization based on the date of generation or completion of card 2102, 2104.

In one embodiment, the next stage 2020, Assignment, may include placing card 2102, 2104 on CI board 2200, as shown on FIG. 22. The section manager may place card 2102, 2104 in a slot 2105 within column 2206, New, under the previously determined critical success factor. Following placement of card 2102, 2104, the section manager may then assign the idea or issue a unique reference number and log it into a tracking system used at facility 114 within which area 122 operates. Such a tracking may be computer based and may be developed wholly within organization 100. The section manager may then determine if either the idea or issue should be acted upon immediately or the idea or issue may wait for a CI review meeting. If, for example, the idea or issue needs immediate attention, the section manager may contact a support group representative in order to assign an owner to the idea or issue. At this point, card 2102, 2104 may be moved to a different slot 2105 within column 2208, Assigned. If, for example, the idea or issue does not require immediate attention, card 2102, 2104 may stay within column 2206. The section manager may discuss the idea or issue with the support group representative at a CI meeting. During this meeting, it may be determined whether the idea or issue needs to be assigned to a different support group. If so, a different support group may be assigned and the identifying characteristic changed on card 2102, 2104 to now represent the new support group. The support group representative may then determine a specific owner for the idea or issue, place the name of the owner on card 2102, 2104, and move card 2102, 2104 to column 2208, Assigned. This ownership may be specifically communicated to the owner.

In a third stage 2030, Understanding, if the originator communicated on card 2102, 2104 a specific idea for improvement, the newly-assigned owner may communicate with the originator to ensure understanding of the idea, which may then be documented on card 2102, 2104. If the originator originally communicated a safety or other related issue, the originator and owner may use root cause problem solving techniques to determine the true cause of the issue. Root cause problem solving techniques are well known and will not be further explained. Once determined, the root cause may be documented on card 2102, 2104. Once a solution is found or an action evaluated, the owner and originator may discuss what solution or action should be taken to implement the idea or resolve the issue, and may set a desired completion date. If a solution or action cannot be immediately determined, card 2102, 2104 may be returned to column 2208, Assigned, as shown in FIG. 22. If a solution or action is determined, the owner may then document the solution or action on the card and both the originator and owner may initial card 2102, 2104 to indicate agreement on the root cause, solution or action, and desired completion date. The owner and section manager may then review the solution or action and place card 2102, 2104 in column 2210, In Process, as shown in FIG. 22.

The fourth stage 2040, Implementation, may include work by the owner to complete the action before the desired target date. Additional resources may be required for completion. In one implementation, at least weekly, the owner may update the support group representative on the status of the idea or issue prior to the CI review meeting so that the representative may provide a pertinent update at the review meeting. In addition, the team lead or owner may update the originator on the status of the implementation. It may be anticipated that during implementation, one or more items may need to be addressed. For example, safety issues not immediately addressed, conflict among support groups, resource allocation, prioritization issues, or non-adherence to the CI process, among other things, may necessitate escalation of these items through additional discussions and notification to higher levels of authority within organization 100. If the target date is missed, card 2102, 2104 may be moved to a different slot 2105 within column 2212, Past Due, as shown in FIG. 22.

A fifth stage 2050, Completion, may include communication by the owner to the section manager that an idea or issue has been completed. The owner may sign and date card 2102, 2104, present it to the originator for acknowledgment, and place it in column 2213, Review. The section manager may then record the completion date on card 2102, 2104 and place card 2102, 2104 in column 2214, Closed, as shown in FIG. 22. A review with the originator may occur to ensure successful implementation before card 2102, 2104 is signed off as closed.

A sixth stage 2060, Feedback and Tracking, may include specific sub-stages if a successful solution is not reached or an action not implemented. In such a case, the owner may communicate with the originator to clarify or gather additional information concerning the idea or issue. The owner and originator may then agree upon a new action plan and target date, for which a new card 2102, 2104 may be created if a root cause or solution/action is determined that differs from the original. If the solution or action has been implemented for the idea or issue, the section manager may communicate the successful implementation at the CI review meeting and record the completion of the idea or issue in the tracking system. The team lead may give card 2102, 2104 to the originator along with recognition for the originator's involvement in the CI process.

A seventh stage 2070, Metrics and Dialogues, may include posting metrics specific to the CI process on one or more metric displays 800-1100, or executive scorecards 1300, 1370, for example, area display 1100, as shown in FIG. 11. These metrics may then be cascaded to other displays 800-1100, or executive scorecards 1300, 1370, as previously described. Specifically, metrics concerning ideas per employee, which may track progress on increasing the number of continuous improvement ideas generated by each employee, and percentage of ideas closed within a time period, such as 30 days, which may track progress of increasing the number of continuous improvement ideas closed within 30 days of the creation date, may be posted on metric displays. Ideas implemented per employee may also be tracked and recorded.

### Final Notations

Portions of the Description stating that a particular act or item is required or must be provided apply only to the particular embodiments of the disclosure described, and do not apply to all embodiments of the disclosure.

### INDUSTRIAL APPLICABILITY

The disclosed production system and method for continuous improvement may be used to improve the order to customer delivery process of an organization, and may further be used by any organization that produces products or provides services. For example, in one embodiment, the system and method disclosed herein may be used by producers of heavy machinery, such as construction vehicles and equipment. In one embodiment, the vehicles may include skid loaders, dozers, dump trucks and other similar equipment and the equipment may include gas tanks, axles, engine parts, vehicle accessory parts, and other parts. However, the system and method embodiments described herein may be used in any industry for one or more aspects of the production of goods and/or provision of services.

It will be apparent to those skilled in the art that various modifications and variations can be made to the production system embodiments disclosed herein. Other embodiments will be apparent to those skilled in the art from consideration of the specification and practice of the disclosed production system and method. It is intended that the specification and examples be considered as exemplary only, with a true scope being indicated by the following claims and their equivalents.

What is claimed is:

1. A method of problem analysis within an organization, the organization having one or more production levels, comprising:
defining a plurality of organizational principles that apply to the organization;
defining a plurality of practices to enable the plurality of organizational principles, each of the practices associated with at least one metric for performance measurement;
displaying each metric at a display at one of the production levels;
enabling a meeting between two or more organization personnel concerning at least one metric, the meeting to identify a problem associated with the at least one metric.

2. The method of claim 1, further including: using root cause problem solving techniques to analyze the problem.

3. The method of claim 1, further including: establishing at least one corrective action to solve the problem.

4. The method of claim 1, wherein enabling a meeting between two or more organizational personnel includes enabling a meeting at a physical display at one of the production levels.

5. The method of claim 1, wherein enabling a meeting between two or more organizational personnel includes enabling a meeting at a virtual display at one of the production levels.

6. The method of claim 2, further including: documenting the problem analyzed.

7. The method of claim 6, wherein the documenting is accomplished electronically.

8. The method of claim 1, further including: recognizing performance of at least one of the two or more organizational personnel.

9. The method of claim 1, further including: associating the at least one metric with a pre-defined critical success factor of the organization.

10. The method of claim 9, wherein associating the at least one metric with a pre-defined critical success factor includes associating one metric with a factor directed to the well-being of organization personnel.

11. The method of claim 9, wherein associating the at least one metric with a pre-defined critical success factor includes associating one metric with a factor directed to the quality of products produced by the organization.

12. The method of claim 9, wherein associating the at least one metric with a pre-defined critical success factor includes associating one metric with a factor directed to meeting customer demands in a timely manner.

13. The method of claim 9, wherein associating the at least one metric with a pre-defined critical success factor includes associating one metric with a factor directed to reducing unwanted production costs.

14. The method of claim 1, further including: identifying at least one waste within the organization.

15. The method of claim 14, wherein identifying at least one waste includes identifying a waste directed to inefficient use of employee capabilities.

16. The method of claim 14, further including; based on the meeting, implementing at least one change to the organization's operation for reduction of the at least one waste.

17. The method of claim 1, wherein defining a plurality of organizational principles includes defining a principle directed to encouraging proposals for improvement from organization personnel.

18. The method of claim 1, wherein defining a plurality of practices to enable the plurality of organizational principles includes defining a practice directed to enabling a common measurement system across the organization.

19. A system of problem analysis within an organization, the organization having one or more production levels, comprising:
a plurality of organizational principles that apply to the organization;
a plurality of practices that enable the plurality of organizational principles, each of the practices associated with at least one metric for performance measurement;
a display for displaying each metric at one of the production levels;
a meeting between two or more organization personnel concerning at least one metric, the meeting to identify a problem associated with the at least one metric.

20. A tangible computer-readable storage medium embodying computer-readable code for instructing a system of problem analysis within an organization, the organization having one or more production levels, the computer-readable code comprising,
a plurality of organizational principles that apply to the organization;
a plurality of practices that enable the plurality of organizational principles, each of the practices associated with at least one metric for performance measurement;
a display for displaying each metric at one of the production levels;
a meeting between two or more organization personnel concerning at least one metric, the meeting to identify a problem associated with at least one metric.
